(19) United States
(12) Patent Application Publication
(10) Pub. No.: US 2016/0299170 A1
(43) Pub. Date: Oct. 13, 2016

(54) LASER SCANNING OBSERVATION DEVICE AND LASER SCANNING METHOD

(71) Applicant: SONY CORPORATION, Tokyo (JP)

(72) Inventors: Terumasa Ito, Tokyo (JP); Atsushi Fukumoto, Kanagawa (JP); Fumisada Maeda, Tokyo (JP); Hideya Chubachi, Kanagawa (JP); Yu Hirono, Tokyo (JP)

(73) Assignee: Sony Corporation, Tokyo (JP)

(21) Appl. No.: 14/777,535

(22) PCT Filed: Mar. 28, 2014
(86) PCT No.: PCT/JP2014/059220

§ 371 Date: Sep. 16, 2015

(30) Foreign Application Priority Data
Mar. 29, 2013 (JP) 2013-072688

(51) Int. Cl. G01Q 60/20; G02B 23/24; G02B 27/28; G02B 27/00; G02B 21/00

(52) U.S. Cl. CPC G01Q 60/20; G02B 27/0068; G02B 27/0031; G02B 21/0072; G02B 21/006; G02B 21/0076; G02B 27/283; G02B 23/2423

(57) ABSTRACT

Provided is a laser scanning observation device including: a window unit provided in a partial area of a casing and configured to be in contact with or close to an observation target; an objective lens configured to collect laser light on the observation target through the window unit; an optical path changing element configured to change a direction of travel of the laser light guided within the casing toward the window unit; an astigmatism correction element provided in a front stage of the window unit and configured to correct astigmatism occurring upon the collection of the laser light on the observation target; and a rotation mechanism configured to allow at least the optical path changing element to rotate about a rotation axis perpendicular to a direction of incidence of the laser light on the window unit to scan the observation target with the laser light.

### TECHNICAL FIELD

The present disclosure relates to a laser scanning observation device and a laser scanning method.

### BACKGROUND ART

As technologies for observing objects at a high resolution, there are laser scanning microscopic devices. The laser scanning microscopic devices can acquire various kinds of information regarding objects as 2-dimensional or 3-dimensional image data by applying laser light to the objects and detecting the intensity of its transmitted light, backscattered light, fluorescent light, Raman-scattered light, various kinds of light produced due to a nonlinear optical effect, or the like while scanning the objects with the laser light. In recent years, the technology using such a laser scanning microscopic device has been applied to a probe in contact with the body surface of a subject (a patient) or an endoscope inserted into the body cavity of a subject, thereby observing the body tissue of the subject (patient) at higher resolution.

In the field of microscopes, endoscopes, and probes used in observing an object by scanning the object with laser light (hereinafter, such devices will be collectively referred to as “laser scanning observation device”) as described above, there is a desire to obtain an extensive view of an observation target (e.g., biological tissue) and to observe any particular area in an enlarged form as necessary. In other words, the laser scanning observation device is necessary to achieve both a wider field of view, i.e. actual field of view (FOV) and a larger numerical aperture. However, to achieve both a wider FOV and a larger numerical aperture, it is generally necessary to make an optical system complex, and thus the problems of large size and high cost arise. In particular, in a device necessary to have smaller size in terms of its application such as a probe or endoscope, installation of a complex optical system is difficult, and thus the configuration to achieve both a wider FOV and a larger numerical aperture is difficult to implement.

On the other hand, in fields of so-called optical coherence tomography (OCT) in which tomography images of biological tissues are obtained using interference of light, endoscopic devices in which miniaturization of a head portion is realized by installing a rotation mechanism in an optical element in the head portion of an endoscope have been suggested. For example, Non-Patent Literature 1 discloses an OCT system capable of acquiring tomographic images of biological tissues by irradiating the biological tissue with low-coherence light while rotating the graded index (GRIN) lens and the prism provided in the header portion of the endo scope in the longitudinal direction of the tube as the rotation axis direction. In addition, for example, Non-Patent Literature 2 discloses a technique that, in an OCT-based endoscope for acquiring an observation image by rotating the GRIN lens and the mirror provided in the header portion in the longitudinal direction of the tube as the rotation axis direction, which is similar to Non-Patent Literature 1, acquires an observation image with a higher image quality by forming the reflective surface of the mirror to correct astigmatism liable to be caused in a window for data acquisition (for capturing images) provided on a side wall of the tube. The rotation mechanism of the optical element as disclosed in Non-Patent Literatures 1 and 2 is applicable to the laser scanning observation device, and thus a wider FOV may be achieved.

Accordingly, technologies for realizing a wide FOV by rotating an optical element in a head portion of an endoscope and performing scanning in a circumferential direction of a tube with laser light have been suggested. For example, Non-Patent Literature 3 discloses a laser scanning endoscopic device that acquires image data by rotating a mirror, using the longitudinal direction of a tube as a rotational axis direction, to perform scanning in the circumferential direction of the tube with laser light in an endoscopic device in which light is applied to a biological tissue in a side surface direction of the tube by causing a GRIN lens to collect the laser light guided inside the tube by an optical fiber into the minor. Also, Non-Patent Literature 4 discloses a laser scanning endoscopic device that acquires image data by rotating a grating and an objective lens using the longitudinal direction of a tube as a rotational axis direction and by performing scanning in the circumferential direction of the tube with laser light in an endoscopic device in which light is applied to a biological tissue via the objective lens by causing the grating to diffract the laser light guided inside the tube by an optical fiber in a side surface direction of the tube.

### CITATION LIST

### Non-Patent Literature

Non-Patent Literature 1: Guillermo J. Tearney, et al., In vivo endoscopic optical biopsy with optical coherence tomograhy, Science, 1997, Vol. 276, p. 2037-2039

Non-Patent Literature 2: Jiefeng Xi et al., High-resolution OCT balloon imaging catheter with astigmatism correction, OPTICS LETTERS, 2009, Vol. 34, No. 13, p. 1943-1945

Non-Patent Literature 3: Gangjun Liu et al., Rotational multiphoton endoscopy with a 1 μm fiber laser system, OPTICS LETTERS, 2009, Vol. 34, No. 15, p. 2249-2251

Non-Patent Literature 4: D. Yelin et al., Large area confocal microscopy, OPTICS LETTERS, 2007, Vol. 32, No. 9, p. 1102-1104

### SUMMARY OF INVENTION

### Technical Problem

In the laser scanning observation device, to acquire more stable image data of a desired area, an approach is considered in which a window unit provided in a part of a casing to acquire image data (to capture images) is in contact with an observation target and, at the same time, laser light is collected on the observation target by an objective lens through the window unit, thereby observing the target. Such an approach is necessary for the window being in contact with the observation target to have a predetermined thickness in order to achieve predetermined strength for safety.

In this regard, considering aberration caused when laser light collected by an objective lens is applied to the observation target through the window unit, as the NA of the objective lens and the thickness of the window are increased, the degree of aberration tends to increase. When the window is provided on the side surface of a cylindrical casing such as a tube of the endoscope and is cylindrical (tubular) to match the shape of the casing, as the window has low curvature (i.e. the tube of the casing has small diameter), the degree of aberration is considered to be further increased. In particular, when laser light passes through the window having a cylindrical surface, aberration may occur even on the optical axis (especially, astigmatism), resulting in deterioration in the quality of image data to be acquired.

Furthermore, in the laser scanning observation device, there is a demand for acquisition of an image including a plurality of layers by performing laser scanning while changing the observable depth (i.e. the penetration depth of laser light applied to the observation target). The change in depth of observation alters the convergence and divergence states of laser light upon the passage through the objective lens and the window unit, and thus the degree of aberration varies accordingly. To acquire a high-quality observation image, it is necessary to design an optical system by considering the change in aberration caused by any change in the optical system during observation as described above.

However, the techniques disclosed in Non-Patent Literatures 1 and 2 are based on OCT and use an objective lens having relatively low NA (e.g., NA approximately equal to 0.1), thus such aberration will not so serious problem for the quality of observation image. In the technique disclosed in Non-Patent Literature 2, the aberration is corrected using the shape of a mirror to improve the image quality, but the technique fails to deal with the case in which the degree of aberration is changed by a change in the depth of observation as described above. Also, in the technologies disclosed in Non-Patent Literature 2 and Non-Patent Literature 3, the detailed configuration of a window unit is not mentioned. Accordingly, conditions necessary for the window unit from the foregoing viewpoint of safety or aberration occurring due to the configuration of the window unit are not considered. In this way, in the endoscopes known in the art, it is difficult to achieve the enhancement of safety by providing a window having the predetermined thickness while using an objective lens having relatively large NA and, at the same time, to achieve the observation with high accuracy by reducing the influence of aberration.

Therefore, according to an embodiment of the present disclosure, there is provided a novel and improved laser scanning observation device and laser scanning observation method, capable of achieving an observation with higher accuracy.

### Solution to Problem

According to the present disclosure, there is provided a laser scanning observation device including: a window unit provided in a partial area of a casing and configured to be in contact with or close to an observation target; an objective lens configured to collect laser light on the observation target through the window unit; an optical path changing element configured to change a direction of travel of the laser light guided within the casing toward the window unit; an astigmatism correction element provided in a front stage of the window unit and configured to correct astigmatism occurring upon the collection of the laser light on the observation target; and a rotation mechanism configured to allow at least the optical path changing element to rotate about a rotation axis perpendicular to a direction of incidence of the laser light on the window unit to scan the observation target with the laser light. The astigmatism correction element corrects astigmatism by an amount of correction corresponding to variation in the astigmatism caused by a change in depth of observation, the depth of observation being a measure of depth at a position where the laser light is collected on the observation target.

According to the present disclosure, there is provided a laser scanning method including: causing laser light to be incident on an optical path changing element provided within a casing; changing a direction of travel of the laser light guided within the casing by the optical path changing element, and irradiating, through a window unit provided in a partial area of the casing and configured to be in contact with or close to an observation target, the observation target with the laser light which is collected by an objective lens and in which astigmatism is corrected by an astigmatism correction element; and causing at least the optical path changing element to rotate about a rotation axis perpendicular to an observation direction to scan the biological tissue with the laser light, the observation direction being a direction of incidence of the laser light on the observation target. The astigmatism correction element corrects astigmatism by an amount of correction corresponding to variation in the astigmatism caused by a change in depth of observation, the depth of observation being a measure of depth at a position where the laser light is collected on the observation target.

According to an embodiment of the present disclosure, the optical path changing element is allowed to rotate within the casing, and thus the observation target is scanned with laser light. Accordingly, the range of the observation target scanned with laser light during one rotation of the optical path changing element is obtained as FOV, and thus a wide field of view is implemented even when the objective lens has relatively large NA. Moreover, there is provided the astigmatism correction element configured to correct astigmatism caused by a change in depth of observation by the amount of correction to be determined depending on variation of astigmatism, and thus it is possible to perform high precision observation with less influence of astigmatism even when the depth of observation is changed.

### Advantageous Effects of Invention

According to the embodiments of the present disclosure as described above, it is possible to perform higher precision observation. Note that the advantages described above are not necessarily intended to be restrictive, and any other advantages described herein and other advantages that will be understood from the present disclosure may be achievable, in addition to or as an alternative to the advantages described above.

### BRIEF DESCRIPTION OF DRAWINGS

FIG. 1A is a graph illustrating a relation between an NA and an FOV in laser scanning endoscopic devices according to the related art.

FIG. 1B is a graph illustrating a relation between the size of a head portion, and the NA and the FOV in the laser scanning endoscopic devices according to the related art.

FIG. 2 is a schematic diagram illustrating one configuration example of a laser scanning endoscopic device according to a first embodiment of the present disclosure.

FIG. 3 is a schematic diagram schematically illustrating the configuration of a scanning unit illustrated in FIG. 2.

FIG. 4A is a schematic diagram illustrating one configuration example of a laser scanning endoscopic device according to a second embodiment of the present disclosure.

FIG. 4B is a schematic diagram illustrating the profile of a multi-core optical fiber.

FIG. 5 is a schematic diagram illustrating one configuration example of the laser scanning endoscopic device when a scanning unit includes a plurality of objective lenses.

FIG. 6A is a schematic diagram illustrating one configuration example of the scanning unit when an optical path changing element is a polarization beam splitter.

FIG. 6B is a schematic diagram illustrating a state when the scanning unit illustrated in FIG. 6A is rotated 180 degrees about the y axis as a rotational axis.

FIG. 7A is a schematic diagram illustrating one configuration example of the scanning unit when the optical path changing element is an MEMS mirror.

FIG. 7B is a schematic diagram illustrating one configuration example of the scanning unit when the optical path changing element is an MEMS mirror.

FIG. 8A is a schematic diagram illustrating one configuration example of the scanning unit when the scanning unit includes an optical path branching element.

FIG. 8B is a schematic diagram illustrating one configuration example of the scanning unit when the scanning unit includes an optical path branching element.

FIG. 9A is a schematic diagram illustrating one configuration example of the scanning unit when an incident position of laser light is fixed with respect to the tube.

FIG. 9B is a schematic diagram illustrating one configuration example of the scanning unit when an incident position of laser light is fixed with respect to the tube.

FIG. 10A is a schematic diagram illustrating one configuration example of an endoscope in which a scanning unit has another rotational axis direction.

FIG. 10B is a schematic diagram schematically illustrating the configuration of the scanning unit illustrated in FIG. 10A.

FIG. 11 is a schematic diagram illustrating an exemplary configuration of an endoscope according to a modification example in which a plurality of objective lenses are arranged in the longitudinal direction of a tube.

FIG. 12 is a schematic diagram illustrating another exemplary configuration of an endoscope according to a modification in which a plurality of objective lenses are arranged in the longitudinal direction.

FIG. 13A is a schematic diagram illustrating the configuration of a cylindrical concave-convex lens pair which is one configuration example of an aberration correction element according to an embodiment.

FIG. 13B is a schematic diagram illustrating the configuration of a cylindrical concave-convex lens pair which is one configuration example of an aberration correction element according to an embodiment.

FIG. 14 is a schematic diagram illustrating the configuration of a cylindrical meniscus lens which is one configuration example of an aberration correction element according to an embodiment.

FIG. 15 is a schematic diagram illustrating the configuration of a cylindrical plane-convex lens which is one configuration example of an aberration correction element according to an embodiment.

FIG. 16 is a diagram illustrated to describe a depth-of-observation adjusting mechanism in the laser scanning endoscopic device according to an embodiment.

FIG. 17 is a diagram illustrating an example of a laser scanning method using the depth-of-observation adjusting mechanism in the laser scanning endoscopic device according to an embodiment.

FIG. 18 is a side view illustrating an exemplary configuration of a laser scanning probe according to an embodiment.

FIG. 19 is a diagram illustrating an arrangement of optical members in the laser scanning probe illustrated in FIG. 18.

FIG. 20 is a diagram illustrating an arrangement of optical members in the laser scanning probe illustrated in FIG. 18.

FIG. 21 is a diagram illustrating an arrangement of optical members in the laser scanning probe illustrated in FIG. 18.

FIG. 22 is a diagram illustrated to describe a parameter that affects the astigmatism in an optical system of the laser scanning probe.

FIG. 23 is a graph illustrating an example of optical properties of a cylindrical meniscus lens used as an astigmatism correction element in an embodiment.

FIG. 24 is a graph illustrating the dependency of astigmatism on depth of observation for an optical member having two curved surfaces and for an optical member having one curved surface.

FIG. 25 is diagram illustrated to describe a chromatic aberration correction element that is used in the laser scanning probe.

FIG. 26 is a graph illustrating the light collection efficiency of fluorescent light on an optical fiber between both cases where a chromatic aberration correction element is employed and not employed.

FIG. 27 is a perspective view illustrating the configuration of a hand-held laser scanning probe as another exemplary configuration of the laser scanning probe according to an embodiment.

FIG. 28 is a schematic diagram illustrating an exemplary configuration of a laser scanning microscopic device according to an embodiment.

FIG. 29 is a block diagram illustrated to describe the hardware configuration of the laser scanning observation device according to an embodiment.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Examination of laser scanning endoscopic devices with different configurations

2. First embodiment

3. Second embodiment

4. Modification examples

4-1. Configuration in which scanning unit includes plurality of objective lenses

4-1-1. Configuration in which optical path changing element is polarization beam splitter

4-1-2. Configuration in which optical path changing element is MEMS mirror

4-1-3. Configuration in which scanning unit includes optical path branching element

4-1-4. Configuration in which incident position of laser light with respect to tube is fixed

4-2. Other configurations

4-2-1. Configuration in which scanning unit has other rotational axis direction

4-2-2. Modification of arrangement of objective lenses in longitudinal direction of tube

5. Configuration of aberration correction element

5-1 Correction of astigmatism

5-1-1. Cylindrical concave-convex lens pair

5-1-2. Cylindrical meniscus lens

5-1-3. Cylindrical plane-concave lens

6. Configuration including depth-of-observation adjusting mechanism
6-1. Laser scanning using depth-of-observation adjusting mechanism
6-2. Laser scanning probe
   6-2-1. General configuration
   6-2-2. Astigmatism correction element
   6-2-3. Chromatic aberration correction element
   6-2-4. Another exemplary configuration of laser scanning probe
   6-3. Laser scanning microscopic device

7. Hardware configuration

8. Conclusion

In the following, the description will be given of exemplary configuration and its modification of the laser scanning endoscopic device according to an embodiment as an example in the description of items 1 (Examination of laser scanning endoscopic devices with different configurations) to 5 (Configuration of aberration correction element). The embodiments of the present disclosure are not limited to such examples, and the laser scanning observation device according to an embodiment of the present disclosure may have other configurations than those presented herein, such as laser scanning probe and laser scanning microscopic device. Any matter described in items 1 (Examination of laser scanning endoscopic devices with different configurations) to 5 (Configuration of aberration correction element) may be similarly applicable to other configurations than those presented herein, such as a laser scanning probe and laser scanning microscopic device. An exemplary configuration of a laser scanning probe or a laser scanning microscopic device will be described in detail in items 6-2 (Laser scanning probe) and 6-3 (laser scanning microscopic device).

As a preferred embodiment of the present disclosure, the laser scanning observation device may be provided with a depth-of-observation adjusting mechanism used to adjust the depth of observation that is the depth at which laser light is collected on an observation target. The laser scanning observation device including the depth-of-observation adjusting mechanism makes it possible to acquire information relating to the direction of depth of an observation target, resulting in the achievement of useful observation that is more suitable for the demand of an operator (user). Thus, in item 6 (Configuration including depth-of-observation adjusting mechanism), the configuration of the laser scanning observation device including the depth-of-observation adjusting mechanism will be described in detail herein. Then, an exemplary hardware configuration capable of implementing the laser scanning observation device according to an embodiment will be described in item 7 (Hardware configuration).

Specifically, in item 6 (Configuration including depth-of-observation adjusting mechanism), the description will be first given of a laser scanning method that is implemented by using the depth-of-observation adjusting mechanism in item 6-1 (Laser scanning using depth-of-observation adjusting mechanism). Then, in item 6-2 (Laser scanning probe), as an exemplary configuration other than the endoscope described until then, the configuration of the laser scanning probe including the depth-of-observation adjusting mechanism will be described. In addition, the detailed description will be given of the configuration of the depth-of-observation adjusting mechanism or an aberration correction element configured to deal with a change in depth of observation. Then, in item 6-3 (Laser scanning microscopic device), as yet another exemplary configuration of the laser scanning observation device according to an embodiment, the configuration of the laser scanning microscopic device provided with the depth-of-observation adjusting mechanism will be described. Each configuration of the laser scanning probe and the laser scanning microscopic device described in items 6-2 (Laser scanning probe) and 6-3 (Laser scanning microscopic device) is illustrative of the case of including the depth-of-observation adjusting mechanism. The configuration of the laser scanning probe and the laser scanning microscopic device is not limited such examples, and it is not necessarily be provided with the depth-of-observation adjusting mechanism. The laser scanning probe and the laser scanning microscopic device according to an embodiment may have various configurations described by taking the laser scanning endoscopic device as an example.

1. EXAMINATION OF LASER SCANNING ENDOSCOPIC DEVICES WITH DIFFERENT CONFIGURATIONS

First, contents of laser scanning endoscopic devices with different configurations of the related art examined by the present inventors will be described to clarify embodiments of the present disclosure.

Examples of performance necessary for a laser scanning endoscopic device include the following performances. That is, “1. Penetration depth,” “2. Miniaturization of head portion,” “3. High NA,” “4. Wide field of view,” and “5. High-speed scanning” are included.

The “1. Penetration depth” is an index that represents an observable distance in a depth direction of a biological tissue which is an observation target. When the penetration depth is large, not only the surface of a biological tissue but also a depth position of the biological tissue can be observed. Therefore, more information regarding the biological tissue can be acquired. Specifically, the penetration depth can be enlarged by enlarging a working distance (distance up to focus of an objective lens within a biological tissue) by the objective lens arranged to face the biological tissue. It is preferable to provide a mechanism that has a predetermined magnitude of penetration depth and is capable of changing the depth of observation in the range of penetration depth (hereinafter, sometimes refer to as “depth-of-observation adjusting mechanism”). The variable depth of observation allows an observation image to be acquired, for example, while changing the depth of observation, and thus an image including a plurality of layers may be obtained, thereby acquiring more information.

The “2. Miniaturization of head portion” is necessary from the viewpoint of minimally invasive medical treatment. In consideration of a physical burden on a patient, the diameter of a head portion at the distal end of a tube of an endoscope is preferably equal to or less than a few mm. However, such performance is particularly important for the endoscope. For the laser scanning probe and the laser scanning microscopic device, a large tube (casing) having the diameter of 10 mm or greater may be used.

The “3. High NA” is necessary to acquire an image with a high resolving power (resolution). By using an objective lens with a high NA, it is possible to acquire an image with a high resolving power especially in a depth direction. In the case of the field of OCT, the NA of an objective lens may be about 0.1. In a laser scanning endoscope, however, the NA of an objective lens is preferably equal to or greater than, for example, about 0.5 to acquire an image with a high resolving power.

The “4. Wide field of view” is necessary to extensively view a biological tissue which is an observation target. The field of view mentioned here may be a so-called actual field of view (FOV) or a range of a line in which scanning with laser light is performed. When compatibility between the foregoing “3. High NA” and the foregoing “4. Wide field of view” is achievable, it is possible to acquire an image with a high resolving power while scanning a broad range. As the field of view, for example, an FOV is preferably equal to or greater than about 1.0 mm.

The “5. High-speed scanning” is necessary to observe a moving biological tissue. This is because when a scanning speed is low, it takes a long time to acquire image data, and consequently it is difficult to accurately understand a movement of a biological tissue. For example, the scanning speed is preferably equal to or greater than at least 1 fps (frame per sec). Ideally, the scanning speed is about 30 fps which is the same as a general video rate.

From the viewpoint of the foregoing 5 performances, the present inventors have examined laser scanning endoscopic devices according to the related art.

For example, an MEMS mirror type laser scanning endoscopic device has been developed by research groups at Montana State Univ. and the like (for example, “MEMS-based handheld confocal microscope for in-vivo skin imaging” by Christopher L. Arrasmith et al., in OPTICS EXPRESS 2010 Vol. 18 NO. 4 p. 3805 to 3819). This device is a device configured to scan laser light, and compatibility between the “2. Miniaturization of head portion” and the “5. High-speed scanning” is achieved by using a miniaturized minor formed of an MEMS.

As another example, a fiber end scanning type laser scanning endoscopic device has been developed by research groups at Washington Univ. and the like (for example, “Scanning fiber endoscopy with highly flexible, 1 mm catheterscopes for wide-field, full-color imaging” by Cameron M. Lee et al., in Journal of BIOPHOTONICS 2010 Vol. 3 NO. 5 to 6 p. 385 to 407). This device realizes compatibility between the “2. Miniaturization of head portion” and the “5. High-speed scanning” by 2-dimensionally moving the distal end of an optical fiber which guides laser light and performing scanning a biological tissue with the laser light.

As another example, a fiber bundle contact type laser scanning endoscopic device has been developed by Mauna Kea Technologies. In this device, optical fibers which guide laser light inside a tube of an endoscope are configured in a bundle (block) form and scanning with laser light is performed using light emitted from the fiber bundle. In this method, since a field of view corresponding to the size of the diameter of the bundle can be ensured, the “2. Miniaturization of head portion,” “4. Wide field of view,” and the “5. High-speed scanning” can be realized simultaneously. This corporation has also suggested a laser scanning endoscopic device that has a configuration in which an objective lens is provided at the distal end of the foregoing bundle contact type fiber bundle.

As another example, an actuator type laser scanning endoscopic device has been developed by research groups at the Fraunhofer Institute for Biomedical Technology (IBMT) and the like (for example, “Nonlinear optical endoscope based on a compact two axes piezo scanner and a miniature objective lens” by R. Le Harzic et al., in OPTICS EXPRESS 2008 Vol. 25 NO. 16 p. 20588 to 20596). This device achieves compatibility between the “3. High NA” and the “4. Wide field of view” by moving the entire optical system including an objective lens 2-dimensionally and scanning a biological tissue with laser light.

Here, in the laser scanning endoscopic devices with the configurations of the related art, it is generally difficult to simultaneously realize the “2. Miniaturization of head portion,” the “3. High NA,” and the “4. Wide field of view.” This is because the FOV of a lens with a high NA generally decreases since the lens has high magnification. Here, in a laser scanning microscopic device, since a tube diameter is relatively large and a large-scale configuration can be formed inside a tube, the degree of design freedom of an optical system is high and it is possible to achieve compatibility between the “3. High NA” and the “4. Wide field of view.” For example, when “FOV×NA” is defined as a performance index representing the performances of a microscopic device and an endoscopic device, a laser scanning microscopic device has the performance index of about “FOV×NA=1.0.” However, extensive off-axis characteristics necessarily increase the number of lenses, resulting in large and complex configuration of optical system, which will be difficult to implement the reduction in size and cost. However, in a laser scanning endoscopic device in which a necessary size of a tube diameter is about a few mm, it is considered difficult to configure a complex optical system inside a tube and to simultaneously realize the “2. Miniaturization of head portion,” the “3. High NA,” and the “4. Wide field of view.”

Accordingly, the present inventors have benchmarked the laser scanning endoscopic device having each of the foregoing configurations of the related art, focusing on each performance of the “2. Miniaturization of head portion,” the “3. High NA,” and the “4. Wide field of view.”

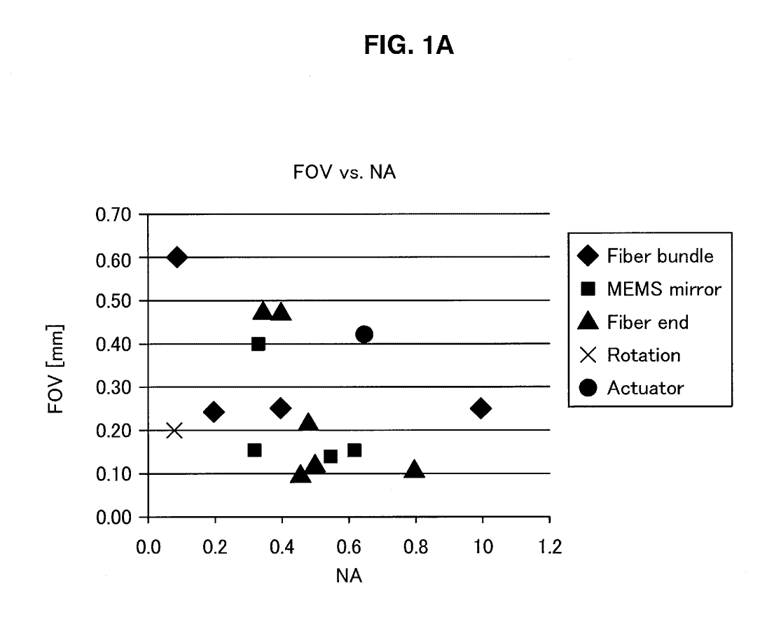

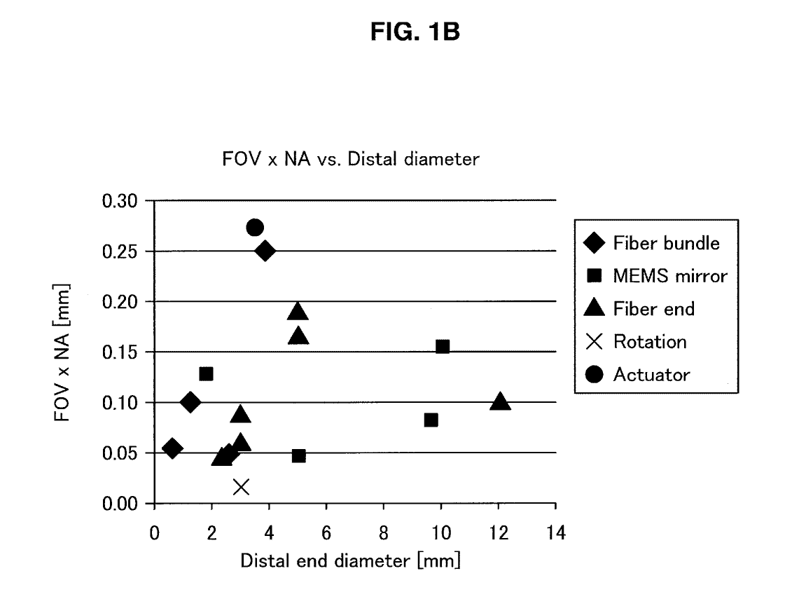

The results of the benchmark are shown in FIGS. 1A and 1B. FIG. 1A is a graph illustrating a relation between an NA and an FOV in laser scanning endoscopic devices according to the related art. FIG. 1B is a graph illustrating a relation between the size of a head portion, and the NA and the FOV in the laser scanning endoscopic devices according to the related art. Points indicated by a legend “Rotation” in the graphs represent the performance of a laser scanning microscope that scans a biological tissue with laser light by rotating an optical element in a head portion of an endoscope, as described in Non-Patent Literature 3 and Non-Patent Literature 4.

First, FIG. 1A is a graph in which the horizontal axis represents the NA, the vertical axis represents the FOV, and the performance of the laser scanning endoscopic device having each of the foregoing configurations of the related art is plotted. Referring to FIG. 1A, the NA and the FOV have a contradictory relation (inversely proportional relation) as an overall tendency. As reviewed above, it can be understood that it is difficult to achieve the compatibility between the “3. High NA” and the “4. Wide field of view.”

Next, FIG. 1B is a graph in which the horizontal axis represents the diameter of a head portion, the vertical axis represents “FOV×NA” which is the performance index of the endoscopic device, and the performance of the laser scanning endoscopic device having each of the foregoing configurations of the related art is plotted. Referring to FIG. 1B, when the diameter of the head portion is set to be equal to or less than a few mm, the limit value of FOV×NA can be understood to be about 0.3 (mm) at the highest.

Referring to FIG. 1B, a laser scanning endoscopic device with the highest value of “FOV×NA” can be understood to be the actuator type laser scanning endoscopic device among the currently benchmarked laser scanning endoscopic devices of the related art. However, since the actuator type laser scanning endoscopic device has a configuration in which the entire optical system is moved, a scanning speed is considered to be restricted when a wider field of view is configured to be acquired, that is, when the optical system is configured to be moved to scan a wider area. Thus, although not illustrated in FIG. 1B, it is difficult to achieve compatibility between the “4. Wide field of view” and the “5. High-speed scanning” in the actuator type laser scanning endoscopic device.

The contents of laser scanning endoscopic devices having the different configurations of the related art examined by the present inventors have been described above. From the above examination results, the present inventors have become aware that it is difficult to simultaneously satisfy the “1. Penetration depth,” the “2. Miniaturization of head portion,” the “3. High NA,” the “4. Wide field of view,” and the “5. High-speed scanning” in the configurations of the laser scanning endoscopic devices of the related art. Among the performances, it has been considered particularly difficult to simultaneously satisfy the “2. Miniaturization of head portion,” the “3. High NA,” and the “4. Wide field of view” in the configurations of the laser scanning endoscopic devices of the related art. The present inventors have conceived a laser scanning endoscopic device according to embodiments of the present disclosure to be described below as the result of the examination of a configuration satisfying the “2. Miniaturization of head portion,” the “3. High NA,” and the “4. Wide field of view” among the foregoing performances. Hereinafter, preferred embodiments of the laser scanning endoscopic device related to the present disclosure will be described.

### 2. FIRST EMBODIMENT

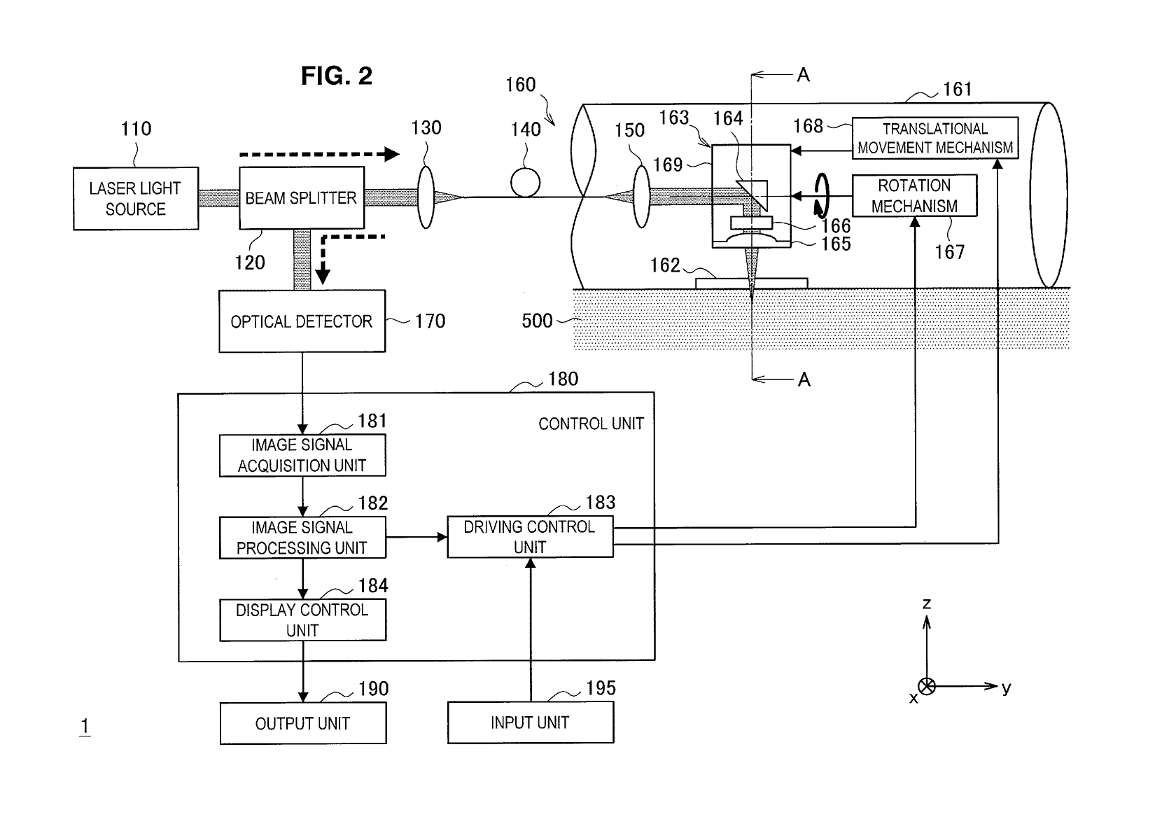

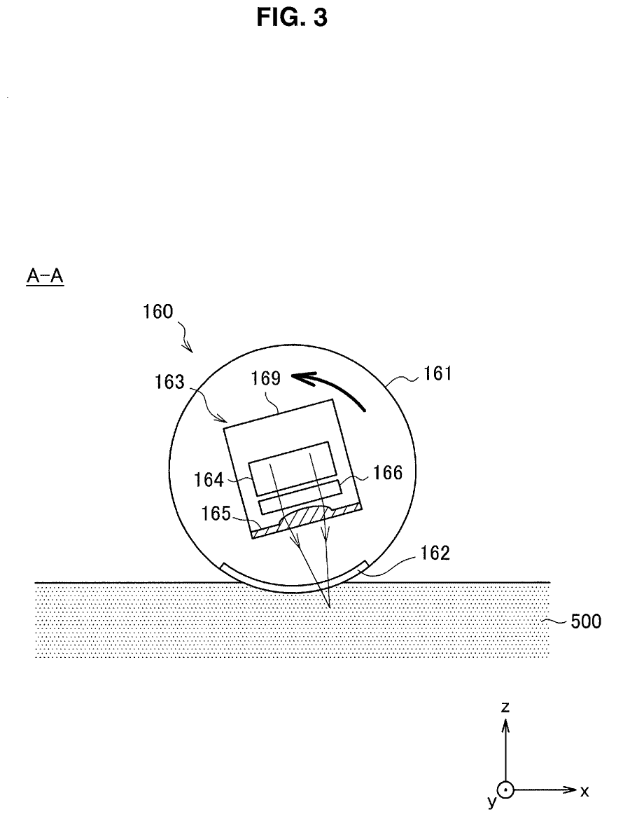

First, a configuration example of a laser scanning endoscopic device 1 according to a first embodiment of the present disclosure will be described with reference to FIGS. 2 and 3. FIG. 2 is a schematic diagram illustrating one configuration example of the laser scanning endoscopic device 1 according to the first embodiment of the present disclosure. FIG. 3 is a schematic diagram illustrating the configuration of a scanning unit illustrated in FIG. 2. In the following drawings including FIGS. 2 and 3, a supporting member supporting each constituent member included in the laser scanning endoscopic device according to embodiments of the present disclosure is not illustrated. Also, though the detailed description will be omitted, constituent members are assumed to be appropriately supported by various supporting members such that propagation of laser light and driving of the constituent members to be described below do not interfere.

Referring to FIG. 2, the laser scanning endoscopic device 1 according to the first embodiment includes a laser light source 110, a beam splitter 120, an optical fiber 140, optical fiber light-guiding lenses 130 and 150, an endoscope 160, an optical detector 170, a control unit 180, an output unit 190, and an input unit 195. For the sake of simplicity, only a configuration regarding acquisition of image data by laser scanning is illustrated in FIG. 2 among the functions of the laser scanning endoscopic device 1. Here, the laser scanning endoscopic device 1 may further have various configurations of other known endoscopic devices in addition to the configuration illustrated in FIG. 2.

In the laser scanning endoscopic device 1 according to the first embodiment, laser light emitted from the laser light source 110 sequentially passes through the beam splitter 120, the optical fiber light-guiding lens 130, the optical fiber 140, and the optical fiber light-guiding lens 150 and is then guided to the inside of the endoscope 160. A partial area of the endoscope 160 is inserted into a body cavity of a human or animal that is an observation target (hereinafter, referred to as a patient, as an example), and thus the laser light guided to the inside of the endoscope 160 is applied to a biological tissue 500 inside the body cavity of the patient that is an observation target. When the laser light is applied to the biological tissue 500 that is the observation target, light including various kinds of physical information or chemical information, such as reflected light, scattered light, fluorescent light, or various kinds of light produced due to a nonlinear optical effect, originates from the biological tissue 500. Thus, returning light originating from the biological tissue 500 and including the various kinds of physical information or chemical information is retraced along a reverse path to the optical path, that is, the returning light sequentially passes through the optical fiber light-guiding lens 150, the optical fiber 140, and the optical fiber light-guiding lens 130 and is then guided to the beam splitter 120. The beam splitter 120 guides the returning light originating from the biological tissue 500 to the optical detector 170. An image signal corresponding to the returning light and detected by the optical detector 170 is subjected to suitable image signal processing by the control unit 180, and thus various kinds of information regarding the biological tissue 500 are acquired as image data. Each of the constituent members of the laser scanning endoscopic device 1 will be described in detail below. In the following description, with respect to the optical path along which the laser light is emitted from the laser light source 110, guided into the inside of the endoscope 160, and then applied to the biological tissue 500, the side of the laser light source 110 is referred to as an upstream side and the side of the biological tissue 500 is referred to as a downstream side. Also, to describe a positional relation between constituent members arranged along the optical path of the laser light, the upstream side of the optical path is referred to as a front stage and the downstream side of the optical path is referred to as a rear stage.

The laser light source 110 emits the laser light to be applied to the biological tissue 500 that is an observation target. In the present embodiment, the configuration of the laser light source 110 is not limited uniquely, but may be appropriately set according to an observation target or use of the laser scanning endoscopic device 1. For example, the laser light source 110 may be a solid-state laser or may be a semiconductor laser. A medium (material) of the solid-state laser and the semiconductor laser may be appropriately selected so that laser light with a desired wavelength band can be emitted according to the use of the laser scanning endoscopic device 1. For example, the material of the laser light source 110 is appropriately selected so that light with a near-infrared wavelength band of which permeability is known to be relatively high with respect to the human biological tissue 500 can be emitted.

For example, the laser light source 110 may emit a contimuous wave laser (CW laser) or a pulse-oscillated laser (pulse laser). When the laser light source 110 emits a CW laser, for example, various kinds of observations may be carried out using single-photon confocal reflection, a confocal fluorescence, or the like in the laser scanning endoscopic device 1. Also, when the laser light source 110 emits the pulse laser, for example, various kinds of observations may be carried out using multiphoton excitation, a nonlinear optical phenomenon, or the like in the laser scanning endoscopic device 1.

The beam splitter 120 guides light incident from one direction and light incident from the other direction in different directions. Specifically, the beam splitter 120 guides the laser light emitted from the laser light source 110 to the optical fiber 140 via the optical fiber light-guiding lens 130. Also, the beam splitter 120 guides the returning light produced from the laser light applied to the biological tissue 500 which is an observation target to the optical detector 170. That is, as indicated by an arrow of a dotted line in FIG. 2, the beam splitter 120 guides the laser light incident from the upstream side to the optical fiber 140 via the optical fiber light-guiding lens 130 and guides the returning light produced from the biological tissue 500 and incident from the downstream side to the optical detector 170.

The optical fiber light-guiding lenses 130 and 150 are provided at the end portions of the front stage and the rear stage of the optical fiber 140, respectively, allow light to be incident on the optical fiber 140, and guide the light emitted from the optical fiber 140 to members at the rear stage. Specifically, the optical fiber light-guiding lens 130 allows the light emitted from the laser light source 110 and guided by the beam splitter 120 to be incident on the optical fiber 140. Also, the optical fiber light-guiding lens 130 guides the returning light produced from the biological tissue 500 and passing through the optical fiber 140 to the beam splitter 120.

The optical fiber 140 is a light-guiding member that guides the laser light emitted from the laser light source 110 up to the inside of the endoscope 160. The optical fiber 140 extends to the inside of the endo scope 160 to guide the laser light up to a head portion corresponding to a distal portion of the endoscope 160. The laser light guided up to the head portion of the endoscope 160 by the optical fiber 140 is guided to the scanning unit 163 provided in the head portion of the endoscope 160 to be described below via the optical fiber light-guiding lens 150. The laser light is applied to the biological tissue 500 by the scanning unit 163 and the produced returning light is incident on the optical fiber 140 by the optical fiber light-guiding lens 150. Then, the returning light is guided up to the outside of the endoscope 160 by the optical fiber 140.

Thus, the optical fiber light-guiding lens 150 is provided in the head portion of the endoscope 160 and guides the laser light guided through the optical fiber 140 to the scanning unit 163. Also, the optical fiber light-guiding lens 150 allows the returning light of the laser light applied to the biological tissue 500 by the scanning unit 163 to be incident on the optical fiber 140 and guides the incident returning light up to the outside of the endoscope 160. The optical fiber light-guiding lens 150 may function as a collimator lens to guide the laser light through the optical fiber 140 to the scanning unit 163 as a substantially parallel beam of light. The optical fiber light-guiding lens 150 may adjust its position in the optical axis direction (longitudinal direction of the tube 161), which leads to a change in the convergence and divergence of laser light on the objective lens 165 used to collect the laser light from the biological tissue 500, thus it is possible to change the depth of observation. In this way, the optical fiber light-guiding lens 150 may serve as a depth-of-observation adjusting mechanism for adjusting the depth of observation.

Here, in the present embodiment, the configuration of the optical fiber 140 is not limited uniquely, but may be appropriately set according to an observation target or use of the laser scanning endoscopic device 1. For example, when the laser scanning endoscopic device 1 performs an observation using confocal reflection, a single-mode optical fiber may be used as the optical fiber 140. Also, when the optical fiber 140 is a single-mode optical fiber, for example, the plurality of single-mode optical fibers may be tied to be used as a bundle.

For example, when the laser scanning endoscopic device 1 performs an observation using multiphoton excitation, there is no limitation on a mode of the returning light. Therefore, a multi-core optical fiber or a double clad optical fiber may be used as the optical fiber 140. Also, when the optical fiber 140 is a double clad optical fiber, for example, the laser light (that is excitation light) may be guided up to the head portion of the endoscope 160 through a core and the returning light (that is fluorescent light) from the biological tissue 500 may be guided up to the outside of the endoscope 160 through an inner clad. Thus, by using the double clad optical fiber as the optical fiber 140, it is possible to guide the laser light and the returning light more efficiently. The detailed configuration of the laser scanning observation device according to an embodiment in a case where observation is performed using two-photon excitation will be described in detail in item 6-2 (Laser scanning probe).

For example, the plurality of optical fibers 140 may be provided. Also, an optical fiber which guides the laser light up to the head portion of the endoscope 160 and an optical fiber which guides the returning light produced from the biological tissue 500 up to the outside of the endoscope 160 may be configured as different optical fibers.

When the laser light source 110 emits the pulse laser, a core portion of the optical fiber 140 preferably has a large-mode area or is preferably a hollow core-type photonic crystal optical fiber in order to suppress a nonlinear optical effect occurring inside the optical fiber 140. Likewise, when the laser light source 110 emits a pulse laser, various dispersion compensation elements may be provided at the front stage of the optical fiber 140 in consideration of dispersion occurring inside the optical fiber 140 or expansion of a pulse width (pulse time width) associated with the dispersion.

Depending on the configuration of the device according to an embodiment of the present disclosure, the optical fiber 140 may not necessarily be used. For example, in the laser scanning probe or the laser scanning endoscopic device 1 according to an embodiment, light is necessary to be guided from a light source to the probe or the endoscope 160 for irradiating an observation target with laser light, and thus the optical fiber 140 may be preferably used. However, the laser scanning microscopic device may have the configuration capable of placing an observation target sample on the stage provided in the device and irradiating it with laser light. Consequently, the laser scanning microscopic device according to an embodiment can be suitably provided, within the casing of the device, with an optical system for guiding light from the light source to the sample, and thus the optical fiber 140 may not be necessarily used.

The endoscope 160 has a tubular shape and a partial area including the head portion which is the distal portion is inserted into a body cavity of a patient. By scanning the biological tissue 500 inside the cavity with the laser light by the head portion, various kinds of information regarding the biological tissue 500 are acquired. The details of a laser scanning function which the head portion of the endo scope 160 has will be described later with reference to FIG. 3.

Here, the head portion of the endoscope 160 may further have various configurations of other known endoscopes in addition to the foregoing laser scanning function. For example, the head portion of the endoscope 160 may include an imaging unit configured to photograph an inside of a cavity of a patient, a treatment tool configured to perform various kinds of treatment on a diseased part, and a washing nozzle configured to eject water or air to wash out a lens of the imaging unit or the like. The endoscope 160 can search for an observation target portion while monitoring a state of the inside of a cavity of a patient by the imaging unit and can perform laser scanning on the observation target portion. However, the configurations of the imaging unit, the treatment tool, the washing nozzle, and the like are the same as the configurations of other known endoscopes. Therefore, the laser scanning function of the head portion among the functions of the endoscope 160 will be mainly described below and the detailed description of the other functions and configurations will be omitted.

The optical detector 170 detects the returning light produced from the biological tissue 500 and guided to the outside of the endoscope 160 by the optical fiber 140. Specifically, the optical detector 170 detects the returning light produced from the biological tissue 500 as an image signal with a signal intensity according to the intensity of the returning light. For example, the optical detector 170 may include a light-receiving element such as a photodiode or a photo multiplier tube (PMT). For example, the optical detector 170 may include various image sensors such as a charge coupled device (CCD) and a complementary metal oxide semiconductor (CMOS). To acquire spectral information of the returning light, a spectroscopic element may be provided in a front stage of the optical detector 170. The optical detector 170 can continuously (when the laser light is a CW laser) or intermittently (when the laser light is a pulse laser) detect the returning light produced through the scanning of the biological tissue 500 with the laser light in a scanning order of the laser light. The optical detector 170 transmits the image signal corresponding to the detected returning light to the control unit 180.

The control unit 180 generally controls the laser scanning endoscopic device 1 and performs control of the laser scanning of the biological tissue 500 and various kinds of image signal processing on the image signal obtained as the result of the laser scanning.

The functions and the configuration of the control unit 180 will be described in detail. Referring to FIG. 2, the control unit 180 includes an image signal acquisition unit 181, an image signal processing unit 182, a driving control unit 183, and a display control unit 184. All of the functions of the constituent elements of the control unit 180 may be performed by, for example, various signal processing circuits such as a central processing unit (CPU) and a digital signal processor (DSP).

The image signal acquisition unit 181 acquires the image signal transmitted from the optical detector 170. Here, since the optical detector 170 detects the returning light continuously or intermittently in the scanning order of the laser light, the image signal corresponding to the returning light is likewise transmitted to the image signal acquisition unit 181 continuously or intermittently in the scanning order of the laser light. The image signal acquisition unit 181 can chronologically acquire the image signal consulted continuously or intermittently in the scanning order of the laser light. When the image signal transmitted from the optical detector 170 is an analog signal, the image signal acquisition unit 181 may convert the received image signal into a digital signal. That is, the image signal acquisition unit 181 may have an analog/digital conversion function (A/D conversion function). The image signal acquisition unit 181 transmits the digitized image signal to the image signal processing unit 182.

The image signal processing unit 182 generates image data by performing various kinds of signal processing on the received image signal. In the present embodiment, the image signal corresponding to the laser light with which the biological tissue 500 is scanned is detected continuously or intermittently in the scanning order by the optical detector 170 and is transmitted to the image signal processing unit 182 via the image signal acquisition unit 181. The image signal processing unit 182 generates the image data corresponding to the scanning of the biological tissue 500 with the laser light based on the continuously or intermittently transmitted image signal. Also, the image signal processing unit 182 may generate the image data by performing signal processing corresponding to use of the laser scanning endoscopic device 1 according to the use of the laser scanning endoscopic device 1, that is, according to which image data is acquired. The image signal processing unit 182 can generate the image data by performing the same processes as various image data generation processes performed by a general laser scanning endoscopic device. Also, the image signal processing unit 182 may perform various kinds of signal processing, such as a noise removing process, a black-level correction process, and a lightness (luminance) or white balance adjustment process, performed in general image signal processing when the image signal processing unit 182 generates the image data. The image signal processing unit 182 transmits the generated image data to the driving control unit 183 and the display control unit 184.

The driving control unit 183 performs laser scanning of the biological tissue 500 by controlling driving of the laser scanning function in the head portion of the endoscope 160. Specifically, the driving control unit 183 performs the laser scanning of the biological tissue 500 by controlling driving of a rotation mechanism 167 and/or a translational movement mechanism 168 provided in the head portion of the endoscope 160, as will be described below, and driving the scanning unit 163. Here, the driving control unit 183 can adjust laser scanning conditions such as a scanning speed and a laser scanning interval in the laser scanning by controlling the driving the rotation mechanism 167 and/or the translational movement mechanism 168. The driving control unit 183 may adjust the laser scanning conditions based on a command input from the input unit 195 or based on the image data generated by the image signal processing unit 182. The driving control of the rotation mechanism 167 and/or the translational movement mechanism 168 by the driving control unit 183 will be described in detail when the functions and the configuration of the endoscope 160 are described.

The display control unit 184 controls the driving of a data display function in the output unit 190 and displays various kinds of data on a display screen of the output unit 190. In the present embodiment, the display control unit 184 controls the driving of the output unit 190 and displays the image data generated by the image signal processing unit 182 on the display screen of the output unit 190.

The output unit 190 is an output interface configured to output various kinds of information processed in the laser scanning endoscopic device 1 to an operator (user). For example, the output unit 190 includes a display device, such as a display device or a monitor device, that displays text data, image data, or the like on the display screen. In the present embodiment, the output unit 190 displays the image data generated by the image signal processing unit 182 on the display screen. Also, the output unit 190 may further include various output devices having a data output function, such as an audio output device such as a speaker or a headphone outputting audio data as audio or a printer device printing and outputting various kinds of data on a page.

The input unit 195 is an input interface configured for a user to input various kinds of information, commands regarding processing operations, or the like to the laser scanning endoscopic device 1. For example, the input unit 195 includes an input device that has an operation unit operated by a user, such as a mouse, a keyboard, a touch panel, a button, a switch, and a lever. In the present embodiment, a user can input various commands regarding operations of the endoscope 160 from the input unit 195. Specifically, the laser scanning conditions in the endoscope 160 may be controlled according to a command input from the input unit 195. Also, in addition to the laser scanning function of the endoscope 160, various configurations, e.g., driving of the imaging unit, the treatment tool, the washing nozzle, and the like may be controlled according to a command input from the input unit 195.

The schematic configuration of the laser scanning endoscopic device 1 according to the first embodiment of the present disclosure has been described above with reference to FIG. 2. Next, the functions and the configuration of the endoscope 160 will be described in more detail with reference to FIG. 3 in conjunction with FIG. 2. FIG. 3 is a schematic diagram schematically illustrating the configuration of the scanning unit 163 illustrated in FIG. 2. For the sake of simplicity, a configuration regarding the laser scanning function is mainly illustrated in FIG. 3 among the functions of the endoscope 160.

Referring to FIGS. 2 and 3, the endoscope 160 according to the first embodiment includes a tube (casing) 161, a window unit 162, a scanning unit 163, the rotation mechanism 167, and the translational movement mechanism 168.

In the present embodiment, as illustrated in FIG. 2, a partial area of the endoscope 160 is brought into contact with the biological tissue 500 which is an observation target and the laser light is applied to the contact area from the scanning unit 163. Then, when the laser light is applied to the biological tissue 500 from the scanning unit 163, the biological tissue 500 is scanned with the laser light by rotating the scanning unit 163 using an insertion direction (the longitudinal direction of the tube 161) of the endoscope 160 as a rotational axis direction and/or moving the scanning unit 163 translationally in the insertion direction of the endoscope 160. In the following description, “contact” of the endoscope 160 or other constituent member with the biological tissue 500 may represent “contact or proximity.”

Here, in the following description, as illustrated in FIGS. 2 and 3, a direction (a direction perpendicular to the page) in which the laser scanning is to be performed by rotating the scanning unit 163 is defined as an x axis, a direction in which the endoscope 160 (tube 161) is inserted is defined as a y axis, and a direction which is perpendicular to the x and y axes is defined as a z axis. Here, FIG. 2 schematically illustrates a cross-sectional view when the configuration of the scanning unit 163 of the endo scope 160 and the vicinity of the scanning unit 163 is cut out on the cross-sectional surface parallel to the y-z plane through the center axis of the tube 161. FIG. 3 is a diagram illustrating a state in which the cross-sectional surface taken along the line A-A of FIG. 2 is viewed from the front direction of the y axis. Here, FIG. 3 illustrates a state in which the scanning unit 163 is rotated at a predetermined angle about the foregoing rotational axis.

The tube 161 is a tubular casing. The head portion which is the distal portion of the tube has various configurations in which the window unit 162, the scanning unit 163, the rotation mechanism 167, and the translational movement mechanism 168, and the like are provided with regard to the laser scanning function. The diameter of the head portion of the tube 161 is, for example, equal to or less than about a few mm. In the present embodiment, as illustrated in FIGS. 2 and 3, the tube 161 has a cylindrical shape, but the cross-sectional shape of the tube 161 is not limited to this example. Any shape may be used as long as the tube is a tubular casing. For example, the cross-sectional shape of the tube 161 may be any polygon. However, the cross-sectional shape of the tube 161 is preferably a shape close to a circle in consideration of a reduction of a physical burden on a patient. Thus, when the cross-sectional shape of the tube 161 is any polygon, the number of apexes of the polygon is preferably as many as possible so that the cross-sectional shape is close to a circle. In the following description, the longitudinal direction of the endoscope 160 and the tube 161 is referred to as a major axis direction of the casing.

The head portion may also include various mechanisms in addition to the laser scanning function of the imaging unit, the treatment tool, the washing nozzle, and the like. The various mechanisms are connected electrically and mechanically to a device body of the laser scanning endoscopic device 1 by a cable or a wire (none of which is illustrated) extending inside the tube 161, and thus are driven under control of the device body. For example, the various mechanisms may be controlled according to commands which a user inputs from the input unit 195.

The window unit 162 is provided in a partial area of the tube 161 and comes into contact with the biological tissue 500 inside the body cavity of a patient that is an observation target. In the present embodiment, the window unit 162 is provided in a partial area of a side wall substantially parallel to the longitudinal direction of the tube 161 and has a cylindrical surface suitable for the shape of the side wall of the tube 161. As illustrated in FIG. 2, the laser light guided inside the tube 161 by the optical fiber 140 is applied to the biological tissue 500 via the window unit 162. Also, the returning light from the biological tissue 500 is incident inside the tube 161 via the window unit 162 and is guided to the outside of the endoscope 160 by the optical fiber 140. Accordingly, the material of the window unit 162 is preferably transparent (has large transmittance) to a wavelength band of the laser light emitted by the laser light source 110 and a wavelength band of the returning light from the biological tissue 500. Specifically, for example, the window unit 162 may be formed of various known materials such as quartz, glass, or plastic.

In the present embodiment, as described above, the biological tissue 500 is scanned with the laser light through the rotation of the scanning unit 163 about the y axis serving as the rotational axis and/or the translational movement of the scanning unit 163 in the y axis direction. Accordingly, an optical system subsequent to the scanning unit 163 (until the laser light is applied to the biological tissue 500) is preferably kept with respect to the rotation and/or the translational movement of the scanning unit 163. The shape of the window unit 162 may be set in view of the fact that the optical system subsequent to the scanning unit 163 is kept with respect to the rotation and/or the translational movement of the scanning unit 163.

Since the window unit 162 comes into contact with the biological tissue 500 at the time of the laser scanning, it is necessary for the window unit 162 to have a predetermined intensity from the viewpoint of safety. Thus, the thickness or the material of the window unit 162 is designed to have a sufficient intensity so that the window unit 162 does not harm a patient in consideration of the contact of the window unit 162 with the biological tissue 500. For example, the window unit 162 preferably has a thickness of about hundreds of μm according to its material.

In the example illustrated in FIGS. 2 and 3, the window unit 162 has a cylindrical surface suitable for the shape of the side wall of the tube 161, but the present embodiment is not limited to this example. For example, the window unit 162 may have another shape such as various kinds of different curved surfaces or planar surfaces. In the example illustrated in FIGS. 2 and 3, the window unit 162 is provided only in the partial area of the tube 161 in the circumferential direction (outer circumferential direction), but the present embodiment is not limited to this example. The window unit 162 may have a given width in the longitudinal direction of the tube 161 to be provided in the entire area in the circumferential direction of the tube 161. An installation length of the window unit 162 in the circumferential direction of the tube 161 may be set appropriately according to the areas of regions of mutual contact when the tube 161 is pressed against the biological tissue 500 at the time of the laser scanning.

The biological tissue 500 is scanned with the laser light by relative rotation and/or translational movement of the scanning unit 163 with respect to the window unit 162 inside the tube 161 when the scanning unit 163 applies the laser light to the biological tissue 500 via the window unit 162.

The function and the configuration of the scanning unit 163 will be described in detail. The scanning unit 163 includes an optical path changing element 164, an objective lens 165, an aberration correction element 166, and a housing 169.

The optical path changing element 164 guides the laser light guided in the longitudinal direction of the tube 161 inside the tube 161 to the lens surface of the objective lens 165. Specifically, the optical path changing element 164 receives the laser light guided inside the tube 161 by the optical fiber 140, changes the optical path of the laser light, and guides the laser light on the optical axis of the objective lens 165. In the example illustrated in FIG. 2, the laser light guided by the optical fiber 140 is collimated to substantially parallel light by the optical fiber light-guiding lens 150, is guided in the y axis direction, and is incident on the optical path changing element 164. The optical path changing element 164 is, for example, a folding minor and reflects the laser light guided from the optical fiber light-guiding lens 150 substantially orthogonally in the z axis direction to guide the laser light to the objective lens 165 located at the z axis position in view of the optical path changing element 164 itself. In the present embodiment, the optical path changing element 164 is not limited to the folding mirror, but may be various other optical elements. A modification example of the present embodiment in which the optical path changing element 164 is another optical element will be described in detail in (4. Modification examples) to be described below.

The objective lens 165 is provided inside the tube 161 and collects the laser light on the biological tissue 500 via the window unit 162. Specifically, the objective lens 165 collects the laser light guided from the optical path changing element 164 and applies the collected laser light toward the biological tissue 500 via the window unit 162. Also, the returning light from the biological tissue 500 is incident on the inside of the tube 161 via the window unit 162 and the objective lens 165 and is guided to the outside of the endoscope 160 by the optical fiber 140. Accordingly, the material of the objective lens 165 is preferably transparent (has large transmittance) to the wavelength band of the laser light emitted by the laser light source 110 and the wavelength band of the returning light from the biological tissue 500. Specifically, for example, the objective lens 165 may be formed of various known materials such as quartz, glass, or plastic. For example, the objective lens 165 may be an aspheric lens. In the present embodiment, the objective lens 165 preferably has a relatively high NA in order to acquire image data with a high resolving power. For example, the NA of the objective lens 165 may be equal to or greater than 0.5.

In the example illustrated in FIGS. 2 and 3, the objective lens 165 is provided in a stage following the optical path changing element 164 in the scanning unit 163 and is configured to rotate together with the optical path changing element 164. However, the position at which the objective lens 165 is provided is not limited thereto. For example, the objective lens 165 may not be included in the scanning unit 163 (i.e. it may not be rotated together with other components of the scanning unit 163) or may be provided in a front stage of the optical path changing element 164. Such configuration allows the direction of travel of the laser light collected by the objective lens 165 to be changed through the optical path changing element 164 to pass through the window unit 162 and scan the biological tissue 500. When the objective lens 165 is provided in a front stage of the optical path changing element 164, in consideration of the distance between the objective lens 165 and the optical path changing element 164 and the distance between the optical path changing element 164 and the biological tissue 500, it is preferable to use the objective lens 165 having a relatively long working distance.

The aberration correction element 166 is provided at the front stage of the window unit 162 and corrects aberration occurring when the laser light is collected on the biological tissue 500. Specifically, the aberration correction element 166 corrects at least one of the chromatic aberration, the spherical aberration, the astigmatism, and the like occurring due to the objective lens 165 and/or the window unit 162 when the laser light is applied to the biological tissue 500. An example of the aberration correction element 166 for correcting spherical aberration may include a parallel flat plate between, for example, the objective lens 165 and the window unit 162 for the purpose of compensating spherical aberration due to an error caused by the thickness of the window unit 162 or the objective lens 165. However, when the objective lens 165 is an aspheric lens, the objective lens 165 itself may have a spherical aberration correction function. For example, various cylindrical lenses or cylindrical meniscus lens may be used as the aberration correction element 166 to correct astigmatism. A specific configuration of the aberration correction element 166 will be described in detail in (5. Configuration of aberration correction element) to be described below.

Here, the degree of the foregoing aberration is influenced by the value of the NA of the objective lens 165 or the shape of the window unit 162. Specifically, the degree of aberration tends to be higher as the NA of the objective lens 165 is higher, the thickness of a constituent member of the window unit 162 is thicker, and the curvature of the window unit 162 is smaller (that is, the diameter of the tube 161 is smaller). Accordingly, an optical element used as the aberration correction element 166 or the specific configuration of the optical element may be selected appropriately according to the shapes and the characteristics of the window unit 162 and the objective lens 165.

When the depth of observation is changed by the use of the optical fiber light-guiding lens 150 that serves as, for example, a collimator lens as described above, it may be suitable to use an aberration correction element, which corrects astigmatism and is designed in consideration of aberration fluctuation associated with the change in depth of observation. When the laser scanning endoscopic device performs observation using two-photon excitation, it may be suitable to use an aberration correction element for correcting chromatic aberration. In this way, the detailed configuration of the aberration correction element in a case of including a depth-of-observation adjusting mechanism or a case where observation using two-photon excitation is performed will be described in detail in item 6-2 (Laser scanning probe).

In the example illustrated in FIGS. 2 and 3, the aberration correction element 166 is provided between the optical path changing element 164 and the objective lens 165, but the installation position of the aberration correction element 166 is not limited to this position. The aberration correction element 166 may be provided at any position until the laser light emitted from the optical fiber 140 passes through the window unit 162, or the aberration correction element 166 may be configured to be prevented from rotating or moving translationally as a component of the scanning unit 163.

For the purpose of suppressing aberration occurring when the laser light is collected on the biological tissue 500, a space between the objective lens 165 and the window unit 162 may be immersed in a liquid having a refractive index which is substantially the same as the refractive indexes of the objective lens 165 and the window unit 162. The liquid may be, for example, an oil satisfying the foregoing condition. In general, the refractive index of the biological tissue 500 is known to be a value closer than air to that of glass or the like selectable as the material of the window unit 162. Accordingly, the immersion of a space between the objective lens 165 and the window unit 162 in liquid having predetermined refractive index makes a change in refractive index on the optical path from the objective lens 165 to the biological tissue 500 through the window unit 162, especially the refractive index difference in the inner surface of the window unit 162 smaller, thereby enabling reduction in occurrence of aberration. When the space between the objective lens 165 and the window unit 162 is immersed in a liquid, the configuration of the aberration correction element 166 is selected appropriately in consideration of optical characteristics such as the refractive index of the liquid in which the space is immersed. Also, for the purpose of suppressing the aberration, the medium with which the space between the objective lens 165 and the window unit 162 is filled is not limited to a liquid. Another medium formed of various known materials satisfying the foregoing condition of the refractive index may be used.

By configuring the laser light reflection surface of the folding mirror, which is the optical path changing element 164, to have an aspheric surface shape, the optical path changing element 164 may have an aberration correction function. When the optical path changing element 164 has the aberration correction function, the configuration of the aberration correction element 166 is also selected appropriately in consideration of the performance of the aberration correction function of the optical path changing element 164.

The housing 169 houses each constituent member of the scanning unit 163 in its inner space. In the present embodiment, as illustrated in FIGS. 2 and 3, the housing 169 has a substantially rectangular shape having a space therein, and the optical path changing element 164 and the aberration correction element 166 are arranged in the inner space. Also, the objective lens 165 is arranged in a partial area of one surface facing an inner wall of the tube 161 of the housing 169. As illustrated in FIG. 2, the laser light incident on the scanning unit 163 is incident on the optical path changing element 164 provided inside the housing 169, and thus the optical path of the laser light is changed. Then, the laser light passes through the aberration correction element 166 and is guided to the outside of the housing 169 via the objective lens 165. The optical path changing element 164 and the aberration correction element 166 are assumed to be fixed to the housing 169 by supporting members or the like (not illustrated) in the inner space of the housing 169.

The rotation mechanism 167 rotates at least the objective lens 165 inside the tube 161 about a rotational axis, which is perpendicular to the optical axis of the objective lens 165 and does not pass through the objective lens 165, so that the biological tissue 500 is scanned with laser light. Specifically, the rotation mechanism 167 may include, for example, various motors driven using an electromagnetic force, an ultrasonic wave, or the like as power or a motor including a piezoelectric element. Also, the rotation mechanism 167 may include a small-sized air turbine. Further, the rotation mechanism 167 may include a mechanism that delivers a torque from the outside of the endoscope 160 using a coupling mechanism.

In the example illustrated in FIGS. 2 and 3, the rotation mechanism 167 rotates the scanning unit 163, that is, integrally rotates the optical path changing element 164, the objective lens 165, the aberration correction element 166, and the housing 169 about the y axis as a rotational axis. That is, the rotation mechanism 167 rotates the scanning unit 163 about the y axis as the rotational axis so that the optical axis of the objective lens 165 is scanned onto the surface of the window unit 162 in the x axis direction. Thus, in the present embodiment, the biological tissue 500 is scanned with the laser light corresponding to one line in the x axis direction while the rotation mechanism 167 rotates the scanning unit 163 once. Accordingly, by detecting the returning light of the laser light, characteristics of a portion of the biological tissue 500 corresponding to the line scanned with the laser light through the rotation of the mechanism 167 can be acquired as image data.

The translational movement mechanism 168 moves at least the objective lens 165 inside the tube 161 translationally in the direction of the rotational axis by the rotation mechanism 167. Specifically, the translational movement mechanism 168 may include, for example, a linear actuator or a piezoelectric element. In the example illustrated in FIGS. 2 and 3, the translational movement mechanism 168 moves the scanning unit 163, that is, integrally moves the optical path changing element 164, the objective lens 165, the aberration correction element 166, and the housing 169 translationally in the y axis direction. That is, the translational movement mechanism 168 moves the scanning unit 163 translationally in the y axis direction so that the optical axis of the objective lens 165 scans the surface of the window unit 162 in the y axis direction. Here, in the present embodiment, the laser light incident on the scanning unit 163 is collimated to substantially parallel light by the optical fiber light-guiding lens 150. Accordingly, even when the scanning unit 163 is moved translationally in the y axis direction by the translational movement mechanism 168, the focus of the laser light applied to the biological tissue 500 is not changed.

Thus, in the present embodiment, scanning in the x axis direction with the laser light is performed by rotating the scanning unit 163 by the rotation mechanism 167 and scanning in the y axis direction with the laser light is performed by moving the scanning unit 163 translationally by the translational movement mechanism 168. Accordingly, the biological tissue 500 is scanned with the laser light in a 2-dimensional form on an x-y plane (a plane defined by the x and y axes). Thus, by detecting the returning light of the laser light, the characteristics of a portion of the biological tissue 500 scanned with the laser light can be acquired as 2-dimensional image data.

In the present embodiment, a scanning speed in the x axis direction is controlled by a rotation velocity of the scanning unit 163 by the rotation mechanism 167, and a scanning speed in the y axis direction is controlled by a translational movement velocity of the scanning unit 163 by the translational movement mechanism 168. Accordingly, the rotation velocity and the translational movement velocity may be set appropriately based on a sampling frequency or the like of the image data. Also, a range of the acquired image data is controlled according to a movable range (movable distance) of the scanning unit 163 by the translational movement mechanism 168. Accordingly, the movable distance may be set appropriately in consideration of the length of the window unit 162 in the y axis direction.

In the example illustrated in FIGS. 2 and 3, the rotation mechanism 167 and the translational movement mechanism 168 rotate and move the scanning unit 163 translationally, that is, integrally rotate and move the optical path changing element 164, the objective lens 165, the aberration correction element 166, and the housing 169 translationally, but the present embodiment is not limited to this example. For example, the rotation mechanism 167 and the translational movement mechanism 168 may rotate and move only the objective lens 165 and its holder translationally so that the biological tissue 500 is scanned with the laser light. When the rotation mechanism 167 and the translational movement mechanism 168 rotate and move only the objective lens 165 and its holder translationally, the optical path changing element 164 may not be rotated or moved translationally, but may be configured to dynamically change the optical path of the laser light in synchronization with the rotation and the translational movement of the objective lens 165 by the rotation mechanism 167 and the translational movement mechanism 168, so that the laser light can be guided to the lens surface of the objective lens 165 which is being rotated and moved translationally. In this case, for example, the aberration correction element 166 may be configured to be provided so as not to be rotated and moved translationally between the optical path changing element 164 and the objective lens 165 and to dynamically change the aberration correction function in synchronization with the dynamic change in the optical path by the optical path changing element 164. For example, by providing the objective lens 165 and the aberration correction element 166 in a front stage of the optical path changing element 164, the rotation mechanism 167 and the translational movement mechanism 168 may perform the rotation and translational movement, respectively, of only the optical path changing element 164. In this way, according to an embodiment of the present disclosure, the rotation and/or translational movement of the scanning unit 163 allows the biological tissue 500 to be scanned with laser light, and an optical component to be rotated and/or moved translationally may be suitably determined to implement the scanning of laser light.

Although not illustrated in FIGS. 2 and 3, the endoscope 160 may further include an optical axis direction movement mechanism that moves the scanning unit 163 in the z axis direction, that is, in the optical axis direction of the objective lens 165. Specifically, the optical axis direction movement mechanism includes, for example, a small-sized actuator. By moving the scanning unit 163 in the z axis direction by the optical axis direction movement mechanism, the focal depth (i.e. depth of observation) of the objective lens 165 with respect to the biological tissue 500 can be changed. Also, the optical axis direction movement mechanism may move only the objective lens 165 and its holder in the z axis direction, as in the foregoing rotation mechanism 167 and the foregoing translational movement mechanism 168. By configuring the objective lens 165 as a variable focal length lens instead of moving the objective lens 165 in the optical axis direction, the focal distance of the objective lens 165 may be changed. The endoscope 160 may include a focus servo mechanism that automatically performs adjustment of a focal distance by the foregoing optical axis direction movement mechanism or the foregoing variable focal length lens by detecting a relative distance between the window unit 162 and the biological tissue 500. The optical axis direction movement mechanism or the focal distance adjusting mechanism using the variable focal length lens may be an illustrative example of the depth-of-observation adjusting mechanism according to an embodiment, which is similar to the optical fiber light-guiding lens 150 serving as the above-described collimator lens.

In the illustrative embodiment, the use of these depth-of-observation adjusting mechanisms makes it possible to scan the biological tissue 500 with laser light in the z-axis direction. Thus, the combination between driving of the scanning unit 163 by the rotation mechanism 167 and the translational movement mechanism 168 and driving of the depth-of-observation adjusting mechanism makes it possible to perform three-dimensional scanning of the biological tissue 500 with laser light. In addition, the returning light from the biological tissue is detected, and thus it is possible to acquire the properties of the biological tissue 500 as three-dimensional image data. Accordingly, the user can perform more convenient observation that allows an observation target area (e.g., diseased area) to be searched while capturing an image including a plurality of layers in the depth direction.

The overall configuration of the laser scanning endoscopic device 1 according to the first embodiment of the present disclosure has been described above with reference to FIGS. 2 and 3. In the laser scanning endoscopic device 1 according to the first embodiment, as described above, the biological tissue 500 is scanned with the laser light via the window unit 162 in the x axis direction by rotating the objective lens 165 about the y axis as the rotational axis inside the tube 161. Thus, scanning with the laser light is performed by rotating the objective lens 165, the field of view (FOV) in the laser scanning endoscopic device 1 is not restricted due to off-axis characteristics of the objective lens 165. Accordingly, in the laser scanning endoscopic device 1, a range facing the window unit 162 during the rotation of the objective lens 165 (that is, a range in which scanning with the laser light is performed in the x axis direction) is ensured as the FOV. Therefore, the wide field of view is realized even when the NA of the objective lens 165 is relatively high. Since the window unit 162 provided in the endoscope 160 of the laser scanning endoscopic device 1 according to the first embodiment is formed to have a predetermined thickness, safety is guaranteed at the time of the contact of the window unit 162 with a biological tissue. In the laser scanning endoscopic device 1 according to the first embodiment, the aberration correction element 166 that corrects aberration occurring at the time of the collection of the laser light on a biological tissue is provided at the front stage of the window unit 162. Here, the aberration correction performance of the aberration correction element 166 may be set appropriately according to the characteristics or the shapes of the objective lens 165 and the window unit 162 so that the aberration occurring due to the objective lens 165 and/or the window unit 162 is corrected. Accordingly, in the laser scanning endoscopic device 1, it is possible to achieve compatibility between the guarantee of safety obtained by allowing the window unit to have a predetermined thickness and acquisition of a high-quality image obtained by suppressing an influence of aberration, while using an objective lens with a relatively high NA.

In the laser scanning endoscopic device 1 according to the first embodiment, the objective lens 165 can be brought close to the biological tissue 500 since the window unit 162 is brought into contact with the biological tissue 500 and scanning with the laser light is performed. Therefore, even when the objective lens 165 with a relatively high NA is used, the image data by which an observation can be made up to a deeper portion of the biological tissue 500 can be acquired with a higher resolution and with higher reliability.

Here, an approximate value of FOV×NA in the laser scanning endoscopic device 1 according to the first embodiment will be calculated. As described above, the FOV of the laser scanning endoscopic device 1 is a range in which the biological tissue 500 is scanned with the laser light in the x axis direction by the rotation of the scanning unit 163. Therefore, the FOV can be considered to be a contact length with the biological tissue 500 in the length of the window unit 162 in the circumferential direction. Accordingly, the FOV is calculated by the following equation (1).

FOV=π×(outer diameter of window unit 162)×(contact angle with biological tissue)500/360°

In equation (1), the “contact angle” is a central angle of a circle of a cross-sectional surface (that is, a cross-sectional surface of the tube 161 illustrated in FIG. 3) taken along the x-z plane of the tube 161 corresponding to the contact length with the biological tissue 500 in the length of the window unit 162 in the circumferential direction.

Here, for example, the outer diameter of the window unit 162 is the same as the diameter of the tube 161 and is assumed to be 5 (mm). For example, the contact angle with the biological tissue 500 is assumed to be 60°. When the values are substituted into the foregoing equation (1), the FOV of the laser scanning endoscopic device 1 is calculated as “FOV≈2.6 (mm).” Accordingly, for example, when the objective lens 165 with the NA of 0.5 is used, the index “FOV×NA” representing the performance of the laser scanning endoscopic device 1 is “FOV×NA=2.6×0.5=1.3.” As described above in (1. Examination of laser scanning endoscopic devices with different configurations), the highest value of FOV×NA in laser scanning endo scopes of the related art is about 0.3 (mm) and the value of FOV×NA in a laser scanning microscope is about 1.0 (mm). Accordingly, with regard to the performances of the “3. High NA,” and the “4. Wide field of view,” the laser scanning endoscopic device 1 according to the first embodiment can be said to have higher performances than laser scanning endoscopes of the related art and laser scanning microscopes of the related art. Thus, in the laser scanning endoscopic device 1, the “2. Miniaturization of head portion,” the “3. High NA,” and the “4. Wide field of view” are simultaneously realized by rotating the objective lens 165. That is, in the laser scanning endoscopic device 1, a high resolution and a wide field of view can be ensured. Accordingly, a biological tissue can be efficiently observed since the biological tissue can be viewed in a wide range by controlling line interval and a sampling rate of the laser scanning or a desired portion can be observed with a higher resolution by expanding the desired portion as necessary.

When the laser scanning endoscopic device 1 includes a mechanism such as the above-described optical axis direction movement mechanism that controls a focal depth of the objective lens 165 to the biological tissue 500, a predetermined performance can also be achieved in the “1. Penetration depth.”

Also, the “5. High-speed scanning” performance in the laser scanning endoscopic device 1 will be considered. The scanning speed of the laser light in the laser scanning endoscopic device 1 is determined according to the rotation velocity of the scanning unit 163 by the rotation mechanism 167. Here, a rotation velocity necessary for the scanning unit 163 will be calculated. For example, when image data of one frame is assumed to be (x x y)=(500(pixels)×500(pixels)), it is necessary to scan the laser light corresponding to 500 lines in one second in order to realize the scanning speed of 1 fps. Accordingly, the rotation velocity necessary for the scanning unit 163 in order to realize the scanning speed of 1 fps is 500'60×1=30000 (rpm). This is the number of rotations sufficiently realized when the rotation mechanism 167 includes various motors. In the laser scanning endoscopic device 1, the scanning speed of at least about 1 fps can be said to be realizable.

The case in which the objective lens 165 is an aspheric lens has been described above, but the present embodiment is not limited to this example. For example, the objective lens 165 may be another optical element, such as a GRIN lens, a diffractive optical element, a hologram, or a phase modulator, having the same optical function as an aspheric lens.

From the viewpoint of improvement in the scanning speed, a material with a lighter specific weight is preferably used as the material of the objective lens 165 in order to realize high-speed rotation by the rotation mechanism 167.

Various optical elements, such as a reflection type objective lens, a free-form surface minor, and a prism, that can collect the laser light and also change an optical path may be used instead of the objective lens 165. When an optical element that can collect the laser light and also change an optical path is used instead of the objective lens 165, the optical path changing element 164 may not necessarily be provided.

An additional commonly used laser scanning mechanism configured to include a light polarization device such as galvanometer-mounted minor and a relay lens optical system may be provided between the laser light source 110 and the objective lens 165.

The case in which the translational movement mechanism 168 is provided as a unit configured to scan the biological tissue 500 with the laser light in the y axis direction has been described above, but the present embodiment is not limited to this example. For example, the translational movement mechanism 168 may not be provided and image data of one line in the x axis direction may be acquired by the rotation of the scanning unit 163 by the rotation mechanism 167. In the application of the laser light to the biological tissue 500, the laser light has a predetermined breadth and is applied to the biological tissue 500. Therefore, even when the scanning is performed with only the laser light of one line in the x axis direction, the image data with a predetermined width in the y axis direction is acquired. Alternatively, when the translational movement mechanism 168 is not provided, the scanning with the laser light in the y axis direction may be realized through an operation of inserting or removing the endoscope 160 into or from a body cavity. A hand-held laser scanning probe such as a laser scanning probe 5 described below in item 6-2 (Laser scanning probe) may perform the laser scanning in the y-axis direction by moving the laser scanning probe itself in the y-axis direction on the body surface of a human or animal to be observed. When a stage 880 on which an observation target is placed such as a laser scanning microscopic device 6 described below in item 6-3 (Laser scanning microscopic device) is provided, the laser scanning in the y-axis direction may be performed by moving the stage 880 in the y-axis direction. In this way, even when the translational movement mechanism 168 are not provided, it is possible to perform the laser scanning in the y-axis direction by irradiating an observation target with laser light while moving a casing (more specifically, a window unit for irradiating an observation target with laser light) or an observation target in the y-axis direction.

### 3. SECOND EMBODIMENT

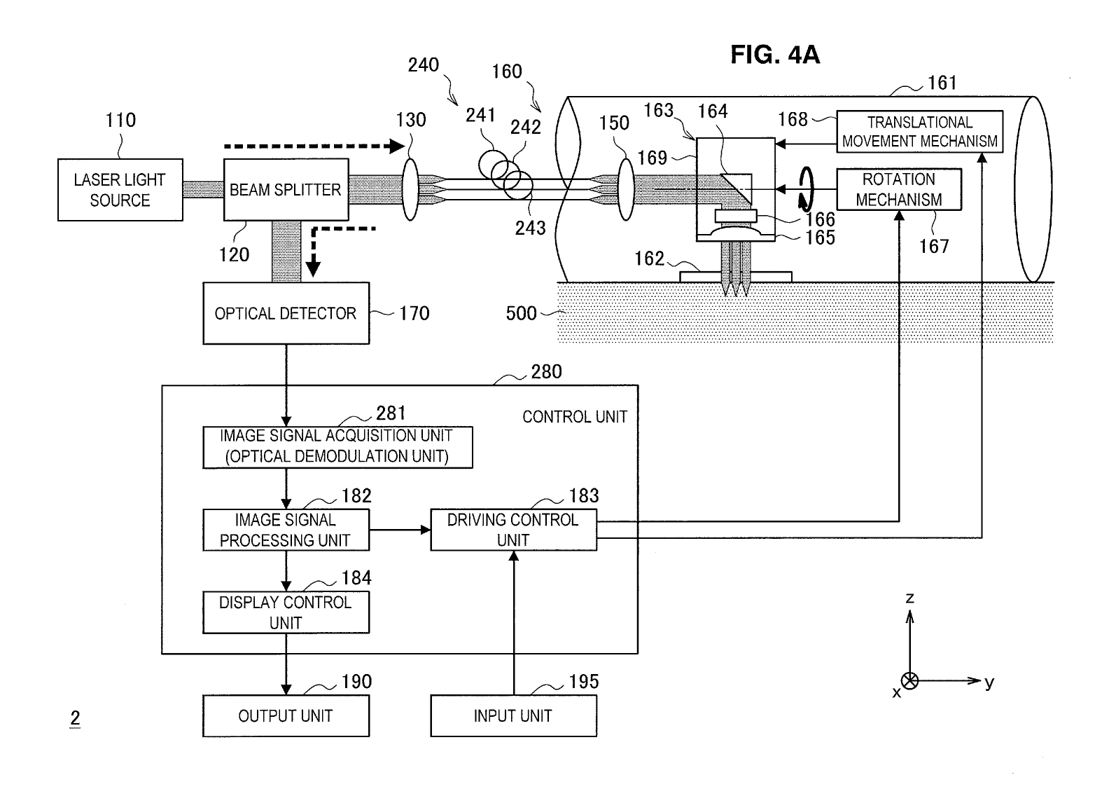

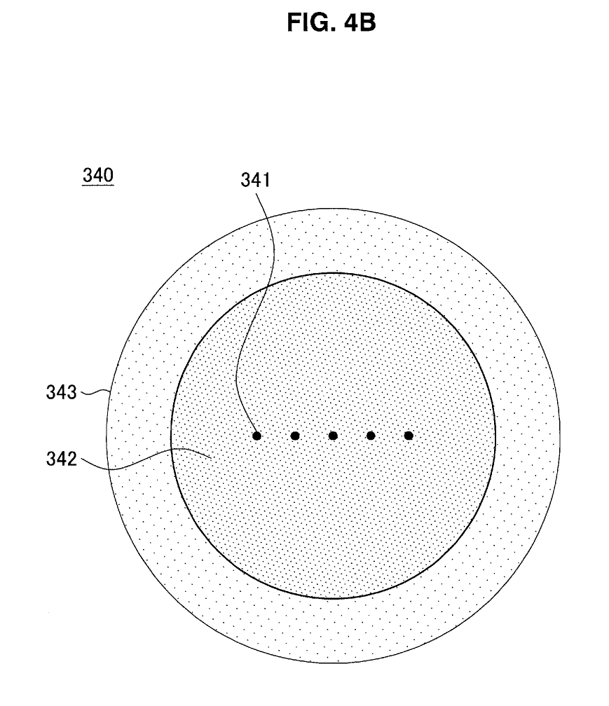

Next, one configuration example of a laser scanning endoscopic device according to a second embodiment of the present disclosure will be described with reference to FIG. 4A. FIG. 4A is a schematic diagram illustrating one configuration example of the laser scanning endoscopic device according to the second embodiment of the present disclosure.

Referring to FIG. 4A, a laser scanning endoscopic device 2 according to the second embodiment includes a laser light source 110, a beam splitter 120, an optical modulator 230, an optical fiber bundle 240, optical fiber light-guiding lenses 130 and 150, an endoscope 160, an optical detector 170, a control unit 280, an output unit 190, and an input unit 195. For the sake of simplicity, only a configuration related to acquisition of image data by laser scanning is illustrated in FIG. 4A among the functions of the laser scanning endoscopic device 2. Here, the laser scanning endoscopic device 2 may further have various configurations of other known endoscopic devices as well as the configuration illustrated in FIG. 4A.

Here, compared to the laser scanning endoscopic device 1 according to the first embodiment, the laser scanning endoscopic device 2 according to the second embodiment of the present disclosure newly includes the optical modulator 230 and includes the optical fiber bundle 240 and the control unit 280 instead of the optical fiber 140 and the control unit 180. The remaining configuration is the same as that of the laser scanning endoscopic device 1 according to the first embodiment. Accordingly, in the following description of the configuration of the laser scanning endoscopic device 2 according to the second embodiment, a configuration different from that of the laser scanning endoscopic device 1 according to the first embodiment will be mainly described and the detailed description of the repeated configuration will be omitted.

Referring to FIG. 4A, compared to the laser scanning endoscopic device 1 of the first embodiment illustrated in FIG. 2, the laser scanning endoscopic device 2 according to the second embodiment of the present disclosure includes the optical modulator 230 between the beam splitter 120 and the optical fiber light-guiding lens 130. Also, the laser scanning endoscopic device 2 includes the optical fiber bundle 240 instead of the optical fiber 140 of the laser scanning endoscopic device 1.

The optical modulator 230 modulates the intensity of the laser light input via the laser light source 110 and the beam splitter 120 at different frequencies of, for example, several MHz to several GHz to excite the laser light to a multiplexed state. Then, the laser light subjected to the mutually different modulations is incident toward the optical fiber bundle 240 via the optical fiber light-guiding lens 130.

The optical fiber bundle 240 is a bundle in which a plurality of optical fibers are collected and includes optical fibers 241, 242, and 243 in the example illustrated in FIG. 4A. Since the plurality of optical fibers 241, 242, and 243 are included, as illustrated in FIG. 2, the laser light is sequentially applied to a plurality of spots of the biological tissue 500 which correspond to the plurality of optical fibers 241, 242, and 243. Thus, by applying the laser light to the plurality of different spots, in other words, the plurality of laser scanning are performed in a narrow area. The returning light of the laser light applied to the plurality of spots is guided in a reverse direction by the plurality of optical fibers 241, 242, and 243 and is detected by the optical detector 170. In the present specification, the “spots” to which the laser light is applied in the biological tissue 500 are predetermined spread areas to which the laser light is applied.

Thus, in the present embodiment, the pencil of the laser light is incident on the optical path changing element 164 and the objective lens 165 collects the pencil of the laser light on the plurality of mutually different spots of the biological tissue 500. Here, the laser light passing through the objective lens 165 is preferably collected on the optical axis basically, but this does not in any way indicate that areas other than the optical axis are not unusable. Accordingly, it is possible to use a scanning method of allowing the pencil of the laser light to be incident on the objective lens 165 using an area (for example, an area of about several 10 μm) other than the optical axis in the objective lens 165 and applying the pencil of the laser light to mutually different spots of the biological tissue 500.

Here, the laser scanning endoscopic device 2 includes the control unit 280 instead of the control unit 180 of the laser scanning endoscopic device 1 according to the first embodiment. The control unit 280 includes an image signal acquisition unit (optical demodulation unit) 281 instead of the image signal acquisition unit 181 in the configuration of the control unit 180. The image signal acquisition unit (optical demodulation unit) 281 has a function of demodulating an image signal transmitted from the optical detector 170 in addition to the functions of the image signal acquisition unit 181. Here, the image signal acquisition unit (optical demodulation unit) 281 can demodulate an image signal through a method corresponding to a laser light modulation method in the optical modulator 230. In the present embodiment, as described above, since the optical modulator 230 modulates the frequency of the laser light and signals corresponding to a plurality of spots are multiplexed, the image signal acquisition unit (optical demodulation unit) 281 demodulates the returning light of the laser light through a method corresponding to the modulation of the frequency. Accordingly, the image signal acquisition unit (optical demodulation unit) 281 can selectively separate and acquire an image signal corresponding to the returning light from each spot with regard to the returning light of the laser light applied to the plurality of spots of the biological tissue 500.

Here, the plurality of spots of the biological tissue 500 to which the laser light is applied are arranged, for example, in the y axis direction. By arranging the spots of the biological tissue 500 in this way and rotating the scanning unit 163 by the rotation mechanism 167 while sequentially applying the laser light to the respective spots, a plurality of lines in the x axis direction can be scanned simultaneously by rotating the scanning unit 163 once. As described above, since the image signal acquisition unit (optical demodulation unit) 281 can selectively separate and acquire an image signal corresponding to the returning light from each spot, image information regarding the plurality of scanning lines can be acquired in the laser scanning endoscopic device 2 by rotating the scanning unit 163 once. Here, in the laser scanning endoscopic device 1 according to the first embodiment, only one line can be scanned by rotating the scanning unit 163 once. Therefore, in order to scan a plurality of lines, it has been necessary to repeatedly perform the rotation of the scanning unit 163 and the translational movement of the scanning unit 163 (or the endoscope 160) in the y axis direction. In the laser scanning endoscopic device 2 according to the second embodiment, however, it is possible to decrease the number of rotations of the scanning unit 163 necessary to acquire the same image data as that of the laser scanning endoscopic device 1 according to the first embodiment, thereby realizing miniaturization of a driving mechanism such as a motor included in the rotation mechanism 167 or a reduction in power consumption.

The schematic configuration of the laser scanning endoscopic device 2 according to the second embodiment of the present disclosure has been described above with reference to FIG. 4A. As described above, in the laser scanning endoscopic device 2 according to the second embodiment, it is possible to obtain the following advantages in addition to the advantages obtained in the laser scanning endoscopic device according to the above-described first embodiment. That is, in the laser scanning endoscopic device 2, the pencil of the laser light is incident on the optical path changing element 164 and the objective lens 165 collects the pencil of the laser light on the plurality of mutually different spots of the biological tissue 500. Here, the laser light forming the pencil may be mutually differently modulated laser light. The laser scanning endoscopic device 2 has a function of demodulating the laser light, and thus can selectively separate and acquire an image signal corresponding to the returning light from each spot. Accordingly, in the laser scanning endoscopic device 2, the plurality of lines of the laser light applied to the plurality of spots can be scanned while the scanning unit 163 is rotated once. Thus, even when the number of rotations of the scanning unit 163 is relatively small, a high scanning speed can be obtained.

For example, as reviewed in the foregoing (2. First embodiment), image data of one frame is assumed to be (x x y)=(500(pixels)×500(pixels)). In the laser scanning endoscopic device 1 according to the first embodiment, the necessary number of rotations of the scanning unit 163 has been about 30000 (rpm) in order to realize the scanning speed of 1 fps. However, for example, when the number of spots is 5 in the laser scanning endoscopic device 2 according to the second embodiment, the number of rotations of the scanning unit 163 necessary to realize the scanning speed of 1 fps is merely ⅕ of the above number of rotations, and thus may be about 6000 (rpm). Accordingly, in the laser scanning endoscopic device 2 according to the second embodiment, as described above, the same image data and the same information as in the laser scanning endoscopic device 1 according to the first embodiment can be obtained with fewer rotations, thereby realizing miniaturization of a driving mechanism such as a motor included in the rotation mechanism 167 or a reduction in power consumption.

In the above, the optical modulator 230 allows the laser light to be subjected to frequency multiplexing by amplitude modulation, but the present embodiment is not limited thereto. For example, a process of modulating the laser light by the optical modulator 230 may be a time-division intensity modulation or frequency modulation process. This modulation process by the optical modulator 230 may be any process in which an image signal corresponding to the returning light from each spot can be selectively separated by performing a demodulation process.

In the second embodiment, the objective lens 165 is preferably designed such that a field of view is as wide as possible to be close to diffraction limit in order for an area other than the optical axis in the objective lens 165 to be used for the scanning of the laser light.

In the above example, the use of the optical fiber bundle 240 enables the laser light to be applied to a plurality of spots of the biological tissue 500, but the second embodiment is not limited thereto. In the second embodiment, a plurality of irradiation spots of laser light may be formed using different methods. For example, a multi-core optical fiber having a plurality of cores is used and the laser light may be guided through each core of the multi-core optical fiber, and thus it is also possible to irradiate a plurality of spots of the biological tissue 500 with laser light using only one optical fiber.

An example of a multi-core optical fiber is illustrated in FIG. 4B. FIG. 4B is a schematic diagram illustrating the profile of a multi-core optical fiber. Referring to FIG. 4B, the multi-core optical fiber 340 is configured to include a plurality of cores 341, an inner clad 342, and an outer clad 343, and the cores 341 are covered by the inner and outer dads 342 and 343. The guiding of the laser light through each core 341 of the multi-core optical fiber 340 may obtain an advantageous effect similar to the case of using the optical fiber bundle 240 described above.

For example, the plurality of cores 341 are preferably arranged in a row at equal intervals in the cross section of the multi-core optical fiber 340. In the multi-core optical fiber 340, the cores 341 are preferably arranged in a direction perpendicular to the rotational scanning direction of laser light (in other words, the cores 341 are arranged in a direction parallel to the y-axis direction). This arrangement makes it possible for a plurality of spots of the biological tissue 500 arranged at equal intervals in the y-axis direction to be irradiated with laser light. Accordingly, it is possible to perform simultaneous scanning of a plurality of lines in the x-axis direction by the rotation of the scanning unit 163.

In the example illustrated in FIG. 4B, the multi-core optical fiber 340 is the double-clad multi-core optical fiber, but the second embodiment is not limited thereto. A single-clad multi-core optical fiber may be used as the multi-core optical fiber 340. However, for example, when the observation based on two-photon excitation is performed by the use of a double-clad multi-core optical fiber as described above, the light collection efficiency of fluorescent light as the returning light from an observation target on an optical fiber can be improved.

### 4. MODIFICATION EXAMPLES

Next, several modification examples of the laser scanning endoscopic devices 1 and 2 according to the first and second embodiments of the present disclosure will be described. Also, in the description of the following modification examples of the first and second embodiments, the laser scanning endoscopic device 1 according to the first embodiment will be mainly exemplified for the description. However, configurations of the modification examples to be described below are also applicable to the laser scanning endoscopic device 2 according to the second embodiment. A similar configuration to the modification example illustrated below may be applicable to the laser scanning probe and the laser scanning microscopic device according an embodiment, which will be described below in item 6-2 (Laser scanning probe) and item 6-3 (Laser scanning microscopic device), respectively.

(4-1. Configuration in Which Scanning Unit Includes Plurality of Objective Lenses)

In the laser scanning endoscopic devices 1 and 2 described in the foregoing (2. First embodiment) and (3. Second embodiment), the scanning unit 163 includes one objective lens 165. However, the present embodiment is not limited to the examples, but the scanning unit 163 may include a plurality of objective lenses 165.

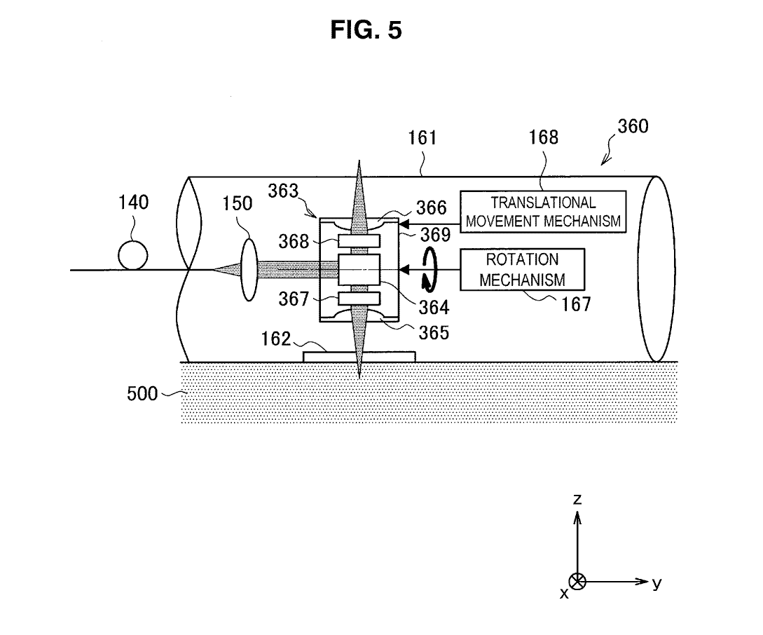

Referring to FIG. 5, a configuration example of the laser scanning endoscopic device 1 when the scanning unit includes a plurality of objective lenses will be described. FIG. 5 is a schematic diagram illustrating one configuration example of the laser scanning endoscopic device 1 when the scanning unit includes the plurality of objective lenses. Also, in FIG. 5, only the portion of an endoscope in the laser scanning endoscopic device is mainly illustrated and the other portions are not illustrated.

Referring to FIG. 5, an endoscope 360 according to the present modification example includes a tube 161, a window unit 162, a scanning unit 363, a rotation mechanism 167, and a translational movement mechanism 168. Since the tube 161, the window unit 162, the rotation mechanism 167, and the translational movement mechanism 168 in the configuration are the same as the constituent members described with reference to FIGS. 2 and 3, the configuration of the scanning unit 363 will be mainly described below and the detailed description of the configuration will be omitted. FIG. 5 schematically illustrates a cross-sectional view when the configuration of the scanning unit 363 of the endoscope 360 and the vicinity of the scanning unit 363 is cut out on the cross-sectional surface parallel to the y-z plane through the center axis of the tube 161.

The scanning unit 363 includes an optical path changing element 364, one pair of objective lenses 365 and 366, one pair of aberration correction elements 367 and 368, and a housing 369.

The pair of objective lenses 365 and 366 are provided at positions facing inner walls of the tube 161 of the scanning unit 363. Also, for example, as illustrated in FIG. 5, the one pair of objective lenses 365 and 366 are provided at facing positions in the scanning unit 363. That is, the one pair of objective lenses 365 and 366 may be located at symmetrical positions in the scanning unit 363 when viewed in the positive direction of the y axis, that is, positions rotated 180 degrees. By locating the one pair of objective lenses 365 and 366 in this way, as illustrated in FIG. 5, one objective lens 365 is located in the negative direction of the z axis to face the window unit 162 and, at this time, the other objective lens 366 is located in the positive direction of the z axis to face the inner wall of the tube 161.

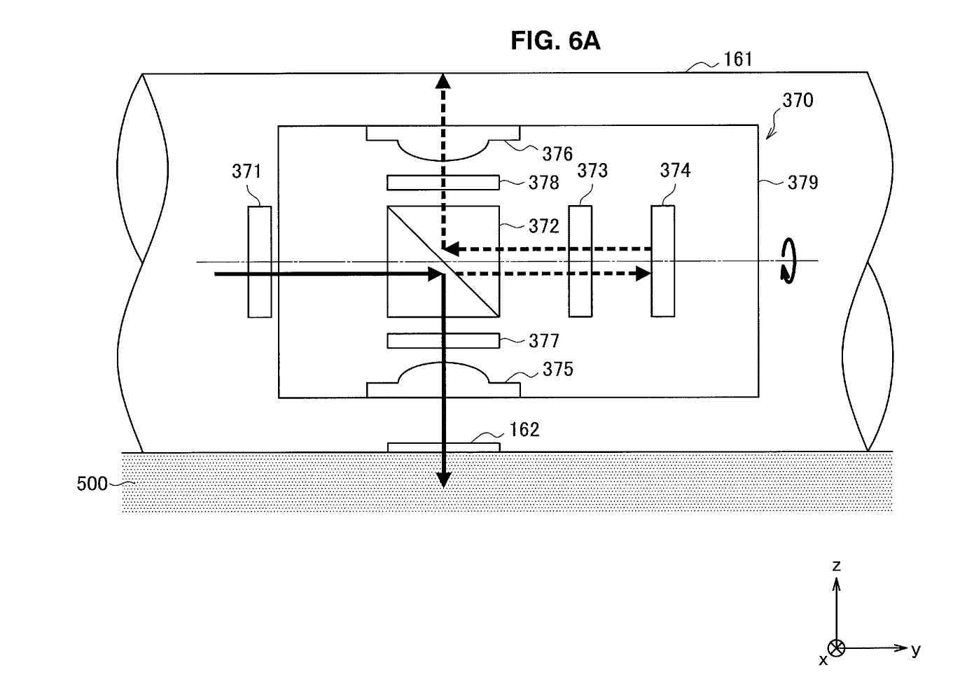

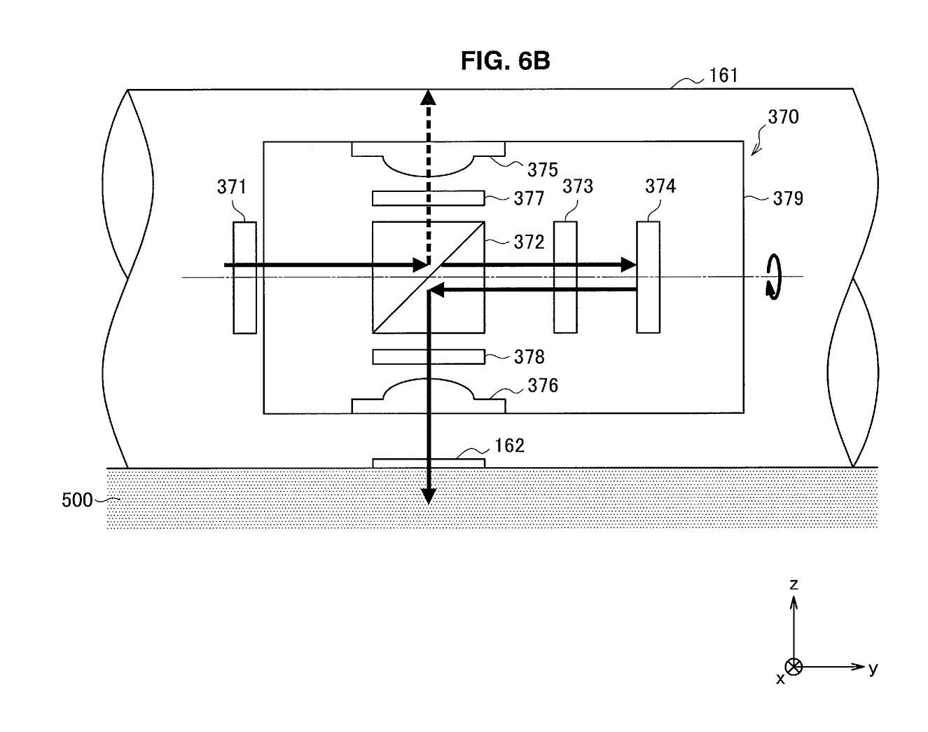

Laser light emitted from the optical fiber 140 and collimated to substantially parallel light by an optical fiber light-guiding lens 150 is incident on the optical path changing element 364. The optical path changing element 364 changes the optical path of the laser light so that the incident laser light is incident toward the objective lenses 365 and 366 facing at least the window unit 162. For example, the optical path changing element 364 may have the function of a beam splitter to separate the incident laser light into two pieces of light and guide the separated laser light toward the objective lenses 365 and 366. Also, the optical path changing element 364 may be an optical element capable of dynamically changing the direction of the optical path in synchronization with rotation of the scanning unit 363 and may guide the laser light the objective lense 365 or 366 facing the window unit 162. Specific configuration examples of scanning units including a plurality of objective lenses as in the scanning unit 363 will be described in detail below with reference to FIGS. 6A, 6B, 7A, 7B, 8A, and 8B.

The one pair of aberration correction elements 367 and 368 are located at the front stages of the one pair of objective lenses 365 and 366. The pair of aberration correction elements 367 and 368 have the same function as the aberration correction element 166 described with reference to FIG. 2 and have a function of correcting aberration occurring when the laser light is collected on the biological tissue 500. In the example illustrated in FIG. 5, the one pair of aberration correction elements 367 and 368 are located between the optical path changing element 364 and the one pair of objective lenses 365 and 366, but the positions at which the one pair of aberration correction elements 367 and 368 are located are not limited to this example. The pair of aberration correction elements 367 and 368 may be located at any positions until the laser light emitted from the optical fiber 140 passes through the window unit 162.

The housing 369 houses each constituent member of the scanning unit 363 in its inner space. In the present modification example, as illustrated in FIG. 5, the housing 369 has a substantially rectangular shape having a space therein, and the optical path changing element 364 and the one pair of aberration correction elements 367 and 368 are arranged in the inner space. Also, the one pair of objective lenses 365 and 366 are arranged in partial areas of surfaces which face inner walls of the tube 161 of the housing 369 and face each other in the housing 369. Thus, the one pair of objective lenses 365 and 366 are provided such that lens surfaces face each other in the housing 369, as illustrated in FIG. 5. Also, the optical path changing element 364 and the one pair of aberration correction elements 367 and 368 are assumed to be fixed to the housing 369 by supporting members or the like (not illustrated) in the inner space of the housing 369.

In the present modification example, as in the first embodiment, the scanning unit 363 can also be rotated together with the housing 369 about the y axis as the rotational axis by a rotation mechanism (not illustrated). Also, as in the first embodiment, the scanning unit 363 can be moved translationally together with the housing 369 in the y axis direction by a translational movement mechanism (not illustrated). Thus, in the present modification example, the biological tissue 500 is scanned with the laser light in the x axis direction through the rotation of the scanning unit 363 about the y axis as the rotational axis by the rotation mechanism and the biological tissue 500 is scanned with the laser light in the y axis direction through the translational movement of the scanning unit 363 in the y axis direction by the translational movement mechanism.

The configuration of the scanning unit 363 including the plurality of objective lenses 365 and 366 according to the modification example of the first and second embodiments of the present disclosure has been described above with reference to FIG. 5. In the present modification example, the scanning with the laser light by the objective lens 365 and the scanning with the laser light by the objective lens 366 are performed while the scanning unit 363 rotates once. Accordingly, compared to the laser scanning endoscopic devices 1 and 2 according to the first and second embodiments, a faster scanning speed is realized to increase an amount of information acquired while the scanning unit 363 rotates once. Alternatively, image data of the same amount of information as that of the laser scanning endoscopic devices 1 and 2 according to the first and second embodiments can be acquired with fewer rotations of the scanning unit 363.

In the example illustrated in FIG. 5, the case in which the scanning unit 363 includes the one pair of objective lenses 365 and 366 and the one pair of objective lenses 365 and 366 are located at the symmetric positions in the scanning unit 363 when viewed in the positive direction of the y axis, that is, the positions rotated 180 degrees, has been described, but the present modification example is not limited to this example. The scanning unit 363 may include more than two objective lenses. The plurality of objective lenses may be located at any positions as long as the objective lenses face inner walls of the tube 161 at substantially identical positions in the longitudinal direction of the tube 161 and are located at predetermined intervals in the outer circumferential direction of the tube 161. Cases in which the number of located objective lenses or their locations in the scanning unit including a plurality of objective lenses are different from those of the example illustrated in FIG. 5 will be described below with reference to FIGS. 6A, 6B, 7A, 7B, 8A, 8B, 9A, and 9B.

(4-1-1. Configuration in Which Optical Path Changing Element is Polarization Beam Splitter)

A configuration in which an optical path changing element is a polarization beam splitter will be described with reference to FIGS. 6A and 6B as a specific configuration example in which a scanning unit includes a plurality of objective lenses. FIG. 6A is a schematic diagram illustrating one configuration example of the scanning unit when the optical path changing element is a polarization beam splitter. FIG. 6B is a schematic diagram illustrating a state in which the scanning unit illustrated in FIG. 6A is rotated 180 degrees about the y axis as a rotational axis. In FIGS. 6A and 6B, for the sake of simplicity, only the configuration of the scanning unit and the vicinity of the scanning unit is mainly illustrated in the configuration of the laser scanning endoscopic device according to the present modification example. Also, FIGS. 6A and 6B schematically illustrate cross-sectional views when the configuration of the scanning unit and the vicinity of the scanning unit is cut out on the cross-sectional surface parallel to the y-z plane through the center axis of the tube.

Referring to FIGS. 6A and 6B, a scanning unit 370 according to the present modification example includes a polarization beam splitter 372, a quarter-wavelength plate 373, a minor 374, one pair of objective lenses 375 and 376, one pair of aberration correction elements 377 and 378, and a housing 379. In the configuration example illustrated in FIG. 6A, a polarization modulation element 371 is also provided at the front stage of the scanning unit 370, that is, immediately before the laser light emitted from the optical fiber is incident on the scanning unit 370. Also, solid-line and dashed-line arrows illustrated in FIGS. 6A and 6B indicate optical paths of the laser light.

As in the example illustrated in FIG. 5, the one pair of objective lenses 375 and 376 are located at symmetric positions in the scanning unit 370 when viewed in the y axis direction, that is, positions rotated 180 degrees. That is, as illustrated in FIG. 6A, when one objective lens 375 is located in the negative direction of the z axis to face the window unit 162, the other objective lens 376 is located in the positive direction of the z axis direction to face an inner wall of the tube 161. Also, the one pair of aberration correction elements 377 and 378 are located at the front stages of the one pair of objective lenses 375 and 376, respectively. The aberration correction elements 377 and 378 have the same function as the aberration correction element 166 described with reference to FIG. 2 and have a function of correcting aberration occurring when the laser light is collected on the biological tissue 500.

The polarization modulation element 371 has a function of changing a polarization direction of the incident laser light. Specifically, the polarization modulation element 371 may have a function of passing only laser light with a predetermined polarization direction in the incident laser light. In the present modification example, laser light emitted from an optical fiber (not illustrated) at the front stage of the polarization modulation element 371 is incident on the polarization modulation element 371, and then the polarization modulation element 371 passes only laser light with the predetermined polarization direction in the laser light so that the laser light is incident on the scanning unit 370.

The laser light passing through the polarization modulation element 371 is incident on the scanning unit 370 and is further incident on the polarization beam splitter 372. The polarization beam splitter 372 has a function of changing the optical path of the laser light with the predetermined polarization direction. Specifically, the polarization beam splitter 372 changes the optical path according to the polarization direction of the incident laser light. In the example illustrated in FIG. 6A, the polarization beam splitter 372 changes the optical path of the laser light passing through the polarization modulation element 371 about 90 degrees such that the laser light is adjusted to be incident on the aberration correction element 377 and the objective lens 375 located in the negative direction of the z axis. The laser light of which the optical path is changed by the polarization beam splitter 372 passes through the aberration correction element 377 and the objective lens 375 and is applied to the biological tissue 500 via the window unit 162.

The housing 379 houses each constituent member of the scanning unit 370 in its inner space. In the present modification example, as illustrated in FIG. 6A, the housing 379 has a substantially rectangular shape having a space therein, and the polarization beam splitter 372, the quarter-wavelength plate 373, the minor 374, and the one pair of aberration correction elements 377 and 378 are arranged in the inner space. Also, the one pair of objective lenses 375 and 376 are arranged in partial areas of surfaces which face inner walls of the tube 161 of the housing 379 and face each other in the housing 379. Also, the polarization beam splitter 372, the quarter-wavelength plate 373, the minor 374, and the one pair of aberration correction elements 377 and 378 are assumed to be fixed to the housing 379 by supporting members or the like (not illustrated) in the inner space of the housing 379.

In the present modification example, as in the first embodiment, the scanning unit 370 can also be rotated together with the housing 379 about the y axis as the rotational axis by a rotation mechanism (not illustrated). Also, as in the first embodiment, the scanning unit 370 can be moved translationally together with the housing 379 in the y axis direction by a translational movement mechanism (not illustrated). Thus, in the present modification example, the biological tissue 500 is scanned with the laser light in the x axis direction through the rotation of the scanning unit 370 by the rotation mechanism about the y axis as the rotational axis and the biological tissue 500 is scanned with the laser light in the y axis direction through the translational movement of the scanning unit 370 in the y axis direction by the translational movement mechanism.

FIG. 6B illustrates a state when the scanning unit 370 is rotated 180 degrees about the y axis as the rotational axis from the state of FIG. 6A. Since the scanning unit 370 is rotated 180 degrees about the y axis as the rotational axis, the polarization beam splitter 372 and position relations between the aberration correction element 377 and the objective lens 375 and between the aberration correction element 378 and the objective lens 376 are also rotated 180 degrees. That is, in the state illustrated in FIG. 6B, the aberration correction element 378 and the objective lens 376 face the window unit 162.

In the state illustrated in FIG. 6B, the polarization beam splitter 372 adjusts the laser light passing through the polarization modulation element 371 in the negative direction of the y axis and incident such that the laser light passes in the positive direction of the y axis without change in the optical path. Alternatively, when the polarization beam splitter 372 is rotated 180 degrees from the state illustrated in FIG. 6A and enters the state illustrated in FIG. 6B, the characteristics of the polarization modulation element 371 may be changed dynamically in synchronization with the rotation of the scanning unit 370 so that the incident laser light passes in the positive direction of the y axis.

The quarter-wavelength plate 373 and the mirror 374 are located in this order in the positive direction of the y axis of the polarization beam splitter 372. Thus, the laser light passing through the polarization beam splitter 372 is reflected by the minor 374 after passing through the quarter-wavelength plate 373, passes through the quarter-wavelength plate 373 again, and is incident on the polarization beam splitter 372 in the positive direction of the y axis. The laser light passing through the quarter-wavelength plate 373 twice along the series of optical paths, and thus its polarization direction is changed. The polarization beam splitter 372 changes, by about 90 degrees, the optical path of the laser light which is incident in the positive direction of the y axis and of which the polarization direction is changed such that the laser light is adjusted to be incident on the aberration correction element 378 and the objective lens 376 located at the negative direction of the z axis. The laser light of which the optical path is changed by the polarization beam splitter 372 passes through the aberration correction element 377 and the objective lens 375 and is applied to the biological tissue 500 via the window unit 162.

In the present modification example, as described above with reference to FIGS. 6A and 6B, the laser light can be guided in the direction of the objective lens 375 or 376 facing the window unit 162 in synchronization with the rotation of the scanning unit 370 by combining the polarization modulation element 371 that controls the polarization direction of the laser light and the polarization beam splitter 372 that controls the optical path of the laser light according to the polarization direction of the laser light. Accordingly, scanning with the laser light can efficiently be performed by performing both of the scanning of the biological tissue 500 with the laser light via the objective lens 375 and the scanning of the biological tissue 500 with the laser light via the objective lens 376 while the scanning unit 370 is rotated once.

(4-1-2. Configuration in Which Optical Path Changing Element is MEMS Minor)

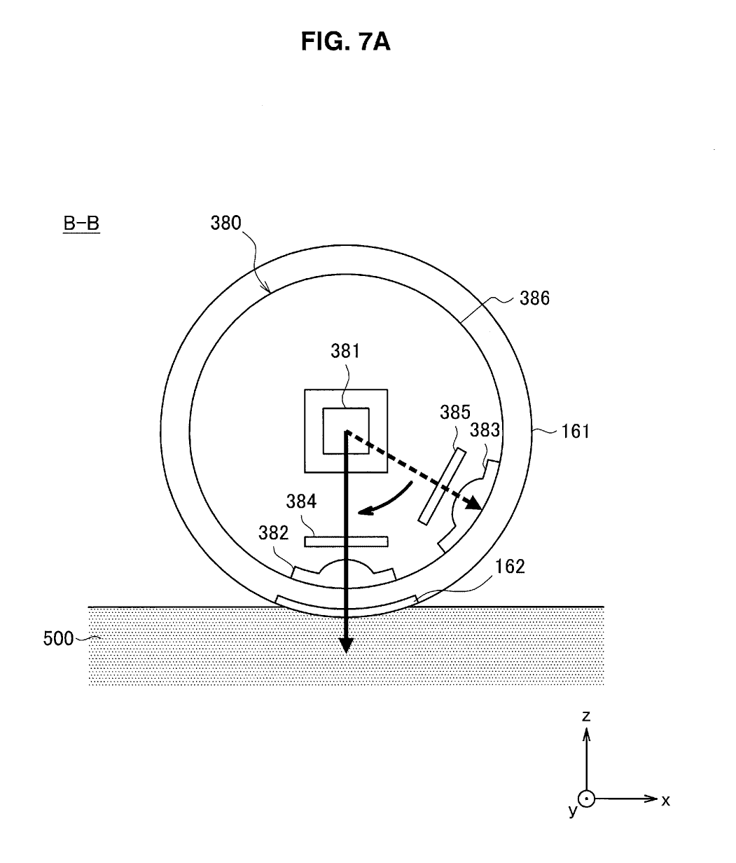

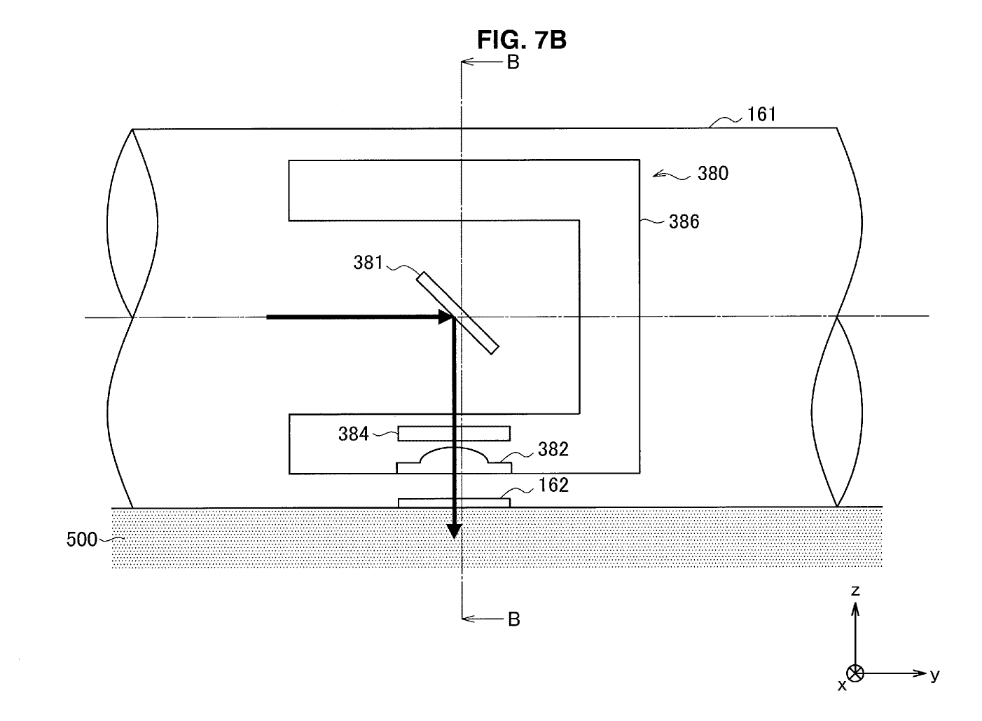

Next, a configuration in which an optical path changing element is an MEMS minor will be described with reference to FIGS. 7A and 7B as a specific configuration example in which a scanning unit includes a plurality of objective lenses. FIGS. 7A and 7B are schematic diagrams illustrating one configuration example of the scanning unit when an optical path changing element is an MEMS minor. In FIGS. 7A and 7B, for the sake of simplicity, only the configuration of the scanning unit and the vicinity of the scanning unit is mainly illustrated in the configuration of the laser scanning endoscopic device according to an embodiment of the present disclosure. Also, FIG. 7A schematically illustrates a cross-sectional view when the configuration of the scanning unit and the vicinity of the scanning unit is cut out on the cross-sectional surface parallel to the x-z plane through the center axis of the tube. Further, FIG. 7B schematically illustrates a cross-sectional view when the configuration of the scanning unit and the vicinity of the scanning unit is cut out on the cross-sectional surface parallel to the y-z plane through the center axis of the objective lens of the scanning unit. FIG. 7A corresponds to the cross-sectional view taken along the line B-B illustrated in FIG. 7A.

Referring to FIGS. 7A and 7B, a scanning unit 380 includes an MEMS minor 381, one pair of objective lenses 382 and 383, one pair of aberration correction elements 384 and 385, and a housing 386. Solid-line arrows illustrated in FIGS. 7A and 7B indicate optical paths of a laser light.

In the example illustrated in FIG. 7A, the locations of the one pair of objective lenses 382 and 383 are different from those in the examples illustrated in FIGS. 5, 6A, and 6B. That is, in the example illustrated in FIG. 7A, the one pair of objective lenses 382 and 383 are not located at positions rotated 180 degrees in the scanning unit 380 when viewed in the y axis direction, but are located at a predetermined angle less than 180 degrees. Also, the one pair of aberration correction elements 384 and 385 are located at the front stages of the one pair of objective lenses 382 and 383, respectively. The aberration correction elements 384 and 385 have the same function as the aberration correction element 166 described with reference to FIG. 2 and have a function of at least correcting aberration occurring when the laser light is collected on a biological tissue. In the present modification example, however, the locations of the objective lenses 382 and 383 and the aberration correction elements 384 and 385 may also be positions rotated 180 degrees in the scanning unit 380 when viewed in the y axis direction, as in FIGS. 5, 6A, and 6B.

The MEMS mirror 381 is a mirror formed of an MEMS and can dynamically control a reflection direction of the incident laser light. Specifically, the MEMS mirror 381 can dynamically change the optical path of the incident laser light by dynamically changing at least one of the angle and the shape of a reflection surface reflecting the incident laser light. For example, the MEMS mirror 381 is disposed substantially at the center of the inner diameter of the tube. The angular position and surface shape of the MEMS minor 381 are dynamically controlled so that the laser light emitted from an optical fiber (not shown) in the front stage is guided in the radial direction of the tube 161 and scans an observation target along the circumferential direction of the tube 161 (to scan an observation target in the x-axis direction).

Here, in the present modification example, as illustrated in FIGS. 7A and 7B, the housing 386 has a cup-like shape in which the inside of a cylinder is hollowed out in a cylindrical shape with a smaller diameter. In addition, the aberration correction elements 384 and 385 are located in the inner space of the housing 386 and the objective lenses 382 and 383 are located at a predetermined interval along the outer circumference of the housing 386 in partial areas of a surface (that is, the outer circumferential surface of the cylinder) of the housing 386 facing the inner wall of the tube 161. Further, the MEMS mirror 381 is not located inside the housing 386, but is located in the concave portion of the cup-like shape to be separated from the housing 386. Also, the aberration correction elements 384 and 385 are assumed to be fixed to the housing 386 by supporting members or the like (not illustrated) in the inner space of the housing 386.

In the present modification example, as in the first embodiment, the scanning unit 380 can also be rotated together with the housing 386 about the y axis as the rotational axis by a rotation mechanism (not illustrated). Here, in the present modification example, the MEMS mirror 381 is located to be separated from the housing 386, as described above. Therefore, even when the scanning unit 380 is rotated, the MEMS minor 381 is not rotated. In the present modification example, the MEMS minor 381 which is an optical path changing element is not rotated together with the scanning unit 380 and changes the optical path of the laser light in the direction of the objective lens 382 or 383 facing the window unit 162 by changing the angle or the surface shape of the reflection surface in synchronization with the rotation of the scanning unit 380. That is, the biological tissue 500 is scanned with the laser light by allowing the MEMS minor 381 to change the optical path of the laser light. For example, when the scanning unit 380 is rotated at a predetermined angle from the state illustrated in FIG. 7A and the aberration correction element 385 and the objective lens 383 thus arrive at positions facing the window unit 162, the MEMS mirror 381 changes the optical path of the laser light by changing the angle or the surface shape such that the laser light is incident on the aberration correction element 385 and the objective lens 383.

In the present modification example, as in the first embodiment, the scanning unit 380 can also be moved translationally together with the housing 386 in the y axis direction by a translational movement mechanism (not illustrated). When the scanning unit 380 is moved translationally in the y axis direction, the MEMS mirror 381 may be moved translationally together with the scanning unit 380. Thus, in the present modification example, the biological tissue 500 is scanned with the laser light in the x axis direction through the polarization of the optical path of the laser light by the dynamic control of the angle or the shape of the reflection surface of the MEMS minor 381 and the biological tissue 500 is scanned with the laser light in the y axis direction through the translational movement of the scanning unit 370 (and the MEMS mirror 381) by the translational movement mechanism in the y axis direction.

However, the MEMS mirror 381 may not be moved translationally with the translational movement of the scanning unit 380 in the y axis direction. That is, the position of the MEMS mirror 381 may be unchanged with respect to the rotation of the scanning unit 380 about the y axis as the rotational axis and the translational movement in the y axis direction. Even when the MEMS mirror 381 is not rotated and is not moved translationally together with the scanning unit 380, the MEMS minor 381 can perform the scanning of the biological tissue 500 with the laser light by changing the angle or the surface shape of the reflection surface in synchronization with the rotation and the translational movement of the scanning unit 380 and changing the optical path of the laser light in the direction of the objective lens 382 or 383 facing the window unit 162.

Also, the MEMS mirror 381 is assumed to be supported by a supporting member or the like (not illustrated) in the concave portion of the cup-like shape of the housing 386 such that the above-described driving is not interfered with. For example, the MEMS mirror 381 may be connected to a substantial center (a portion corresponding to the rotational axis of the housing 386) of the bottom surface of the concave portion of the cup-like shape of the housing 386 by the supporting member. In addition, by providing a mechanism cancelling the rotation of the housing 386 in the supporting member, it is possible to realize a configuration in which the MEMS mirror 381 is not rotated even when the housing 386 is rotated.

As described with reference to FIGS. 7A and 7B, according to the present modification example, the condition of the reflection surface in the MEMS mirror 381 (e.g., an angle and shape of the reflection surface) can be dynamically changed, thereby scanning the biological tissue 500 with laser light. The control of laser light scanning is performed by controlling the MEMS minor 381, and thus a laser scanning having a higher degree of freedom can be achieved.

The MEMS mirror 381 is an example of a light deflection device (light deflection element) capable of dynamically changing the light reflection direction. When other light deflection devices are used instead of the MEMS minor 381, it is possible to implement the configuration similar to the above-described configuration and to achieve similar advantageous effects. In the present modification example, the rotation mechanism may not be provided. For example, on the optical path of laser light in the tube, an objective lens, an aberration correction element, and a MEMS mirror are provided in this order. The condition of the reflection surface of the MEMS mirror is dynamically controlled so that a window unit is provided on the outer wall of the tube in the area corresponding to the position at which the MEMS mirror is disposed in the longitudinal direction of the tube and the laser light, which passes through the objective lens and the aberration correction element and is incident onto the MEMS minor, scans biological tissue as an observation target through the window unit in the x-axis direction. This configuration allows the laser light scanning of an observation target in the x-axis direction without the rotation of a component in the tube.

(4-1-3. Configuration in Which Scanning Unit Includes Optical Path Branching Element)

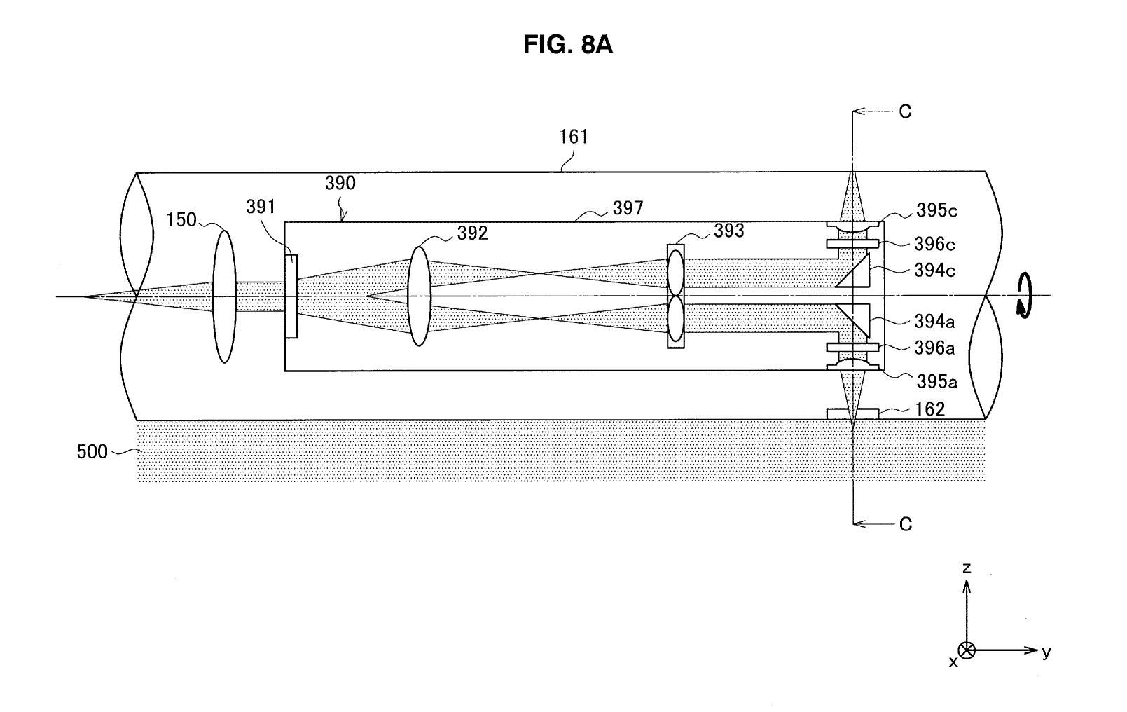

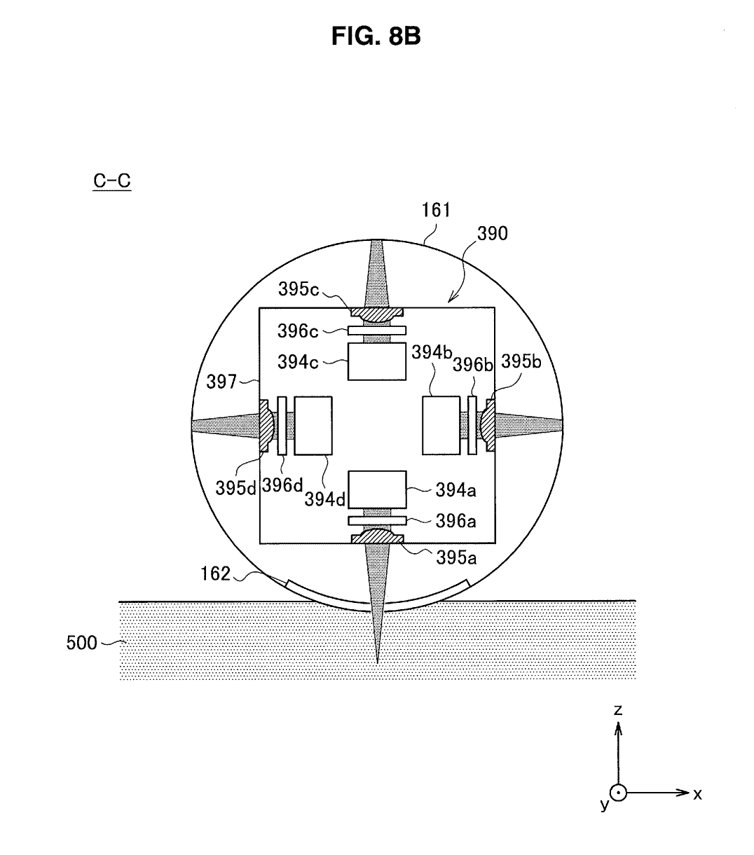

Next, a configuration in which a scanning unit includes an optical path branching element will be described with reference to FIGS. 8A and 8B as a specific configuration example in which a scanning unit includes a plurality of objective lenses. FIGS. 8A and 8B are schematic diagrams illustrating one configuration example of the scanning unit when the scanning unit includes the optical path branching element. In FIGS. 8A and 8B, for the sake of simplicity, only the configuration of the scanning unit and the vicinity of the scanning unit is mainly illustrated in the configuration of the laser scanning endoscopic device according to an embodiment of the present disclosure. Also, FIG. 8A schematically illustrates a cross-sectional view when the configuration of the scanning unit and the vicinity of the scanning unit is cut out on the cross-sectional surface parallel to the y-z plane through the center axis of the tube. Also, FIG. 8B illustrates a cross-sectional view when the configuration of the scanning unit and the vicinity of the scanning unit is cut out on the cross-sectional surface taken along the line C-C illustrated in FIG. 8A.

Referring to FIGS. 8A and 8B, a scanning unit 390 includes an optical path branching element 391, a lens 392, a lens array 393, optical path changing elements 394a, 394b, 394c, and 394d, objective lenses 395a, 395b, 395c, and 395d, aberration correction elements 396a, 396b, 396c, and 396d, and a housing 397. Thus, the scanning unit 390 according to the present modification example includes the four objective lenses 395a, 395b, 395c, and 395d. As illustrated in FIG. 8B, the four objective lenses 395a, 395b, 395c, and 395d are located at positions rotated 90 degrees in the scanning unit 390 when viewed in the y axis direction.

The aberration correction elements 396a, 396b, 396c, and 396d and the optical path changing elements 394a, 394b, 394c, and 394d are located at the front stages of the objective lenses 395a, 395b, 395c, and 395d, respectively. The aberration correction elements 396a, 396b, 396c, and 396d have the same function as the aberration correction element 166 described with reference to FIG. 2 and have a function of at least correcting aberration occurring when the laser light is collected on the foregoing biological tissue. Also, in the example illustrated in FIGS. 8A and 8B, the optical path changing elements 394a, 394b, 394c, and 394d are, for example, folding minors and have the same function as the optical path changing element 164 described with reference to FIG. 2. That is, the optical path changing elements 394a, 394b, 394c, and 394d guide the laser light incident on the scanning unit 390 to the lens surfaces of the objective lenses 395a, 395b, 395c, and 395d.

The housing 397 houses each constituent member of the scanning unit 390 in its inner space. In the present modification example, as illustrated in FIGS. 8A and 8B, the housing 397 has a substantially rectangular shape having a space therein, and the optical path branching element 391, the lens 392, the lens array 393, the optical path changing elements 394a, 394b, 394c, and 394d, and the aberration correction elements 396a, 396b, 396c, and 396d are arranged in the inner space. Also, the objective lenses 395a, 395b, 395c, and 395d are arranged in partial areas of four surfaces facing the inner wall of the tube 161 of the housing 397. Also, the optical path branching element 391, the lens 392, the lens array 393, the optical path changing elements 394a, 394b, 394c, and 394d, and the aberration correction elements 396a, 396b, 396c, and 396d are assumed to be fixed to the housing 397 by supporting members or the like (not illustrated) in the inner space of the housing 397.

In the present modification example, as illustrated in FIG. 8A, the laser light guided inside the tube 161 by an optical fiber (not illustrated) is collimated to substantially parallel light by an optical fiber light-guiding lens 150 and is incident on the optical path branching element 391 provided on one side of the housing 397. The optical path branching element 391 is a kind of beam splitter and can branch the incident laser light into a plurality of optical paths. For example, the optical path branching element 391 may branch the laser light incident by a diffractive grating into a plurality of optical paths. In the present modification example, the optical path branching element 391 branches the incident laser light into four optical paths.

The laser light branched into the four optical paths is collected on the lens array 393 via the lens 392. The lens array 393 is an array in which the same number of lenses as the number of paths into which the laser light is branched are arranged in an array form. The branched laser light is collimated to substantial parallel light by lenses included in the lens array 393 and is incident on the optical path changing elements 394a, 394b, 394c, and 394d. The optical path changing elements 394a, 394b, 394c, and 394d guide the incident light to the corresponding aberration correction elements 396a, 396b, 396c, and 396d and the corresponding objective lenses 395a, 395b, 395c, and 395d, respectively.

In the present modification example, as in the first embodiment, the scanning unit 390 can also be rotated together with the housing 397 about the y axis as the rotational axis by a rotation mechanism (not illustrated). Also, as in the first embodiment, the scanning unit 390 can be moved translationally together with the housing 397 in the y axis direction by a translational movement mechanism (not illustrated). Thus, in the present modification example, the biological tissue 500 is scanned with the laser light in the x axis direction through the rotation of the scanning unit 390 about the y axis as the rotational axis by the rotation mechanism and the biological tissue 500 is scanned with the laser light in the y axis direction through the translational movement of the scanning unit 390 in the y axis direction by the translational movement mechanism.

In the present modification example, as described above with reference to FIGS. 8A and 8B, the laser light incident on the scanning unit 390 is branched into a plurality of paths of laser light, e.g., four paths of laser light, by the optical path branching element 391. Then, the branched laser light is guided toward the objective lenses 395a, 395b, 395c, and 395d by the optical path changing elements 394a, 394b, 394c, and 394d, respectively. In the present modification example, by rotating the scanning unit 390 about the y axis as the rotational axis in this state, the biological tissue 500 is scanned with the laser light via the window unit 162 four times while the scanning unit 390 is rotated once. Accordingly, scanning with the laser light can be performed more efficiently since the number of lines scanned through one rotation of the scanning unit 390 can be increased.

(4-1-4. Configuration in Which Incident Position of Laser Light with Respect to Tube is Fixed)

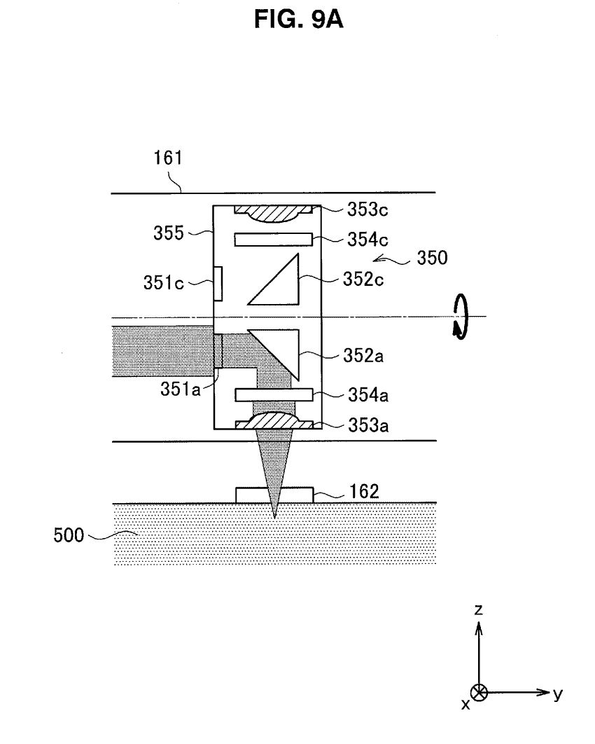

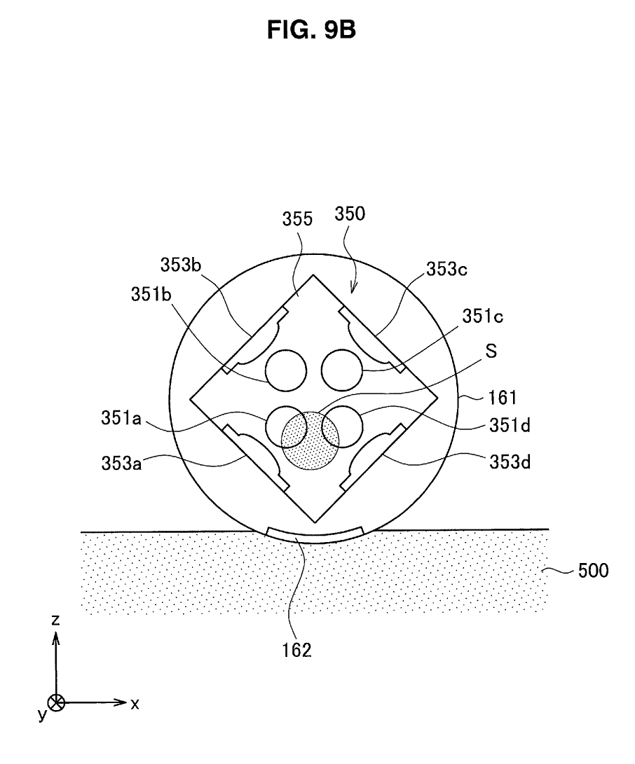

Next, a configuration in which an incident position of the laser light with respect to a tube is fixed will be described with reference to FIGS. 9A and 9B as a specific configuration example in which a scanning unit includes a plurality of objective lenses. FIGS. 9A and 9B are schematic diagrams illustrating one configuration example of a scanning unit when an incident position of the laser light with respect to a tube is fixed. In FIGS. 9A and 9B, for the sake of simplicity, only the configuration of the scanning unit and the vicinity of the scanning unit is mainly illustrated in the configuration of the laser scanning endoscopic device according to an embodiment of the present disclosure. Also, FIG. 9A schematically illustrates a cross-sectional view when the configuration of the scanning unit and the vicinity of the scanning unit is cut out on the cross-sectional surface parallel to the y-z plane through the center axis of the tube. Also, FIG. 9B illustrates a state when the configuration of the scanning unit and the vicinity of the scanning unit is viewed in the negative direction (a direction in which the laser light is incident) of the y axis. Here, FIG. 9B illustrates a state in which the scanning unit is rotated at a predetermined angle about the y axis as the rotational axis and illustrates objective lenses through the housing of the scanning unit.

Referring to FIGS. 9A and 9B, a scanning unit 350 includes incident window units 351a, 351b, 351c, and 351d, optical path changing elements 352a, 352b, 352c, and 352d, objective lenses 353a, 353b, 353c, and 353d, aberration correction elements 354a, 354b, 354c, and 354d and a housing 355. Thus, the scanning unit 350 according to the present modification example includes the four objective lenses 353a, 353b, 353c, and 353d. Also, as illustrated in FIG. 9B, the four objective lenses 353a, 353b, 353c, and 353d are located at positions rotated 90 degrees in the scanning unit 350 when viewed in the y axis direction.

Also, the aberration correction elements 354a, 354b, 354c, and 354d and the optical path changing elements 352a, 352b, 352c, and 352d are located at the front stages of the objective lenses 353a, 353b, 353c, and 353d, respectively. The aberration correction elements 354a, 354b, 354c, and 354d have the same function as the aberration correction element 166 described with reference to FIG. 2 and have a function of at least correcting aberration occurring when the laser light is collected on the foregoing biological tissue. Also, in the example illustrated in FIGS. 9A and 9B, the optical path changing elements 352a, 352b, 352c, and 352d are, for example, folding mirrors and have the same function as the optical path changing element 164 described with reference to FIG. 2. That is, the optical path changing elements 352a, 352b, 352c, and 352d guide the laser light incident on the scanning unit 350 to the lens surfaces of the objective lenses 353a, 353b, 353c, and 353d.

The housing 355 houses each constituent member of the scanning unit 350 in its inner space. In the present modification example, as illustrated in FIGS. 9A and 9B, the housing 355 has a substantially rectangular shape having a space therein, and the optical path changing elements 352a, 352b, 352c, and 352d and aberration correction elements 354a, 354b, 354c, and 354d are arranged in the inner space. Also, the objective lenses 353a, 353b, 353c, and 353d are arranged in partial areas of four surfaces facing the inner wall of the tube 161 of the housing 397. Also, the optical path changing elements 352a, 352b, 352c, and 352d and the aberration correction elements 354a, 354b, 354c, and 354d are assumed to be fixed to the housing 355 by supporting members or the like (not illustrated) in the inner space of the housing 355.

The incident window units 351a, 351b, 351c, and 351d are formed at positions facing the optical path changing elements 352a, 352b, 352c, and 352d on the surfaces of the housing 355 located in the negative direction of the y axis. Here, the housing 355 is formed of a material that does not pass the laser light at the wavelength band of the incident laser light and the incident window units 351a, 351b, 351c, and 351d are formed of a material that passes the laser light. Accordingly, in the present modification example, as illustrated in FIG. 9A, the laser light incident in the negative direction of the y axis and applied to the scanning unit 350 passes through the incident window units 351a, 351b, 351c, and 351d of the housing 355 and is incident on the optical path changing elements 352a, 352b, 352c, and 352d inside the housing 355. Here, FIG. 9A illustrates a state of the rear stage at which the laser light guided inside the tube 161 by an optical fiber (not illustrated) is collimated to substantially parallel light by an optical fiber light-guiding lens (not illustrated).

In the present modification example, as in the first embodiment, the scanning unit 350 can also be rotated together with the housing 355 about the y axis as the rotational axis by a rotation mechanism (not illustrated). Also, as in the first embodiment, the scanning unit 350 can be moved translationally together with the housing 355 in the y axis direction by a translational movement mechanism (not illustrated). Thus, in the present modification example, the biological tissue 500 is scanned with the laser light in the x axis direction through the rotation of the scanning unit 350 by the rotation mechanism about the y axis as the rotational axis and the biological tissue 500 is scanned with the laser light in the y axis direction through the translational movement of the scanning unit 350 in the y axis direction by the translational movement mechanism.

In the present modification example, a position at which the laser light is incident is fixed with respect to the tube 161. That is, in a state in which the optical axis of the laser light is maintained at a predetermined position with respect to the tube 161, the scanning unit 350 is rotated about the y axis as the rotational axis and is moved translationally in the y axis direction. Here, as described above, in the housing 355 of the scanning unit 350, the incident window units 351a, 351b, 351c, and 351d are formed at the positions facing the optical path changing elements 352a, 352b, 352c, and 352d. Accordingly, as illustrated in FIG. 9B, the scanning unit 350 is rotated and the laser light is incident on the inside of the housing 355 to be scanned from the corresponding incident window unit 351a, 351b, 351c, or 351d at a timing at which the incident window unit 351a, 351b, 351c, or 351d is located within the area of an irradiation spot S of the laser light in the housing 355.

Here, in the present modification example, as illustrated in FIG. 9B, a case in which the laser light is simultaneously applied to the plurality of incident window units 351a and 351d is considered. In this case, when the laser light incident from the incident window unit 351a and the laser light incident from the incident window unit 351d are simultaneously applied to the biological tissue 500, the laser light may be simultaneously applied to two different regions of the biological tissue 500 and the returning light from the two regions may be simultaneously detected, and thus this scanning is not preferable as laser scanning. Accordingly, a beam diameter (corresponding to the diameter of a circle indicating the irradiation spot S illustrated in FIG. 9B) of the laser light applied to the housing 355, the sizes of the incident window units 351a, 351b, 351c, and 351d, an interval at which the incident window units 351a, 351b, 351c, and 351d are located, and the like may be designed such that the laser light incident from the mutually different incident window units 351a, 351b, 351c, and 351d is prevented from being simultaneously applied to the biological tissue 500. For example, the beam diameter of the laser light may be about 1.5 times the size of the incident window units 351a, 351b, 351c, and 351d.

In the present modification example, as described above with reference to FIGS. 9A and 9B, the laser light is incident on the scanning unit 350 when the incident position of the laser light with respect to the tube 161 is fixed. In addition, on the surface of the housing 355 on which the laser light is incident, the incident window units 351a, 351b, 351c, and 351d are formed at the positions which are different from each other and correspond to the optical path changing elements 352a, 352b, 352c, and 352d provided inside the housing 355. In this state, by rotating the scanning unit 350 about the y axis as the rotational axis, the laser scanning with the laser light incident from any one of the incident window units 351a, 351b, 351c, and 351d is performed on the biological tissue 500. Accordingly, in the present modification example, the biological tissue 500 is scanned with the laser light via the window unit 162 four times while the scanning unit 350 is rotated once. Accordingly, scanning with the laser light can be efficiently performed since the number of lines scanned through one rotation of the scanning unit 390 can be increased. Also, the foregoing efficiency (the laser scanning is performed four times while the scanning unit 350 is rotated once) in the laser scanning is substantially the same as the efficiency of the laser scanning in the scanning unit 390 illustrated in FIGS. 8A and 8B. However, as illustrated in FIGS. 9A and 9B, the scanning unit 350 according to the present modification example can include fewer constituent members than the scanning units 390. Accordingly, in the present modification example, it is possible to realize substantially the same efficiency as that of the scanning unit 390 illustrated in FIGS. 8A and 8B in the laser scanning with a simpler configuration.

The specific configuration examples of the modification examples in which the scanning unit includes the plurality of objective lenses have been described above referring to FIGS. 6A, 6B, 7A, 7B, 8A, 8B, 9A, and 9B as the modification examples of the laser scanning endoscopic devices 1 and 2 according to the first and second embodiments. In the present modification examples, as described above, the scanning unit includes the plurality of objective lenses, and thus the laser scanning of the plurality of lines by the plurality of objective lenses can be performed while the scanning unit is rotated once. Accordingly, scanning with the laser light can be performed more efficiently since the number of lines scanned through one rotation of the scanning unit can be increased.

(4-2. Other Configurations)

Next, other modification examples of the laser scanning endoscopic devices 1 and 2 according to the first and second embodiments of the present disclosure will be described.

(4-2-1. Configuration in Which Scanning Unit has Other Rotational Axis Direction)

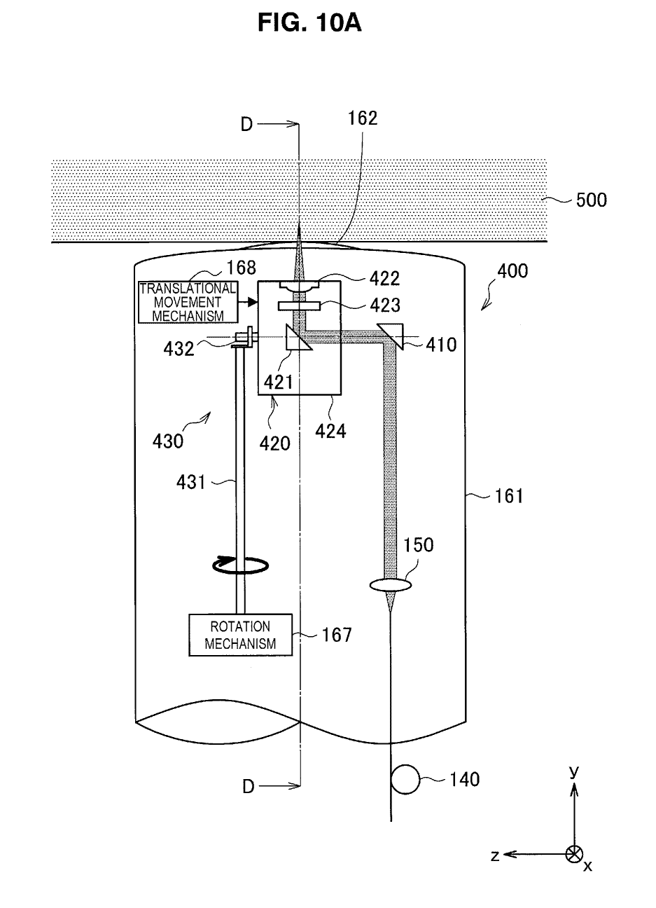

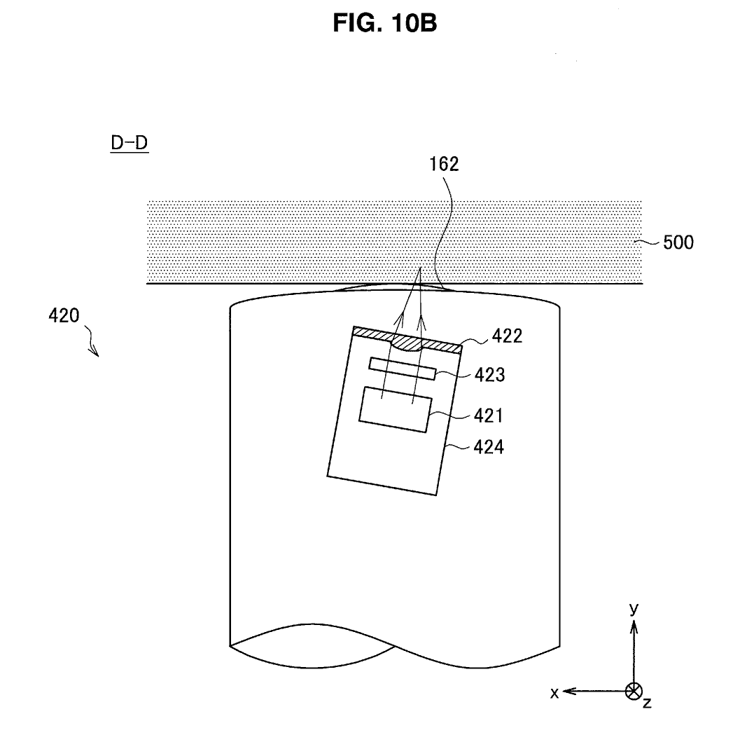

One configuration example of a modification example in which a scanning unit has another rotational axis direction will be described with reference to FIGS. 10A and 10B. FIG. 10A is a schematic diagram illustrating one configuration example of an endoscope in which a scanning unit has different rotational axis directions. FIG. 10B is a schematic diagram schematically illustrating the configuration of the scanning unit illustrated in FIG. 10A. Also, FIG. 10B is a diagram illustrating a state when a cross-sectional surface taken along the line D-D in FIG. 10A is viewed in the z axis direction. Here, FIG. 10B illustrates a state in which the scanning unit is rotated a predetermined angle about the y axis as a rotational axis. Here, in the present modification example, the configuration of the endoscope is different from that of the laser scanning endoscopic devices 1 and 2 according to the first and second embodiments illustrated in FIGS. 2 and 4A and the remaining configuration may be the same as that of the laser scanning endoscopic devices 1 and 2. Accordingly, the configuration of the endoscope, which is the distinguishing feature of the present modification example, will be mainly described in the following description. Also, in FIG. 10A, the configuration of the endoscope is mainly illustrated in the configuration of the laser scanning endoscope.

Referring to FIG. 10A, an endoscope 400 according to the present modification example includes a tube 161, a window unit 162, an optical fiber 140, an optical fiber light-guiding lens 150, a rotation mechanism 167, a translational movement mechanism 168, an optical path changing element 410, a scanning unit 420, and a rotation member 430. Also, since the functions of the tube 161, the window unit 162, the optical fiber 140, the optical fiber light-guiding lens 150, the rotation mechanism 167, and the translational movement mechanism 168 are the same as those of the constituent members described with reference to FIG. 2, the detailed description thereof will be omitted. In the present modification, however, the window unit 162 is provided at a distal portion in the longitudinal direction of the tube 161 rather than the side wall of the tube 161 and has a surface substantially perpendicular in the longitudinal direction of the tube 161. That is, the endoscope 400 according to the present modification example performs laser scanning when one end (distal portion) in the longitudinal direction of the tube 161 is brought into contact with the biological tissue 500. Also, in the present modification example, the shape of the window unit 162 may be a curved surface such as a spherical surface or a cylindrical surface, or may be a planar surface. In the example illustrated in FIGS. 10A and 10B, the window unit 162 has a curved surface with predetermined curvature.

In the present modification example, laser light guided inside the tube 161 by the optical fiber 140 is collimated to substantially parallel light by the optical fiber light-guiding lens 150 and is guided in the y axis direction inside the tube 161. The optical path changing element 410 is provided in a head portion of the endoscope 400, and thus the optical path of the laser light incident on the optical path changing element 410 is changed in the z axis direction and the laser light is incident on the scanning unit 420. Any optical element may be used as the optical path changing element 410 as long as the optical element can change the optical path of the laser light. For example, a folding minor may be used.

The scanning unit 420 includes an optical path changing element 421, an objective lens 422, an aberration correction element 423, and a housing 424. Also, since the functions and the configurations of the optical path changing element 421, the objective lens 422, the aberration correction element 423, and the housing 424 are the same as the functions and the configurations of the optical path changing element 164, the objective lens 165, the aberration correction element 166, and the housing 169 included in the scanning unit 163 according to the first and second embodiments, the detailed description thereof will be omitted. In the present embodiment, however, the scanning unit 420 is disposed such that the window unit 162 provided at the distal portion of the endoscope 400 faces the objective lens 422 and the laser light is collected on the biological tissue 500 via the window unit 162 by the objective lens 422. That is, as illustrated in FIG. 10A, the optical path of the laser light of which the optical path is changed in the z axis direction by the optical path changing element 410 and is incident on the scanning unit 420 is changed in the y axis direction by the optical path changing element 421 in the scanning unit 420, and then the laser light sequentially passes through the aberration correction element 423 and the objective lens 422 and is applied to the biological tissue 500.

In the present modification example, the scanning unit 420 is mechanically connected to the rotation mechanism 167 via the rotation member 430 and is thus rotated about the z axis as the rotational axis by the rotation mechanism 167. By rotating the scanning unit 420 about the z axis as the rotational axis when the laser light is applied from the scanning unit 420 to the biological tissue 500, the biological tissue 500 can be scanned with the laser light in the x axis direction in the distal portion of the endoscope 400. Also, in the present modification example, the translational movement mechanism 168 moves the scanning unit 420 translationally in the z axis direction. Accordingly, in the present modification example, the laser scanning on the x-z plane is performed on the biological tissue 500.

Here, the rotation member 430 includes a plurality of shafts 431 and 432. The shaft 431 extends in the longitudinal direction of the tube 161 inside the tube 161 and one end thereof is connected to the rotation mechanism 167. In addition, the shaft 431 is rotated about the y axis as the rotational axis by the rotation mechanism 167. A toothed wheel (gear) mechanism is provided at the other end of the shaft 431, and thus the gear mechanism is engaged and interlocked with one end of the shaft 432 likewise provided with a gear mechanism. The shaft 432 extends in the z axis direction, which is a direction about 90 degrees from the longitudinal direction of the tube 161, inside the tube 161 so that the one end thereof is connected with the shaft 431 via the gear mechanism, as described above, and the other end is connected with the scanning unit 420. By connecting the rotation mechanism 167 to the rotation member 430 in this way, a rotational motion about the y axis as the rotational axis by the rotation mechanism 167 is finally transmitted to the scanning unit 420 as a rotation motion about the z axis as the rotational axis. Accordingly, the rotation mechanism 167 can rotate the scanning unit 420 about the z axis as the rotational axis.

In the present modification example, the configurations of the rotation mechanism 167 and the rotation member 430 are not limited to the example, but any configuration can be realized as long as the scanning unit 420 can be rotated about the z axis as the rotational axis.

One configuration example of the modification example in which the scanning unit has another rotational axis direction has been described above referring to FIGS. 10A and 10B as a modification example of the laser scanning endoscopic devices 1 and 2 according to the first and second embodiments. In the present modification example, the window unit 162 is provided at the distal portion in the longitudinal direction of the tube 161 and has the surface substantially perpendicular to the longitudinal direction of the tube 161. In addition, the laser scanning is performed on a portion brought into contact with the distal portion of the tube 161. Accordingly, for example, even when an examination target part is present in a recessed concave portion inside a body cavity that is difficult to bring in contact with the side wall of the tube 161, an examination can be carried out through the laser scanning.

The endoscope 160 in which the window unit 162 is provided on the side wall of the tube 161 as in the laser scanning endoscopic devices 1 and 2 according to the first and second embodiments and the endoscope 400 in which the window unit 162 is provided at the distal portion of the tube 161 as in the present modification example may be exchanged with respect to the same device body. Whether to use the configuration of the endoscope in which the window unit 162 is provided on the side wall of the tube 161 or the configuration of the endoscope in which the window unit 162 is provided at the distal portion of the tube 161 may be appropriately selected according to the shape or the like of an examination target part by a user.

(4-2-2. Modification of Arrangement of Objective Lenses in Longitudinal Direction of Tube)

In the modification example described in the above item 4-1 (Configuration in which scanning unit includes plurality of objective lenses), the description has been given of the case where the plurality of objective lenses are arranged in a row along the circumferential direction of the tube 161 at substantially the same position in the longitudinal direction of the tube 161. However, the present embodiment is not limited thereto. For example, the plurality of objective lenses may be arranged in a row along the longitudinal direction of the tube 161.

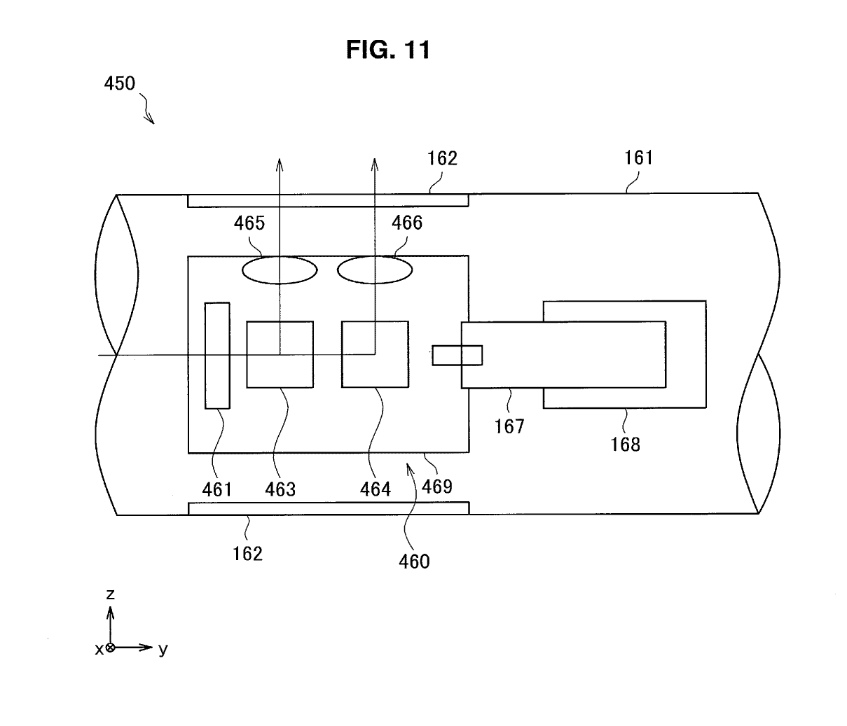

A modification example in which the plurality of objective lens are arranged in the longitudinal direction of the tube as described above will be described with reference to FIG. 11. FIG. 11 is a schematic diagram illustrating an exemplary configuration of an endoscope according to a modification example in which the plurality of objective lenses are arranged in the longitudinal direction of the tube.

Referring to FIG. 11, an endo scope 450 according to the present modification example is configured to include a tube 161, a window unit 162, a rotation mechanism 167, a translational movement mechanism 168, and a scanning unit 460. The tube 161, the window unit 162, the rotation mechanism 167, and the translational movement mechanism 168 have functions similar to those of components described with reference to FIG. 2, and thus detailed description thereof will be omitted. Although not illustrated in FIG. 11 for simplicity, the endo scope 450 has the configuration similar to that of the endoscope 160 including the optical fiber 140 and the optical fiber light-guiding lens 150 as illustrated in FIG. 2. The laser light guided within the tube 161 through the optical fiber is collimated into a substantially parallel beam of light by the optical fiber light-guiding lens, is guided in the y-axis direction within the tube 161, and is incident on the scanning unit 460.

The scanning unit 460 according to the present modification example is configured to include an aberration correction element 461, a first optical path changing element 463, a second optical path changing element 464, a first objective lens 465, and a second objective lens 466, which are accommodated within a housing 469. As illustrated in FIG. 11, in the present modification example, the first objective lens 465 and the second objective lens 466 are arranged in a row to face in substantially the same direction as each other (i.e. in substantially the same position in the circumferential direction of the tube 161) along the longitudinal direction of the tube 161. The first optical path changing element 463 and the second optical path changing element 464 are provided to correspond to the first objective lens 465 and the second objective lens 466, respectively. The respective function and configuration of the aberration correction element 461 and the housing 469 are similar to those of the aberration correction element 166 and the housing 169 illustrated in FIG. 2, and thus detailed description thereof will be omitted. The function and configuration of the first objective lens 465 and the second objective lens 466 are similar to those of the objective lens 165 illustrated in FIG. 2, and thus detailed description thereof will be omitted.

The first optical path changing element 463 may be, for example, a beam splitter. The first optical path changing element 463 guides some of the laser light, which is guided within the tube 161, to the second optical path changing element 464 in a stage following the first optical path changing element 463 and guides others to the first objective lens 465 provided in association with the first optical path changing element 463. The second optical path changing element 464 may be, for example, a folding minor. The second optical path changing element 464 guides the laser light, which is guided by passing through the first optical path changing element 463 in a front stage of the second optical path changing element 464, to the second objective lens 466 provided in association with the second optical path changing element 464. The laser light in which its optical path is changed by the first optical path changing element 463 and the second optical path changing element 46 passes through the first objective lens 465 and the second objective lens 466, respectively, and is applied to a biological tissue to be observed (not shown) through the window unit 162. In this way, in the present modification example, the laser light is applied to a biological tissue at two different spots in the y-axis direction. In the present modification example, as is the case with the scanning unit 163 of the endoscope 160 illustrated in FIG. 2, the scanning unit 460 rotates by the rotation mechanism 167 in the y-axis direction serving as the direction of the rotation axis and is moved translationally in the y-axis direction by the translational movement mechanism 168. Thus, the endoscope 450 according to the present modification example makes it possible to scan a plurality of lines with the laser light applied to a plurality of spots (two spots in the example illustrated in FIG. 11) in the y-axis direction during one rotation of the scanning unit 460.

To distinguish optical signals obtained by irradiation of a plurality of spots using laser light, the laser light is subjected to temporal modulation of its wavelength, angle, or polarization, and then is incident on the first optical path changing element 463. Thus, the transmission and reflection of the laser light in the first optical path changing device 463 may be controlled depending on the modulation of laser light. An example of the optical path changing element 463 that can be used for such control includes optical devices such as a dichroic mirror (an example of optical element that splits a beam of laser light depending on a wavelength), a volume holographic diffraction element (an example of optical element that splits a beam of laser light depending on an angle), and a polarization beam splitter (an example of optical element that splits a beam of laser light depending on polarization). The laser light incident on the first optical path changing device 463 and the second optical path changing device 464 is preferably as close as possible to a parallel beam of light so that the depth of observation in the biological tissue is not changed.

The endoscope 160 allows the translational movement mechanism 168 to move the scanning unit 163 in the y-axis direction upon the laser light scanning in the y-axis direction. Thus, when it is intended to obtain a wider field of view in the y-axis direction, a stroke of the scanning unit 163 in the y-axis direction is necessary to be large. When the stroke is large, to maintain the positional accuracy of the optical system of the scanning unit 163 with high precision while driving the scanning unit 163 at high speed, the degree of accuracy for each component, for example, mechanical rigidity necessary for an axial guide assembly or feeding mechanism of the translational movement mechanism 168, is necessary to be higher. On the other hand, according to the present modification example, the first objective lens 465 and the second objective lens 466 provided in a row in the y-axis direction makes it possible to irradiate a plurality of spots with laser light in the y-axis direction. Thus, it is possible to obtain a wider field of view in the y-axis direction, without increasing the stroke of the scanning unit 460 performed by the translational movement mechanism 168. The configuration according to the present modification example may be especially suitably applicable to a case where the field of view in the y-axis direction is wider than the diameter of aperture of the objective lens.

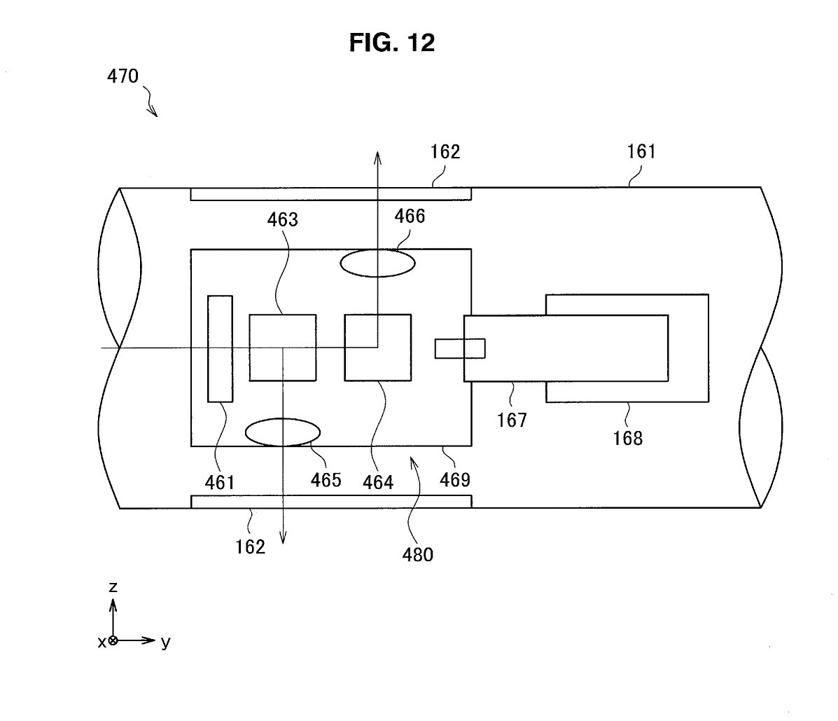

FIG. 12 illustrates another exemplary configuration of the endoscope according to the present modification example shown in FIG. 11. FIG. 12 is a schematic diagram illustrating another exemplary configuration of an endoscope according to a modification example in which a plurality of objective lenses are arranged in the longitudinal direction. Referring to FIG. 12, an endoscope 470 according to the present modification example is configured to include a tube 161, a window unit 162, a rotation mechanism 167, a translational movement mechanism 168, and a scanning unit 480. The scanning unit 480 is configured to include an aberration correction element 461, a first optical path changing element 463, a second optical path changing element 464, a first objective lens 465, and a second objective lens 466, which are accommodated within a housing 469. Referring to FIG. 12, in the endoscope 470 according to the present modification example, the first objective lens 465 and the second objective lens 466 are arranged along the longitudinal direction of the tube 161. They are positioned in approximately 180-degree opposite directions from each other (i.e. approximately 180 degrees of rotation relative to each other in the circumferential direction of the tuber 161). Other configurations are similar to those of the endoscope 450 described above with reference to FIG. 11, and thus detailed description thereof will be omitted.

In the endoscope 470 illustrated in FIG. 12, it is possible to distinguish which one of the first objective lens 465 and the second objective lens 466 allows an biological tissue to be irradiated with laser light based on the rotational phase of the scanning unit 480. Thus, the detection of the returning light from a biological tissue in synchronization with rotation of the scanning unit 480 eliminates the necessity to perform the laser light modulation for distinguishing signals as described above.

The modification example in which the plurality of objective lenses are arranged in the longitudinal direction of the tube has been described above with reference to FIGS. 11 and 12. As described above, according to the present modification example, the first objective lens 465 and the second objective lens 466 provided in a row in the y-axis direction makes it possible to irradiate a plurality of spots with laser light in the y-axis direction. Thus, it is possible to obtain a wider field of view in the y-axis direction, without increasing the stroke of the scanning unit 460 performed by the translational movement mechanism 168. As illustrated in FIGS. 11 and 12, according to the present modification example, the first objective lens 465 and the second objective lens 466 may be arranged to face in substantially the same direction as each other, or may be arranged to face in different directions from each other. The arrangement of the first objective lens 465 and the second objective lens 466 is not limited to the examples illustrated in FIGS. 11 and 12. A plurality of objective lenses may be arranged in a spiral along the longitudinal direction of the tube 161. In the present modification example, an astigmatism correction element (active astigmatism correction element as described later) capable of dynamically changing the amount of correction of astigmatism as described later in item 6-2-2 (Astigmatism correction element) may be used as the aberration correction element 462. The amount of correction may be suitably adjusted by the active astigmatism correction element in synchronization with rotation of the scanning unit 460 or 480, and thus it is possible to reduce the influence of aberration caused by relative alignment error of a plurality of objective lenses.

### 5. CONFIGURATION OF ABERRATION CORRECTION ELEMENT

Next, specific configurations of the aberration correction element 166 illustrated in FIGS. 2 and 3 will be described. As described in the foregoing (2. First embodiment), the aberration correction element 166 according to the present embodiment corrects aberration occurring when the laser light is collected on the biological tissue 500. Examples of the aberration include chromatic aberration, spherical aberration, comatic aberration, and astigmatism.

Among these aberrations, the influence of the chromatic aberration is considered to be relatively small since, for example, the laser light with a specific wavelength band such as near-infrared light is used in many cases when a biological tissue is examined as in the present embodiment. The spherical aberration occurring, for example, due to the window unit 162, can be mostly corrected by configuring the objective lens 165 as an aspheric lens and adjusting optical characteristics such as the curvature, thickness, and aspheric coefficient of the aspheric lens. Accordingly, a specific configuration of the aberration correction element 166 correcting astigmatism occurring in the objective lens 165 and the window unit 162 among the aberrations will be mainly described below. In the present embodiment, however, an element correcting chromatic aberration or an element correcting spherical aberration may be further provided aside from an element correcting astigmatism. For example, when the wavelength bands of excitation light (light applied to the biological tissue 500) of fluorescent observation or the like and biological signal light (returning light from the biological tissue 500) are different, an element correcting chromatic aberration is preferably disposed separately so that the returning light is efficiently guided to the fiber. Also, for example, to correct spherical aberration due to the window unit or thickness of the biological tissue, a spherical aberration correction element may be separately disposed in conjunction with the adjustment of the optical characteristics of the objective lens 165 described above.

As described above in item 2 (First embodiment), the laser scanning observation device according to the exemplary embodiments of the present disclosure may be provided with a depth-of-observation adjusting mechanism used to change the depth of observation. The laser scanning observation device provided with such a depth-of-observation adjusting mechanism may be suitably applicable to an aberration correction element that is designed to correct aberration in consideration of a change in aberration caused by a change in depth of observation. As described above, the laser scanning endoscopic device 1 allows an aberration correction element used to correct chromatic aberration to be suitably applicable to a case of performing observation using fluorescent light of two-photon excitation or the like or performing the observation with laser light of a plurality of different wavelengths. In this way, the detailed configuration of the aberration correction element in the case where the depth-of-observation adjusting mechanism is provided or observation using two-photon excitation is performed will be described in detail in item 6-2 (Laser scanning probe).

(5-1 Correction of Astigmatism)

A specific configuration example of an aberration correction element correcting astigmatism will be described. Before the specific configuration of the aberration correction element correcting astigmatism is described, the contents of astigmatism reviewed by the present inventors will be described.

As described above in (2. First embodiment), the degree of aberration occurring due to the objective lens 165 and the window unit 162 is affected by the value of NA of the objective lens 165 or the shape of the window unit 162. Specifically, the degree of aberration tends to increase as the NA of the objective lens 165 is higher, the thickness of constituent members of the window unit 162 is thicker, and the curvature of the window unit 162 is smaller (that is, the diameter (outer diameter) of the tube 161 is smaller).

The present inventors have investigated relations between the foregoing three parameters (the NA of the objective lens 165, the thickness of the window unit 162, and the diameter of the tube 161) and the degree of astigmatism in more detail by repeating a ray trace simulation while changing the three parameters, and have considered configurations for correcting the astigmatism. Also, the astigmatism mentioned here means a difference between a focal distance in the x axis direction illustrated in FIGS. 2 and 3 and a focal distance in the y axis direction.

From the foregoing considerations, the present inventors have learned that the degree of astigmatism increases in proportion to a square of an optical distance (a product of a refractive index of a medium and a distance in a depth direction) of a distance in the depth direction and increases in proportion to a square of the NA of the objective lens 165. Also, they have confirmed that the degree of astigmatism increases as the diameter (that is, the outer diameter of the window unit 162) of the tube 161 is smaller.

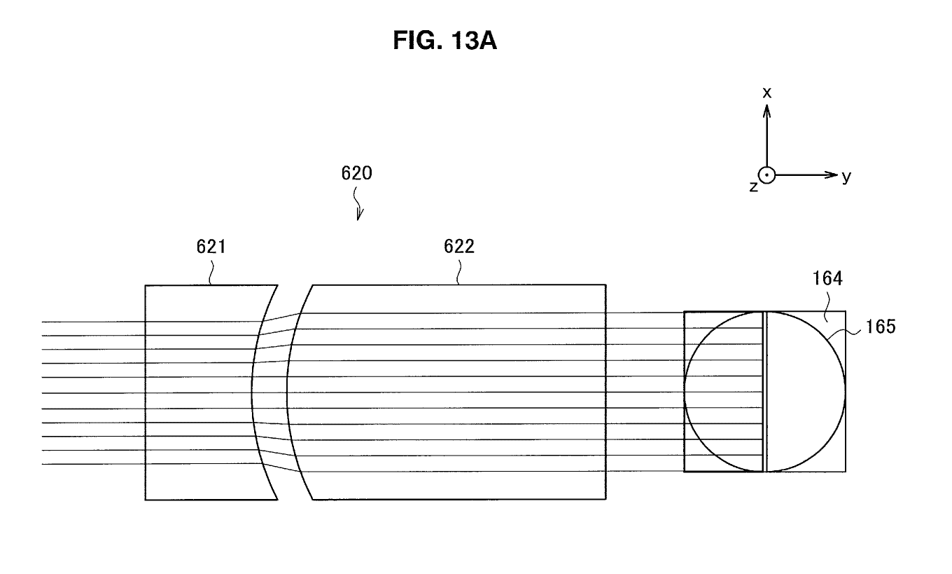

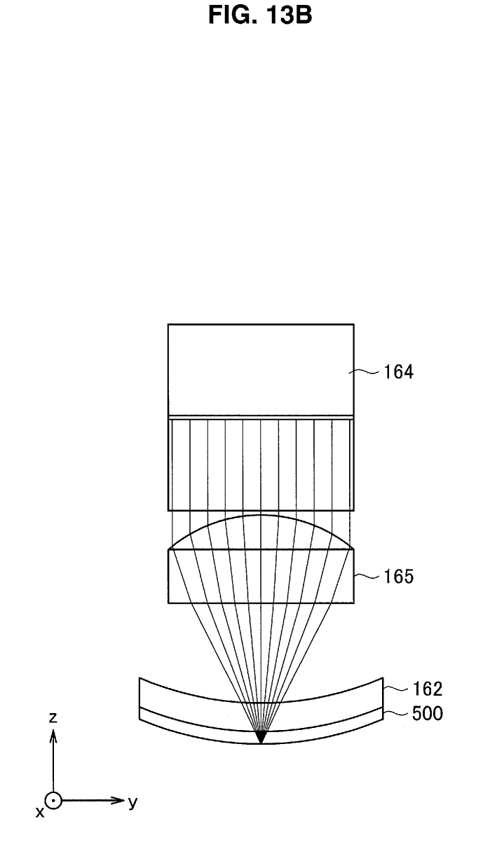

In light of the foregoing discoveries, the present inventors have considered configurations for correcting astigmatism. Hereinafter, specific configuration examples of an aberration correction element devised in light of the foregoing by the present inventors will be described with reference to FIGS. 13A, 13B, 14, and 15. Here, when spherical aberration is corrected by adjusting the optical characteristics of the objective lens 165 which is an aspheric lens, as described above, for example, parameters of the optical characteristics of the objective lens 165 can be adjusted such that a component in one of the x axis direction and the y axis direction in the spherical aberration is minimized. Accordingly, the present inventors have considered that the spherical aberration in the y axis direction (that is, y-z plane) illustrated in FIGS. 2 and 3, which is a direction in which the window unit 162 with a cylindrical shape can be regarded as a parallel plate, are corrected by adjusting the optical characteristics of the objective lens 165 and the spherical aberration on the x-z plane is corrected in conjunction with a configuration for correcting astigmatism. Thus, the specific configuration example of the aberration correction element to be described below is one example of a configuration having a function of not only correcting astigmatism but also correcting spherical aberration on the x-z plane.

Also, FIGS. 13A to 15 to be described below correspond to diagrams illustrating a state of the scanning unit 163 of the endoscope 160 and the vicinity of the scanning unit 163 illustrated in FIGS. 2 and 3. Specifically, in FIGS. 13A to 15, the window unit 162, the optical path changing element 164, the objective lens 165, the aberration correction element 166, and the biological tissue 500 are mainly illustrated in the configuration illustrated in FIGS. 2 and 3, and the configuration of the aberration correction element 166 is illustrated more specifically. Also, since the functions and the configurations of the window unit 162, the optical path changing element 164, and the objective lens 165 illustrated in FIGS. 13A to 15 are the same as the functions and the configurations of the constituent members described with reference to FIGS. 2 and 3, the detailed description of these constituent members will be omitted and the specific configurations of the aberration correction element 166 will be mainly described below. In addition, in the following description of the specific configurations of the aberration correction element 166, a case in which the optical path changing element 164 is a folding minor and the objective lens 165 is an aspheric lens will be described. Each of the specific configurations of the aberration correction element to be described below can be also applied to each of the aberration correction elements illustrated in FIGS. 5 to 10B.

(5-1-1. Cylindrical Concave-Convex Lens Pair)

A cylindrical concave-convex lens pair which is one specific configuration example of the aberration correction element correcting astigmatism and spherical aberration on the x-z plane will be described with reference to FIGS. 13A and 13B. FIGS. 13A and 13B are schematic diagrams illustrating the configuration of the cylindrical concave-convex lens pair which is one configuration example of the aberration correction element 166 according to the present embodiment. Also, FIG. 13A illustrates a state when the scanning unit 163 of the endoscope 160 and the vicinity of the scanning unit 163 illustrated in FIG. 2 is viewed in the positive direction of the z axis. In addition, FIG. 13B illustrates a state when the scanning unit 163 of the endoscope 160 and the vicinity of the scanning unit 163 illustrated in FIG. 2 is viewed in the positive direction of the y axis. Here, FIG. 13A illustrates the objective lens 165 by projecting the optical path changing element 164. Also, in FIGS. 13A and 13B, for the sake of simplicity, only straight lines necessary for the description are mainly illustrated as straight lines indicating a pencil of laser light.

Referring to FIG. 13A, in the present configuration example, a cylindrical concave-convex lens pair 620 is located at the front stage of the optical path changing element 164. The cylindrical concave-convex lens pair 620 includes a concave cylindrical lens 621 having a concave lens surface and a convex cylindrical lens 622 having a convex lens surface. The cylindrical concave-convex lens pair 620 is an aberration correction element that corresponds to the aberration correction element 166 illustrated in FIGS. 2 and 3 and corrects astigmatism and spherical aberration on the x-z plane. In the present embodiment, the cylindrical concave-convex lens pair 620 is located at the front stage of the optical path changing element 164, that is, at the front stage of the objective lens 165, as illustrated in FIG. 13A.

The concave cylindrical lens 621 has one surface which is a plane surface and the other surface which faces the one surface and is a cylindrical surface of a concave shape. In addition, as illustrated in FIG. 13A, the concave cylindrical lens 621 is disposed such that the surface which is the plane surface is oriented in the negative direction of the y axis, that is, the direction in which the laser light is incident, and the surface which is the cylindrical surface of the concave shape is oriented in the negative direction of the y axis. Also, the concave cylindrical lens 621 is disposed such that the z axis direction is the axis direction of a cylinder of the cylindrical surface.

The convex cylindrical lens 622 has one surface which is a plane surface and the other surface which faces the one surface and is a cylindrical surface of a convex shape. In addition, as illustrated in FIG. 13A, the convex cylindrical lens 622 is disposed such that the surface which is the cylindrical surface of the convex shape is oriented in the negative direction of the y axis, that is, the direction in which the laser light is incident and the surface which is the plane surface is oriented in the positive direction of the y direction. That is, the concave cylindrical lens 621 and the convex cylindrical lens 622 are disposed such that the cylindrical surface of the convex shape of the convex cylindrical lens 622 faces the cylindrical surface of the concave shape of the concave cylindrical lens 621. Also, the convex cylindrical lens 622 is disposed such that the z axis direction is the axis direction of a cylinder of the cylindrical surface.

Referring to FIGS. 13A and 13B, the pencil of the laser light is indicated by straight lines. Also, the drawings illustrate a state in which the laser light collimated to substantially parallel light and guided in the y axis direction passes through the cylindrical concave-convex lens pair 620, the optical path of the laser light is changed in the z axis direction by the optical path changing element 164, and the laser light sequentially passes through the objective lens 165 and the window unit 162 and is applied to the biological tissue 500. Thus, in the present configuration example, the incident laser light sequentially passes through the plane surface and the cylindrical surface of the concave shape of the concave cylindrical lens 621 and the cylindrical surface of the convex shape and the plane surface of the convex cylindrical lens 622, and is incident on the optical path changing element 164. By disposing the cylindrical concave-convex lens pair 620, as illustrated in FIG. 13A, it is possible to correct the astigmatism and the spherical aberration on the x-z plane. Also, the cylindrical concave-convex lens pair 620 is rotated and/or moved translationally together with the scanning unit by a rotation mechanism (not illustrated) and/or a translational movement mechanism (not illustrated).

Here, the optical characteristics (for example, a material, a thickness, and curvature of the cylindrical surface) or the specific configuration of the cylindrical concave-convex lens pair 620 may be appropriately set according to the wavelength band of the incident laser light, the optical characteristics of the objective lens 165, the optical characteristics of the window unit 162, and the like. For example, the curvatures of the cylindrical surface of the concave cylindrical lens 621 and the cylindrical surface of the convex cylindrical lens 622 or a magnitude relation of both of the curvatures, the thickness of the concave cylindrical lens 621 and the convex cylindrical lens 622 in the optical axis direction (y axis direction), and the distance between the concave cylindrical lens 621 and the convex cylindrical lens 622 may be adjusted such that the astigmatism and the spherical aberration on the x-z plane are minimized.

(5-1-2. Cylindrical Meniscus Lens)

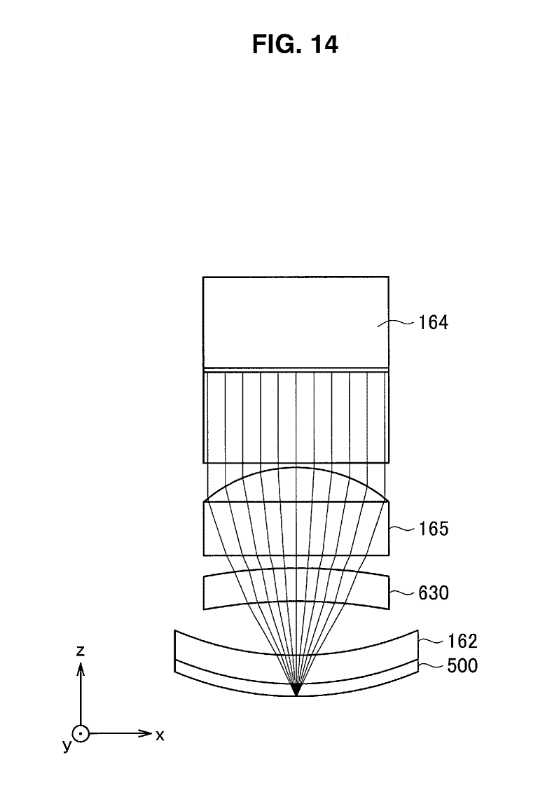

A cylindrical meniscus lens which is one configuration example of the aberration correction element correcting astigmatism and spherical aberration on the x-z plane will be described with reference to FIG. 14. FIG. 14 is a schematic diagram illustrating the configuration of the cylindrical meniscus lens which is one configuration example of the aberration correction element 166 according to the present embodiment. Also, FIG. 14 illustrates a state when the scanning unit 163 of the endoscope 160 and the vicinity of the scanning unit 163 illustrated in FIG. 2 is viewed in the positive direction of the y axis. Also, in FIG. 14, for the sake of simplicity, only straight lines necessary for the description are mainly illustrated as straight lines indicating a pencil of laser light.

Referring to FIG. 14, in the present configuration example, a cylindrical meniscus lens 630 is disposed between the objective lens 165 and the window unit 162. The cylindrical meniscus lens 630 is an aberration correction element that corresponds to the aberration correction element 166 illustrated in FIGS. 2 and 3 and has a function of correcting astigmatism and spherical aberration on the x-z plane.

The cylindrical meniscus lens 630 is a meniscus lens in which both surfaces are cylindrical surfaces. As illustrated in FIG. 14, the cylindrical surfaces which are both of the surfaces of the cylindrical meniscus lens 630 are formed such that the axis direction of both of the cylinders is the same direction and the curvatures of the cylindrical surfaces which are both of the surfaces have the same sign. In the present embodiment, as illustrated in FIG. 14, the cylindrical meniscus lens 630 is disposed such that the axis direction of the cylinder of the cylindrical surfaces is the y axis direction, that is, is the same as the axis direction of the cylinder of the cylindrical surface of the window unit 162. However, the cylindrical meniscus lens 630 is disposed such that the curvatures of the cylindrical surfaces have an opposite sign to that of the curvature of the cylindrical surface of the window unit 162. Also, in the example illustrated in FIG. 14, with regard to the cylindrical surfaces which are both of the surfaces of the cylindrical meniscus lens 630, the curvature of the cylindrical surface facing the objective lens 165 is greater than the curvature of the cylindrical surface facing the window unit 162.

Referring to FIG. 14, the pencil of the laser light is indicated by straight lines. Also, the drawing illustrates a state in which the optical path of the laser light collimated to substantially parallel light and guided in the y axis direction is changed in the z axis direction by the optical path changing element 164 and the laser light sequentially passes through the objective lens 165, the cylindrical meniscus lens 630, and the window unit 162 and is applied to the biological tissue 500. Thus, in the present configuration example, by disposing the cylindrical meniscus lens 630 between the objective lens 165 and the window unit 162, it is possible to correct the astigmatism and spherical aberration on the x-z plane. Also, the cylindrical meniscus lens 630 is rotated and/or moved translationally together with the scanning unit by a rotation mechanism (not illustrated) and/or a translational movement mechanism (not illustrated).

Here, the optical characteristics (for example, a material, a thickness, and curvature of the cylindrical surface) or the specific configuration of the cylindrical meniscus lens 630 may be appropriately set according to the wavelength band of the incident laser light, the optical characteristics of the objective lens 165, the optical characteristics of the window unit 162, and the like. For example, in the example illustrated in FIG. 14, the cylindrical meniscus lens 630 is formed such that the curvature of the cylindrical surface facing the objective lens 165 is greater than the curvature of the cylindrical surface facing the window unit 162, but the relation between the curvatures is not limited to this example. The values of the curvatures of the cylindrical surfaces which are both of the surfaces of the cylindrical meniscus lens 630 or a magnitude relation between the curvatures of the cylindrical surfaces may be adjusted such that high-order aberration, such as the astigmatism or spherical aberration on the x-z plane, is minimized.

As described above, the degree of astigmatism varies depending on the optical distance in the depth direction of observation (the product of a refractive index of a medium and a distance in a depth direction). As described above, when a lens system having at least two cylindrical surfaces is used such as the cylindrical concave-convex lens pair 620 and the cylindrical meniscus lens 630, the suitable adjustment of the curvature or shape of two curved surfaces makes it possible to implement the astigmatism correction element that corrects the astigmatism by the amount of correction corresponding to variation in astigmatism caused by a change in the depth of observation. Thus, when the laser scanning observation device according to the exemplary embodiment includes the depth-of-observation adjusting mechanism, the configuration as illustrated in the cylindrical concave-convex lens pair 620 and the cylindrical meniscus lens 630 described above may be suitably applicable as the astigmatism correction element that corrects astigmatism. The detailed description of the astigmatism correction element with the dependency of astigmatism on depth of observation taken into consideration will be described later in detail in item 6-2-2 (Astigmatism correction element).

(5-1-3. Cylindrical Plane-Concave Lens)

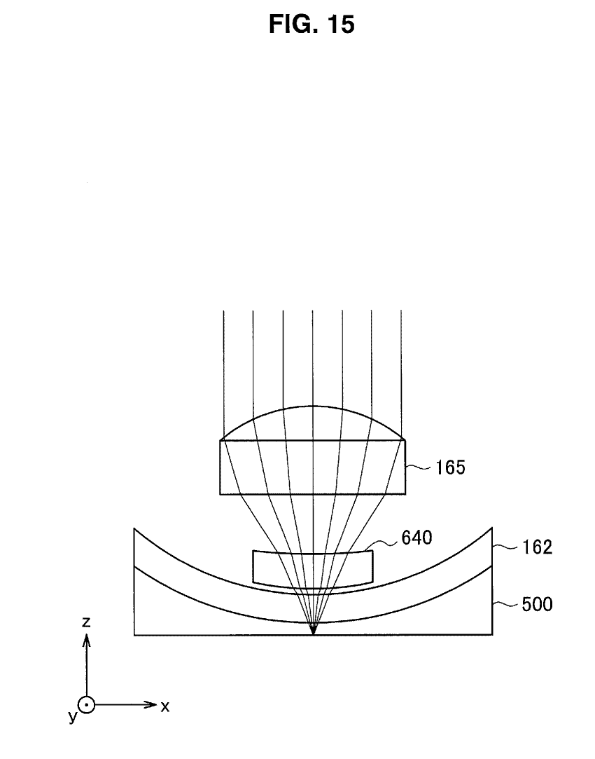

A cylindrical plane-convex lens which is one configuration example of the aberration correction element correcting astigmatism and spherical aberration on the x-z plane will be described with reference to FIG. 15. FIG. 15 is a schematic diagram illustrating the configuration of the cylindrical plane-convex lens which is one configuration example of the aberration correction element 166 according to the present embodiment. Also, FIG. 15 illustrates a state when the scanning unit 163 of the endoscope 160 and the vicinity of the scanning unit 163 illustrated in FIG. 2 is viewed in the positive direction of the y axis. Also, in FIG. 15, for the sake of simplicity, only straight lines necessary for the description are mainly illustrated as straight lines indicating a pencil of laser light.

Referring to FIG. 15, in the present configuration example, a cylindrical plane-convex lens 640 is disposed between the objective lens 165 and the window unit 162. The cylindrical plane-convex lens 640 is an aberration correction element that corresponds to the aberration correction element 166 illustrated in FIGS. 2 and 3 and has a function of correcting astigmatism and spherical aberration on the x-z plane.

The cylindrical plane-convex lens 640 is a lens that has a cylindrical surface as one surface and the other surface facing the one surface as a plane surface. As illustrated in FIG. 15, the cylindrical plane-convex lens 640 is disposed such that the plane surface faces the objective lens 165 and the cylindrical surface faces the window unit 162. Also, the cylindrical plane-convex lens 640 is disposed such that the axis direction of a cylinder of the cylindrical surface is the y axis direction, that is, the same as the axis direction of the cylinder of the cylindrical surface of the window unit 162. Also, as illustrated in FIG. 15, the cylindrical plane-convex lens 640 is disposed to be proximate to the window unit 162.

Referring to FIG. 15, the pencil of the laser light is indicated by straight lines. Also, the drawing illustrates a state in which the optical path of the laser light collimated to substantially parallel light and guided in the y axis direction is changed in the z axis direction by an optical path changing element (not illustrated) and the laser light sequentially passes through the objective lens 165, the cylindrical plane-convex lens 640, and the window unit 162 and is applied to the biological tissue 500. Thus, in the present configuration example, by disposing the cylindrical plane-convex lens 640 at a position located between the objective lens 165 and the window unit 162 and more proximate to the window unit 162, it is possible to correct the astigmatism and spherical aberration on the x-z plane. Also, the cylindrical plane-convex lens 640 is rotated and/or moved translationally together with the scanning unit by a rotation mechanism (not illustrated) and/or a translational movement mechanism (not illustrated).

Here, the optical characteristics (for example, a material, a thickness, and curvature of the cylindrical surface) or the specific configuration of the cylindrical plane-convex lens 640 may be appropriately set according to the wavelength band of the incident laser light, the optical characteristics of the objective lens 165, the optical characteristics of the window unit 162, and the like. For example, the value of the thickness of the cylindrical plane-convex lens 640 in the z axis direction, the curvature of the cylindrical surface, a proximate distance to the window unit 162, and the like may be adjusted such that the astigmatism and spherical aberration on the x-z plane is minimized.

The specific configuration examples of the aberration correction element 166 illustrated in FIGS. 2 and 3 have been described above with reference to FIGS. 13A to 15. Here, the specific configuration examples of the aberration correction element 166 have been described above as examples of the configuration according to the first embodiment illustrated in FIGS. 2 and 3, but configurations to which the above-described aberration correction elements are applied are not limited to the examples. The cylindrical concave-convex lens pair 620, the cylindrical meniscus lens 630, and the cylindrical plane-convex lens 640 which are the above-described aberration correction elements can be applied as aberration correction elements in the configurations according to the second embodiment described in the foregoing (3. Second embodiment) or each modification example described in the foregoing (4. Modification examples). Also, the aberration correction elements according to the present embodiment are not limited to the above-described configurations, but may have any configuration of known optical members such as various lenses and refractive index matching media. Also, in the foregoing description, the specific configurations of the aberration correction elements correcting spherical aberration and astigmatism among aberrations have been described, but the aberration correction elements according to the present embodiment are not limited to the examples. The aberration correction elements according to the present embodiment may have configurations for correcting other kinds of aberrations or a plurality of configurations for correcting mutually different kinds of aberrations may be combined. Also, when the configurations of the aberration correction elements according to the present embodiment are designed, the configurations are preferably designed in consideration of a change in aberration caused in shift of an objective lens in the z axis direction, high-order aberration (for example, high-order astigmatism of four-fold symmetry), or the like in addition to the above-described optical characteristics.

### 6. CONFIGURATION INCLUDING DEPTH-OF-OBSERVATION ADJUSTING MECHANISM

The laser scanning observation device according to the exemplary embodiment may be provided with a depth-of-observation adjusting mechanism to change the depth of observation. The laser scanning observation device according to the exemplary embodiment including the depth-of-observation adjusting mechanism makes it possible to perform scan an observation target with laser in the depth direction, thereby achieving a useful observation capable of meeting the user's requirements.

An example of the depth-of-observation adjusting mechanism includes a mechanism for moving a collimator lens, to the optical axis, for collimating the light emitted from an optical fiber into a substantially parallel beam of light and guiding it to a scanning unit (corresponding to the optical fiber light-guiding lens 150 shown in FIG. 2), a mechanism for moving an objective lens to an optical axis, a focal distance adjusting mechanism using a variable focal length lens as an objective lens, and a mechanism for moving the position of the end portion of an optical fiber in a casing to an optical axis. The depth of observation may be changed by providing a plurality of areas having different thickness in a window unit that is in contact with an observation target and by changing areas to be in contact with the observation target.

On the other hand, the change in observation depth changes the convergence and divergence states of laser light on an objective lens or window unit, and thus the degree of astigmatism occurring when laser light is collected on an observation target varies accordingly. Thus, in the exemplary embodiment, when the laser scanning observation device includes a depth-of-observation adjusting mechanism, it is preferable to provide an astigmatism correction element that corrects the astigmatism by the amount of correction corresponding to variation in astigmatism caused by a change in the depth of observation.

A laser canning method using the depth-of-observation adjusting mechanism and the configuration of a laser scanning observation device provided with an astigmatism correction element for dealing with change in the depth of observation will be described in detail. As is the case with the first embodiment described above, the configuration of the laser scanning observation device in a case where the laser light is applied to a single spot of an observation target will be described below. However, each configuration described below is not limited to such example. As is the case with the second embodiment, for example, the use of an optical fiber bundle or a multi-core optical fiber allows a plurality of spots of an observation target to be irradiated with laser light. Each type of configuration described below may be used in combination with the configuration illustrated in the modification examples described in the above item 4 (Modification examples) in a possible range.

(6-1. Laser Scanning Using Depth-of-Observation Adjusting Mechanism)

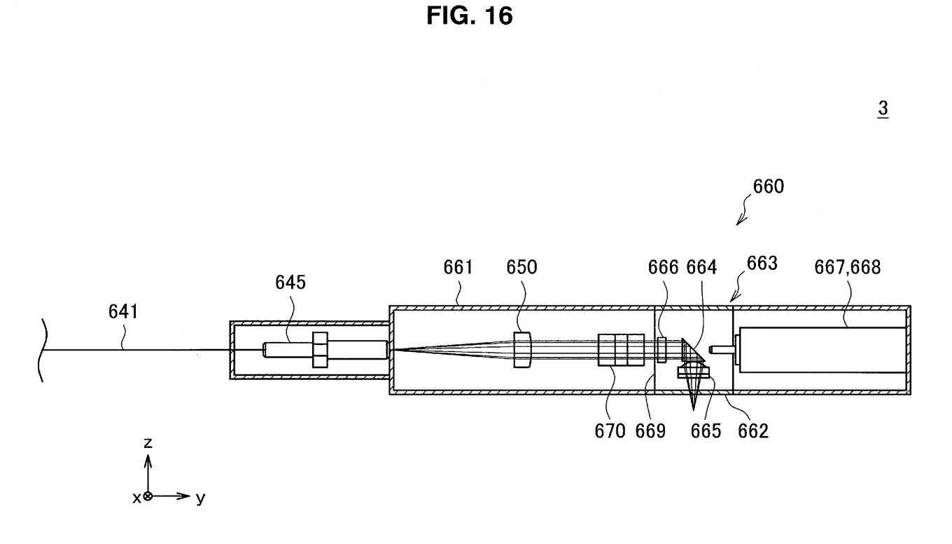

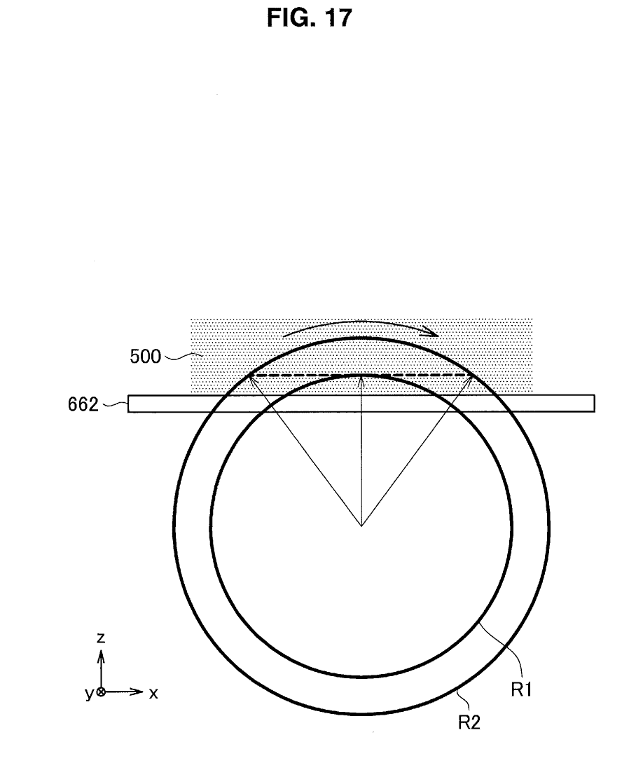

A laser scanning method that uses a depth-of-observation adjusting mechanism in the laser scanning endoscopic device according to an exemplary embodiment will be described with reference to FIGS. 16 and 17. FIG. 16 is a diagram illustrated to describe a depth-of-observation adjusting mechanism in the laser scanning endoscopic device according to an exemplary embodiment. FIG. 17 is a diagram illustrating an example of a laser scanning method that uses the depth-of-observation adjusting mechanism in the laser scanning endoscopic device according to an exemplary embodiment.

The laser scanning endoscopic device shown in FIG. 16 corresponds to the laser scanning endoscopic device 1 shown in FIG. 2, and has substantially similar configuration to the laser scanning endoscopic device 1 described above. Thus, in the following description with reference to FIGS. 16 and 17, a detailed description of the configuration that is the same as the laser scanning endoscopic device 1 will be omitted, and a description will be given mainly of a depth-of-observation adjusting mechanism. FIG. 16 mainly illustrates a portion corresponding to an endoscope of the configurations of the laser scanning endoscopic device according to an exemplary embodiment.

Referring to FIG. 16, an endoscope 660 of a laser scanning endoscopic device 3 according to an exemplary embodiment is configured to include a collimator lens 650, a chromatic aberration correction element 670, a scanning unit 663, a rotation mechanism 667, and a translational movement mechanism 668, which are accommodated within a tube 661. In the example shown in FIG. 16, the rotation mechanism 667 and the translational movement mechanism 668 are illustrated as an integral member, but they may be arranged within the tube 661 as separate members.

The tube 661 is connected to an optical fiber 641 at one end thereof via a fiber connector 645. The laser light emitted from a laser light source (not shown) is guided into the tube 661 through the optical fiber 641. The light guided into the tube 661 through the optical fiber 641 travels in the longitudinal direction (y-axis direction) within the tube 661, passes through the collimator lens 650 and the chromatic aberration correction element 670, and then is incident on the scanning unit 663.

The scanning unit 663 is configured to include an astigmatism correction element 666, an optical path changing element 664, and an objective lens 665, which are accommodated within a housing 669. The scanning unit 663 is configured to be rotatable integrally about the y-axis direction serving as the direction of rotation axis by the rotation mechanism 667 provided in the other end of the tube 661. The light incident on the scanning unit 663 passes through the astigmatism correction element 666. Then, the direction of travel of the light is changed in a direction substantially perpendicular thereto (radial direction of the tube 661, that is, z-axis direction) by the optical path changing element 664 and passes through the objective lens 665, and then is guided to the outside of the housing 669. In a portion of the side wall of the tube 661, a window unit 662 is provided at an area facing the objective lens 665. The window unit 662 is formed of a material that transmits a beam of light of a wavelength band corresponding to at least laser light and its returning light. The light collected by the objective lens 665 is applied to the outside of the tube 661 through the window unit 662. The window unit 662 is configured to be in contact with an observation target (e.g., biological tissue), and thus the observation target is irradiated with laser light.

The rotation of the scanning unit 663 in the y-axis direction as a rotation axis by the rotation mechanism 667 allows an observation target to be scanned with laser light in the x-axis direction. The translational movement of the scanning unit 663 in the y-axis direction by the translational movement mechanism 668 allows an observation target to be scanned with laser light in the y-axis direction. Although not shown in FIG. 16, the laser scanning endoscopic device 3 is configured to include components corresponding to the laser light source 110, the beam splitter 120, the optical fiber light-guiding lens 130, the optical detector 170, the control unit 180, the output unit 190, and the input unit 195, which are shown in FIG. 2. The laser scanning endoscopic device 3 can acquire an image of an observation target based on the returning light occurring by the laser scanning. The optical fiber 641, the tube 661, the window unit 662, the housing 669, the optical path changing element 664, the objective lens 665, the rotation mechanism 667 and the translational movement mechanism 668 shown in FIG. 16 may have similar function to those shown in FIG. 2, and thus detailed description thereof will be omitted.

The astigmatism correction element 666 corrects astigmatism caused when laser light is collected on an observation target. The astigmatism correction element 666 is designed to provide the amount of correction corresponding to variation in astigmatism caused by a change in the depth of observation. The chromatic aberration correction element 670 corrects chromatic aberration caused by the difference in wavelengths between laser light and fluorescent light, for example, when the fluorescent light is emitted from an observation target as returning light. The chromatic aberration correction element 670 allows light collection efficiency of fluorescent light on the end surface of the optical fiber 641 to be improved. The detailed configuration of the astigmatism correction element 666 and the chromatic aberration correction element 670 will be described later in detail in item 6-2 (Laser scanning probe).

The astigmatism correction element 666 and the chromatic aberration correction element 670 correspond to the aberration correction element 166 shown in FIG. 2. In FIG. 2, only one aberration correction element 166 is illustratively shown, but in an exemplary embodiment, a plurality of aberration correction elements may be provided to correct different types of aberration. In the example shown in FIG. 2, the aberration correction element 166 is disposed between the optical path changing element 164 and the objective lens 165. However, as shown in FIG. 16, even when the astigmatism correction element 666 and the chromatic aberration correction element 670 are provided in a front stage of the optical path changing element 664, it is possible to achieve aberration correction effect optically similar to the example shown in FIG. 2. The astigmatism correction element 666 is necessary not to change its relative positional relationship with the optical path changing element 164 for the purpose of correction of astigmatism, and thus the astigmatism correction element 666 may be arranged to perform rotation and/or translational movement together with the optical path changing element 164. On the other hand, the chromatic aberration correction element 670 may be arranged between the collimator lens 650 and the objective lens 665 so that the fluorescent light in which chromatic aberration that is especially likely to occur in the objective lens 165 is corrected is guided to the optical fiber 641.

The collimator lens 650 corresponds to the optical fiber light-guiding lens 150 shown in FIG. 2. The collimator lens 650 makes the light emitted from the optical fiber 641 into a substantially parallel beam of light and guides it to a member in a stage following the collimator lens 650. The movement of the collimator lens 650 in the optical axis (y-axis direction) makes it possible to change the convergence and divergence states of laser light on the objective lens 665, thereby changing the depth of observation.

The laser scanning endoscopic device 3 may be further provided with a movement mechanism (not shown) for moving the collimator lens 650 in the y-axis direction. The depth-of-observation adjusting mechanism may be configured to include the collimator lens 650 and the movement mechanism. The change in the depth of observation by the depth-of-observation adjusting mechanism makes it possible to scan an observation target with laser light in the direction of depth (z-axis direction) of the observation target. Thus, the control of the movement of the collimator lens 650 in synchronization with the rotation and translational movement of the scanning unit 633 allows three-dimensional laser scanning of an observation target. The detailed configuration the moving mechanism for moving the collimator lens 650 may be similar to that of the translational movement mechanism 668. For example, the movement mechanism may be configured to include a linear actuator or a piezoelectric element.

When the depth-of-observation adjusting mechanism is provided, the rotation of the scanning unit 663 (i.e. laser scanning in the x-axis direction) is controlled in cooperation with the change in the depth of observation (i.e. laser scanning in the z-axis direction), and thus it is possible to perform observation with higher accuracy. Referring to FIG. 17, a laser scanning method of controlling the rotation of the scanning unit 663 in cooperation with the change in the depth of observation will be described.

FIG. 17 illustrates how the window unit 662 is in contact with the biological tissue 500 to be observed when the endoscope 660 is viewed from the y-axis direction. In FIG. 17, the illustration of the tube 661, the scanning unit 663, or the like is omitted, and trajectories R1 and R2 of the laser light scanning (scan trajectory) associated with the rotation of the scanning unit 663 are schematically represented by a circle. As shown in FIG. 17, the trajectories R1 and R2 in the different depths of observation may be represented by two circles having different radii.

In the laser scanning endoscopic device 3, the laser scanning in the x-axis direction is performed by the rotation of the scanning unit 663. Thus, the scanning of the biological tissue 500 with laser light in the x-axis direction actually may be laser scanning along a circular arc shown in FIG. 17, not linear scanning along the x-axis direction. In this state, when the scanning unit 663 is moved translationally and the laser scanning is performed in the y-axis direction, a cross-sectional image along the circular arc may be obtained. However, depending on an observation target or the purpose of observation, it is conceivable that a case may arise in which a cross section substantially parallel to the x-axis direction is necessary to be observed.

For such a necessity, in the exemplary embodiment, the dynamical change of the depth of observation during one rotation of the scanning unit 663 using the depth-of-observation adjusting mechanism can implement the linear laser-light scanning along the x-axis direction. Specifically, as shown in FIG. 17, in synchronization with the rotation of the scanning unit 663, the scan trajectory may be changed continuously from the scan trajectory R1 to the scan trajectory R2 and from the scan trajectory R2 to the scan trajectory R1. Thus, the driving of the depth-of-observation adjusting mechanism is controlled so that the depth of observation in the biological tissue 500 is substantially parallel to the x-axis. Such control makes it possible to perform laser scanning in the x-axis direction at a substantially constant depth of observation. Such control is combined with the laser scanning in the y-axis direction by the translational movement of the scanning unit 663, and thus it is possible to observe a planar cross section of the biological tissue 500.

The laser scanning method using the depth-of-observation adjusting mechanism in the laser scanning endoscopic device 3 according to an exemplary embodiment has been described with reference to FIGS. 16 and 17. In an exemplary embodiment, the rotation of the scanning unit 663 is controlled in cooperation with the change in the depth of observation using the depth-of-observation adjusting mechanism, and thus it is possible to perform a linear laser scanning at a substantially constant depth of observation. This makes it possible to observe a planar cross section of an observation target depending on the user's request, thereby further improving the convenience of the user. The laser scanning endoscopic device 3 includes the astigmatism correction element 666 that corrects astigmatism by the amount of correction corresponding to variation in astigmatism caused by a change in the depth of observation. Thus, even when the depth of observation is changed, it is possible to perform observation with high accuracy.

(6-2. Laser Scanning Probe)

The laser scanning observation device 3 described above is provided with the scanning unit 663 within the tube 661 of the endoscope 660. The scanning unit 663 is rotatable using the longitudinal direction of the tube 661 as the rotation axis direction. The laser scanning observation device 3 allows an observation target to be irradiated with laser light through the window unit 662 provided on the side wall of the tube 661. However, in an exemplary embodiment, more generally, the laser scanning probe may be configured so that the scanning unit 663 or other optical components are arranged within a cylindrical casing and the window unit is provided in at least a partial area of the side wall of the casing. A portion corresponding to the endoscope 660 of the above-mentioned laser scanning endoscopic device 3 is an application example of the laser scanning probe. The laser scanning probe may be intended to be directly inserted in the body cavity of the subject, or is accommodated in the distal end of the tube of the existing endoscope and then inserted in the body cavity of the subject. When the laser scanning probe is used to the laser scanning endoscopic device as described above, for example the cylindrical casing is necessary to have a diameter of approximately 10 mm or less. However, in an exemplary embodiment, the laser scanning probe may be configured to increase its size (e.g., a diameter of greater than approximately 10 mm) and to be in contact with the body surface of a human or animal to be observed. Thus, this laser scanning probe may be used to observe biological tissue at a predetermined depth from the body surface.

The exemplary configuration of the laser scanning probe according to an exemplary embodiment has been described above. As an example of the laser scanning probe according to an exemplary embodiment, the configuration of the laser scanning probe in which observation using two-photon excitation is suitably performed will be described below. The use of two-photon excitation makes it possible to obtain information relating to the surface and direction of depth of an observation target. The detection of fluorescent light emitted by irradiation using excitation light (laser light) allows information relating to an observation target to be obtained. Thus, it is possible to obtain detailed molecular-level information on an observation target, which may not be obtained from other optical imaging techniques that visualize the scattering and absorption of light, such as OCT, optoacoustic imaging, and confocal reflection. The use of near infrared light as excitation light makes it possible to reduce damage, for example, to a human to be observed.

(6-2-1. Configuration of Laser Scanning Probe)

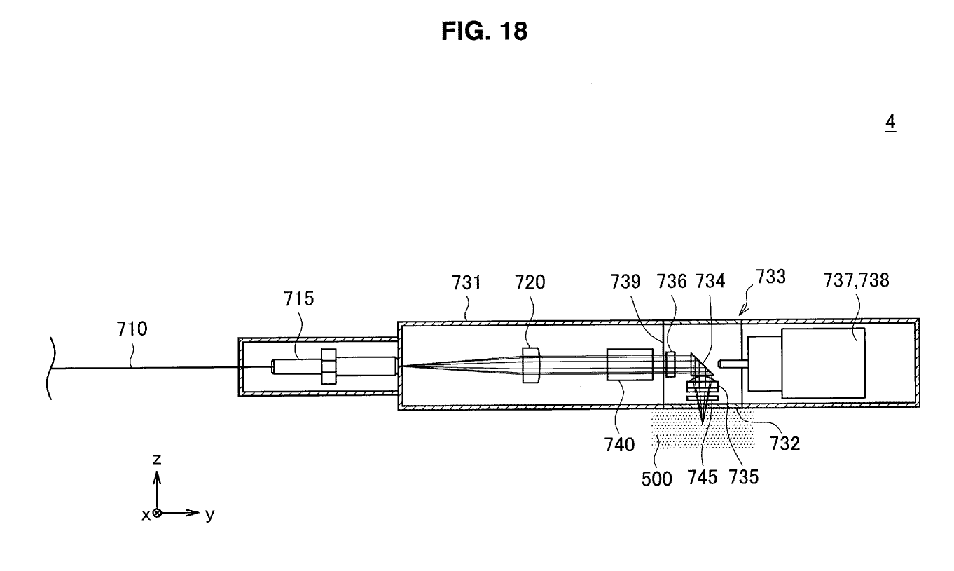

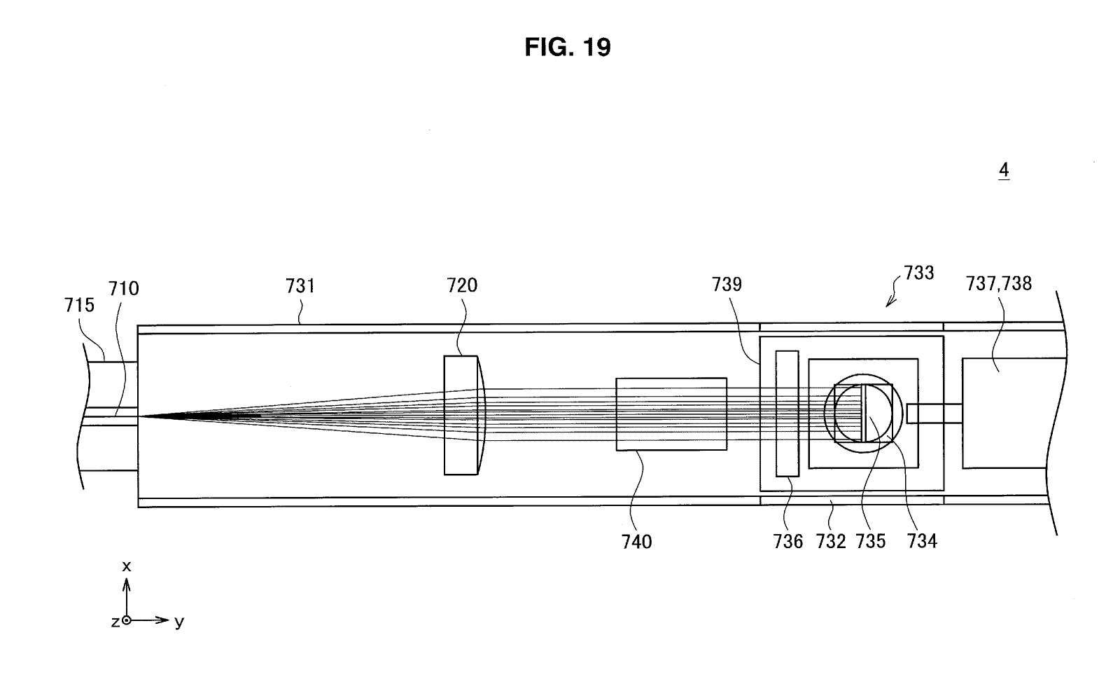

A configuration of the laser scanning probe according to an exemplary embodiment will be described with reference to FIGS. 18 to 22. FIG. 18 is a side view illustrating an exemplary configuration of the laser scanning probe according to an exemplary embodiment. FIG. 18 illustrates components arranged within the casing, as viewed through the casing surrounding the laser scanning probe. FIGS. 19 to 21 illustrate arrangement of optical components in the laser scanning probe shown in FIG. 18.

Referring to FIG. 18, a laser scanning probe 4 according to an exemplary embodiment is configured to include a collimator lens 720, a chromatic aberration correction element 740, a scanning unit 733, a rotation mechanism 737, and a translational movement mechanism 738, which are arranged within a cylindrical casing 731. When the casing 731 is regarded as a tube of an endoscope, the laser scanning probe 4 shown in FIG. 18 has a configuration substantially similar to that of the endoscope 660 shown in FIG. 16. Thus, in the description below with reference to FIG. 18, detailed description of the configuration that is the same as the above-mentioned laser scanning endoscopic device 3 will be omitted.

The casing 731 is connected to an optical fiber 710 at one end thereof via a fiber connector 765. The laser light emitted from a laser light source (not shown) is guided into the casing 731 through the optical fiber 710. The light guided into the casing 731 through the optical fiber 710 travels in the longitudinal direction (y-axis direction) within the casing 731, passes through the collimator lens 720 and the chromatic aberration correction element 740, and then is incident on the scanning unit 733.

The scanning unit 733 is configured to include an astigmatism correction element 736, an optical path changing element 734, and an objective lens 735, which are accommodated within a housing 739. The scanning unit 733 is configured to be rotatable integrally about the y-axis direction serving as the direction of rotation axis by the rotation mechanism 737 provided in the other end of the casing 731. The light incident on the scanning unit 733 passes through the astigmatism correction element 736. Then, the direction of travel of light is changed in a direction substantially perpendicular thereto (radial direction of the casing 731, that is, z-axis direction) by the optical path changing element 734 and the light passes through the objective lens 735 and a spherical aberration correction element 745, and then is guided to the outside of the housing 739. In a portion of the side wall of the casing 731, a window unit 732 is provided at an area facing the objective lens 735. The window unit 732 is formed of a material that transmits a beam of light of a wavelength band corresponding to at least laser light and its returning light. The light collected by the objective lens 735 is applied to the outside of the casing 731 through the window unit 732. The window unit 732 is configured to be in contact with an observation target (e.g., the biological tissue 500), and thus the observation target is irradiated with laser light.

The rotation of the scanning unit 733 in the y-axis direction as a rotation axis by the rotation mechanism 737 allows an observation target to be scanned with laser light in the x-axis direction. The translational movement of the scanning unit 733 in the y-axis direction by the translational movement mechanism 738 allows an observation target to be scanned with laser light in the y-axis direction. Although not shown in FIG. 18, the laser scanning endoscopic device 4 is configured to include components corresponding to the laser light source 110, the beam splitter 120, the optical fiber light-guiding lens 130, the optical detector 170, the control unit 180, the output unit 190, and the input unit 195, which are shown in FIG. 2. The laser scanning endoscopic device 4 can acquire an image of the observation target 500 based on the returning light occurring by the laser scanning. In the example shown in FIG. 18, the rotation mechanism 737 and the translational movement mechanism 738 are illustrated as an integral member, but they may be arranged within the casing 731 as separate members. The optical fiber 710, the window unit 732, the housing 739, the optical path changing element 734, the objective lens 735, the rotation mechanism 737 and the translational movement mechanism 738 shown in FIG. 18 may have similar function to those shown in FIG. 2, and thus detailed description thereof will be omitted.

The collimator lens 720 corresponds to the collimator lens 650 shown in FIG. 16. As is the case with the laser scanning endoscopic device 3 described above in the item 6-1 (Laser scanning using depth-of-observation adjusting mechanism), the laser scanning probe 4 may be provided with an additional movement mechanism for moving the collimator lens 720 in the y-axis direction (not shown). This movement mechanism allows the collimator lens 720 to be moved in the y-axis direction, thereby changing the depth of observation.

The astigmatism correction element 736 and the chromatic aberration correction element 740 correspond to the astigmatism correction element 666 and the chromatic aberration correction element 670, respectively, shown in FIG. 16. The astigmatism correction element 736 is designed to deal with variation in astigmatism caused by a change in the depth of observation. The chromatic aberration correction element 740 corrects chromatic aberration caused by the difference in wavelengths between laser light and fluorescent light, for example, when observation is performed using two-photon excitation, and thus the light collection efficiency of fluorescent light on the optical fiber 710 is improved.

The spherical aberration correction element 745 is provided to correct spherical aberration that may occur by the objective lens 735. In the example shown in FIG. 18, the spherical aberration correction element 745 is a parallel flat plate, but the detailed configuration of the spherical aberration correction element 745 is not limited thereto. The spherical aberration correction element 745 has a parameter by which optical properties can be determined, such as a shape and material. This parameter of the spherical aberration correction element 745 may be preferably designed to correct the spherical aberration depending on the optical property of the objective lens 735. When the objective lens 735 is an aspheric lens, the objective lens 735 may have a function of correcting its own spherical aberration, and in this case, the spherical aberration correction element 745 may not be provided.

A double-clad optical fiber is suitably employed as the optical fiber 710 to deal with the observation using two-photon excitation. When the optical fiber 710 is a double clad optical fiber, for example, a core guides laser light (i.e. excitation light) into the casing 731 and the fluorescent light that is returning light from the biological tissue 500 may be guided from an internal clad to the outside of the casing 731. Thus, the light collection efficiency of fluorescent light on the optical fiber 710 can be improved.

The window unit 732 may be formed only in a predetermined length of an area of the casing 731 in the y-axis direction, or the whole of the casing 731 may be formed by similar material to the window unit 732. For example, the casing 731 may be a glass tube that is formed by materials transparent with respect to the light having wavelength band corresponding to at least laser light and fluorescent light.

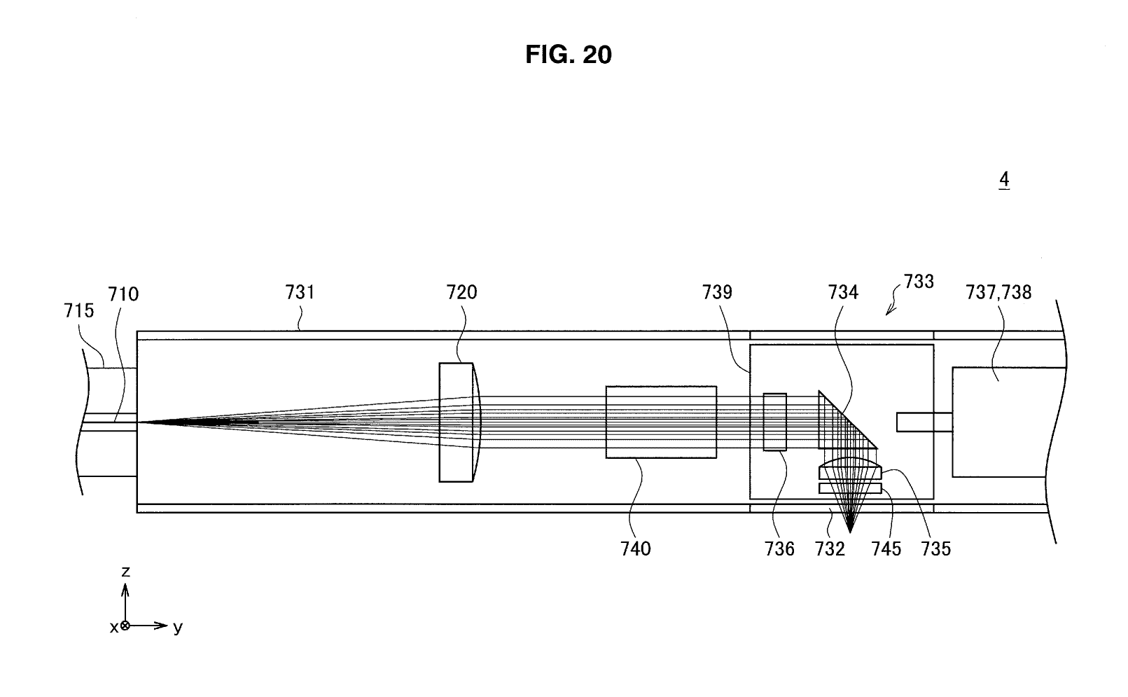

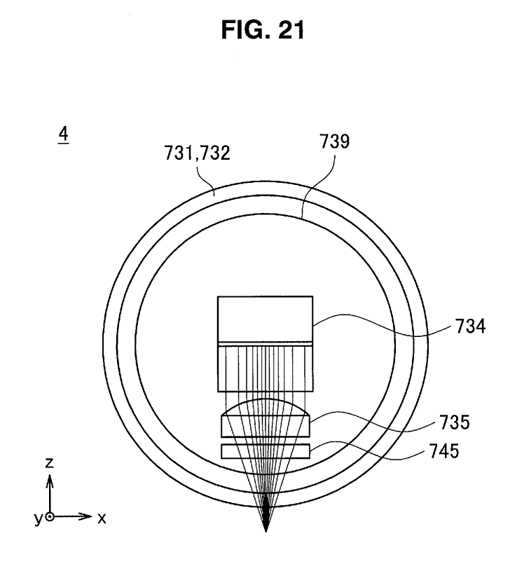

The arrangement of optical components in the laser scanning probe 4 will be described with reference to FIGS. 19 to 21. FIG. 19 illustrates components within the casing 631 shown in FIG. 18, as observed from the z-axis direction (upward). FIG. 20 illustrates components within the casing 631 shown in FIG. 18, as observed from the x-axis direction (lateral). FIG. 21 illustrates a cross-sectional view of the x-z plane including an optical axis of the objective lens 735 among the components shown in FIG. 18. FIGS. 19 to 21 illustrate the casing 731, the housing 739 of the scanning unit 733, or the like with a portion thereof viewed as being transparent to show arrangement of each optical member. FIGS. 19 to 21 also illustrate a straight line indicating light to shown an example of an optical path of light passing through each optical member.

Referring to FIGS. 19 to 21, the light emitted from the optical fiber 710 passes through the collimator lens 720, the chromatic aberration correction element 740, and the astigmatism correction element 736. Then, the direction of travel of the light is changed by the optical path changing element 734, and the light passes through the objective lens 735 and the window unit 732, then finally, the light is applied to the outside. The astigmatism correction element 736, the optical path changing element 734, and the objective lens 735 are accommodated within the housing 739, and they rotate together in the y-axis direction as the rotation axis direction by the rotation mechanism 737.

As the astigmatism correction element 736, for example, a cylindrical meniscus lens that has a convex lens formed on one surface thereof and a concave lens formed on the other surface (e.g., corresponding to the cylindrical meniscus lens 630 described above with reference to FIG. 14) is used. As the astigmatism correction element 736, for example, a configuration in which two cylindrical lenses are combined may be used, such as the cylindrical concave-convex lens pair 620 described above with reference to FIGS. 13A and 13B. On the other hand, as the chromatic aberration correction element 740, for example, a cemented lens composed by two concave lenses joined in a state where each lens surface faces each other. In FIGS. 19 to 21, a detailed shape of the chromatic aberration correction element 740 and the astigmatism correction element 736 is not illuminated for simplicity, and it is illustrated schematically. In an exemplary embodiment, the optical system may be optically designed so that the astigmatism correction element 736 and the chromatic aberration correction element 740 have predetermined properties depending on optical properties other optical members (e.g., the collimator lens 720, the optical path changing element 734, the objective lens 735, the spherical aberration correction element 745 745 and/or the window unit 732), thereby obtaining an observed image with high quality. The astigmatism correction element 736 and the chromatic aberration correction element 740 will be described in detail in items 6-2-2 (Astigmatism correction element) and 6-2-3 (Chromatic aberration correction element) described below.

(6-2-2. Astigmatism Correction Element)

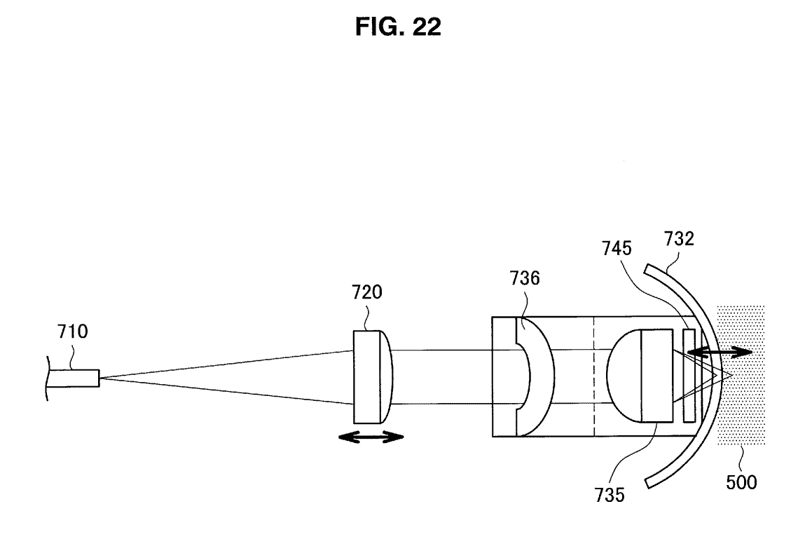

Parameters that affect astigmatism in the optical system of the laser scanning probe 4 will be described with reference to FIG. 22. FIG. 22 is a diagram illustrated to describe parameters that affect astigmatism in the optical system of the laser scanning probe 4. FIG. 22 illustrates only the optical fiber 710, the collimator lens 720, the astigmatism correction element 736, the objective lens 735, and the window unit 732, among the components in the laser scanning probe 4 shown in FIGS. 18 to 21, for the sake of description. In practice, as shown in FIGS. 18 to 21, the light in which its direction of travel is changed by the optical path changing element 734 is incident on the objective lens 735. However, in FIG. 22, the optical path changing element is not illustrated, and a change in the direction of travel of laser light is represented by a dashed line.

As described in the above item 5-1 (Correction of astigmatism), the present inventors have found that the degree of astigmatism varies depending on the optical distance in the direction of depth of observation (the product of a refractive index of a medium and a distance of observation depth direction) from the result of examination. In other words, it can be said that the astigmatism caused by a passage of the collected light by the objective lens 735 through the window unit 732 depends on the thickness of the window unit 732, the distance between the objective lens 735 and the window unit 732, and the depth of observation. As shown in FIG. 22, the laser scanning probe 4 according to an exemplary embodiment allows the position in the optical axis of the collimator lens 720 to be changed, thereby changing the depth of observation. Thus, the astigmatism correction element 736 is necessary to have optical properties to implement the amount of correction corresponding to variation in the degree of astigmatism caused by a change in the depth of observation.

To implement such optical properties in the astigmatism correction element 736, the astigmatism correction element 736 may be designed to have a shape and material so that the dependency of astigmatism on depth of observation in the window unit 732 is obtained and it has reverse astigmatism properties for precisely offsetting the astigmatism in the window unit 732 for each depth of observation. Such astigmatism correction element 736, which is capable of offsetting the astigmatism in the window unit 732 even in a case where the depth of observation is changed, may be implemented, for example, by a lens configured so that laser light passes through at least a two-sided cylindrical surface or toroidal surface. For example, as the astigmatism correction element 736, a cylindrical meniscus lens having two concave surfaces (i.e. both surfaces have the same curvature orientation) on which light is incident from the optical fiber 710 as shown in FIG. 22 may be suitably employed.

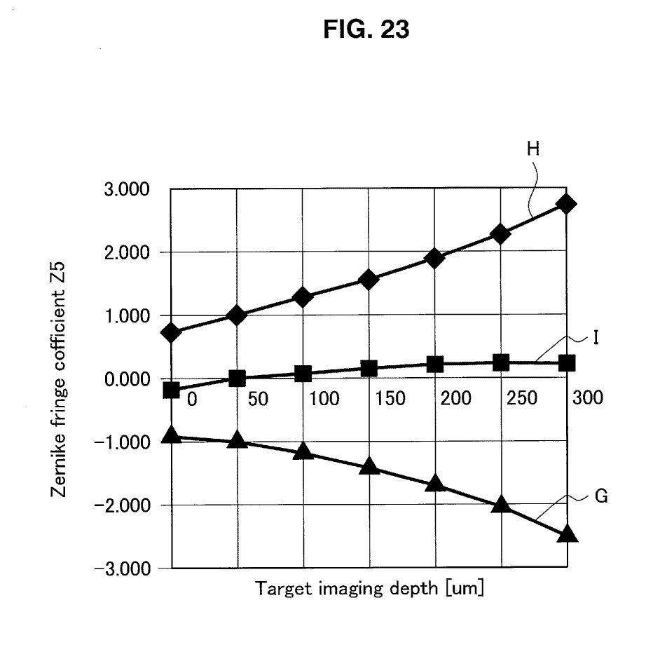

FIG. 23 illustrates an example of optical properties of a cylindrical meniscus lens used as the astigmatism correction element 736 in an exemplary embodiment. FIG. 23 is a graph illustrating an example of optical properties of a cylindrical meniscus lens used as the astigmatism correction element 736 in an exemplary embodiment. In FIG. 23, the horizontal axis represents the depth of observation and the vertical axis represents Fringe Zernike polynomial coefficients as an index indicating the degree of astigmatism, and the relationship between them is plotted.

In FIG. 23, the curve G represents the dependency of astigmatism on depth of observation in the window unit 732. The curve H represents the dependency of astigmatism on depth of observation in the cylindrical meniscus lens used as the astigmatism correction element 736. The curve I represents the astigmatism characteristics, which can be implemented in an exemplary embodiment, obtained by summing astigmatism of the window unit 732 and astigmatism of the cylindrical meniscus lens. Comparison between the curve G and the curve H shows that the astigmatism of the cylindrical meniscus lens has substantially opposite characteristics to the dependency of astigmatism on depth of observation in the window unit 732 and the astigmatism is substantially offset by summing both as illustrated in the curve I.

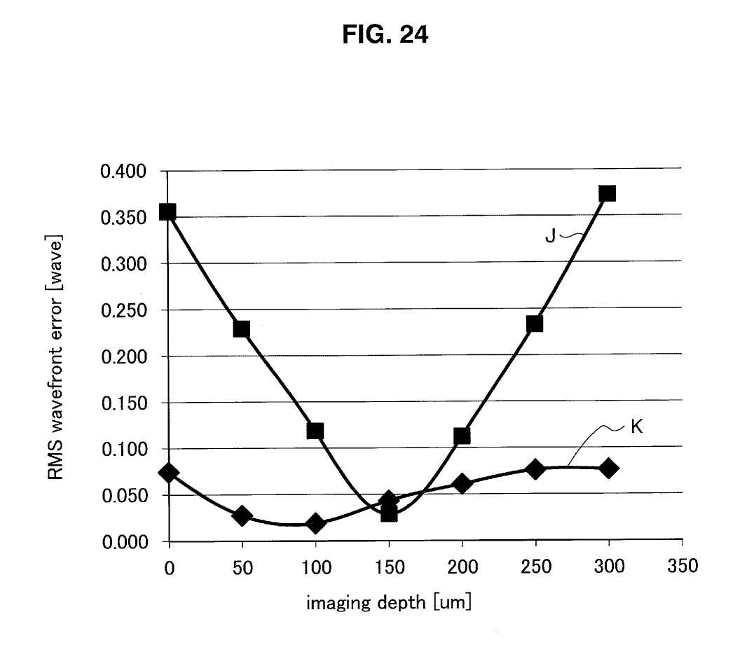

Referring to FIG. 24, comparison is made between a case where astigmatism is corrected by an optical member having two curved surfaces (cylindrical surface or toroidal surface) and a case where astigmatism is corrected by an optical member having one curved surface. An optical member having two curved surfaces corresponds to, for example, the above-mentioned cylindrical meniscus lens. An optical member having one curved surface corresponds to, for example, an optical member that is commonly used to correct astigmatism, such as a cylindrical plane-convex lens and a minor used as an optical path changing element with a concave cylindrical curved surface on the optical path changing element.

FIG. 24 is a graph illustrating the dependency of astigmatism on depth of observation for an optical member having two curved surfaces and for an optical member having one curved surface. In FIG. 24, the horizontal axis represents the depth of observation and the vertical axis represents RMS wavefront aberration value as an index indicating the degree of wavefront aberration, and the relationship between them is plotted.

In FIG. 24, the curve J represents the dependency of wavefront aberration on depth of observation of an optical member with one curved surface, and the curve K represents the dependency of wavefront aberration on depth of observation of an optical member with two curved surfaces. As shown in FIG. 24, in the optical member having only one curved surface, the variation in the degree of aberration to the depth of observation is large. Thus, when the optical member having only one curved surface is used as the astigmatism correction element 736, although the optical design can be made to correct astigmatism in a specified depth of observation, it is difficult to deal with in the case where the depth of observation is changed. On the other hand, in the optical member having two curved surfaces, the variation in the degree of aberration to the depth of observation is relatively small. Thus, when the optical member having two curved surfaces is used as an aberration correction element, it is possible to correct aberration at a substantially constant rate even when the depth of observation is changed. In this way, the use of a lens having two curved surface, such as the above-mentioned cylindrical meniscus lens, as the astigmatism correction element 736 makes it possible to correct astigmatism corresponding to a change in depth of observation.

A detailed shape (e.g., curvature of both curved surfaces) of the cylindrical meniscus lens used as the astigmatism correction element 736 may be preferably designed depending on various parameters affecting astigmatism caused when laser light is collected on an observation target as described above (e.g., thickness of window unit 732, distance between the objective lens 735 and window unit 732, material of the objective lens 735 and window unit 732, and shape, e.g., curvature of the objective lens 735 and window unit 732).

The configuration of astigmatism correction element 736 according to an exemplary embodiment has been described in detail. As described above, in an exemplary embodiment, an optical member having optical properties that implement the amount of correction corresponding to variation in astigmatism caused by a change in the depth of observation is used as the astigmatism correction element 736. Such optical properties may be implemented by a lens system having a configuration in which laser light passes through at least a two-sided cylindrical surface or toroidal surface. Thus, the astigmatism correction element 736 may be implemented by a single lens such as the above-mentioned cylindrical meniscus lens. Alternatively, the astigmatism correction element 736 may be implemented by a lens system having at least a two-sided cylindrical surface or toroidal surface, such as the cylindrical concave-convex lens pair 620 shown in FIGS. 13A and 13B. The use of such astigmatism correction element 736 makes it possible to perform a high-precision observation with less influence on astigmatism when the observation is made while changing depth of observation, that is, when laser scanning is performed in the direction of depth.

Although the above description has been given of the case where the astigmatism correction element 736 includes a lens configured to allow laser light to pass through at least two-sided cylindrical surface or toroidal surface, an exemplary embodiment is not limited thereto. For example, for an optical member having one curved surface, it is possible to provide a driving mechanism for changing the shape of the curved surface depending on a change in depth of observation, thereby adjusting the amount of correction of astigmatism depending on the depth of observation. Thus, it is possible to implement correction characteristics that are similar to the above-mentioned cylindrical meniscus lens. In this way, the astigmatism correction element 736 may be an optical member including a driving element that dynamically changes the amount of correction of astigmatism depending on a change in depth of observation (hereinafter, also refer to as “active astigmatism correction element”). An example of the active astigmatism correction element may include a liquid crystal element, liquid lens, and deformable mirror.

When an optical member in which its optical properties are not dynamically changed such as the above-mentioned cylindrical meniscus lens as the astigmatism correction element 736, the astigmatism correction element 736 and the optical path changing element 734 are necessary to rotate together during laser scanning. This is because, when the relative positional relationship between the astigmatism correction element 736 and the optical path changing element 734, a desired optical property of astigmatism is less likely to be implemented. On the other hand, when the active astigmatism correction element is used as the astigmatism correction element 736, the astigmatism correction element 736 may not be necessary to rotate together with the optical path changing element 734. This is because the astigmatism correction element 736 can dynamically change the amount of correction of astigmatism, thus the amount of correction of astigmatism can be changed depending on both the change in depth of observation and the rotation of the optical path changing element 734. In this way, the use of the active astigmatism correction element as the astigmatism 736 makes it possible to reduce the number of constituent members used to rotate as the scanning unit 733. Thus, it is possible to reduce the output power and rigidity necessary for the rotation mechanism 733, and thus the design of the rotation mechanism is made easier.

(6-2-3. Chromatic Aberration Correction Element)

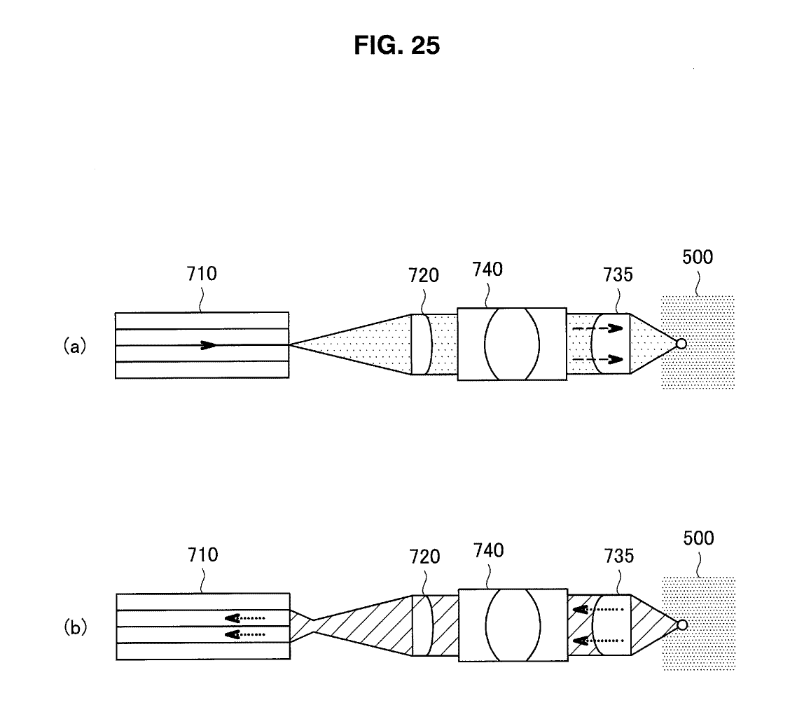

The chromatic aberration correction element 740 employed in the laser scanning probe 4 will be described with reference to FIG. 25. FIG. 25 is diagram illustrated to describe the chromatic aberration correction element 740 that is employed in the laser scanning probe 4. FIG. 25 schematically illustrates only the optical fiber 710, the collimator lens 720, the chromatic aberration correction element 740, and the objective lens 735, among the components of the laser scanning probe 4 shown in FIGS. 18 to 21, for the sake of description.

As described above, in the laser scanning probe 4 according to an exemplary embodiment, the observation using two-photon excitation is suitably performed. In the observation using two-photon excitation, the laser light as excitation light is emitted from the optical fiber 710, passes through the collimator lens 720, the chromatic aberration correction element 740, and the objective lens 735 in this order, and then is applied to the biological tissue 500 (shown by (a) in the figure). The fluorescent light coming from the biological tissue 500 by irradiation with laser light follows a reverse path to the laser light. Specifically, the fluorescent light passes through the objective lens 735, the chromatic aberration correction element 740, and the collimator lens 720 in this order, is guided to the optical fiber 710, and then is detected by an optical detector (not shown) provided outside (shown by (b) in the figure). Thus, to perform an observation more efficiently, the light collection efficiency of fluorescent light on the optical fiber 710 is necessary to be improved.

The laser light applied to the biological tissue 500 often has a wavelength different from that of the fluorescent light that returns from the biological tissue as returning light. For example, when the laser light having a wavelength (785 mm) corresponding to near infrared light is used, the fluorescent light as its returning light may be a beam of light having a visible light band. Thus, chromatic aberration occurs when the fluorescent light that returns from the biological tissue 500 passes through the objective lens 735, and thus the light collection efficiency of fluorescent light on a core of the optical fiber 710 is more likely to be reduced. Thus, in an exemplary embodiment, as shown in FIG. 25, a double clad optical fiber is used as the optical fiber 710 and a core of the optical fiber 710 performs single-mode propagation of laser light, while the fluorescent light propagates through an inner clad and is guided to an optical detector. Such configuration makes it possible to collect the fluorescent light on a portion of the inner clad having a larger area in the end of the optical fiber 710, thereby improving the light collection efficiency.

However, when the degree of chromatic aberration is large, the light collection efficiency of fluorescent light is less likely to be achieved even using the double clad optical fiber. Thus, in an exemplary embodiment, there is provided the chromatic aberration correction element 740 between the collimator lens 720 and the objective lens 735. The provision of the chromatic aberration correction element 740 makes it possible to correct chromatic aberration caused by the passage of fluorescent light through the objective lens 735, thereby improving the light collection efficiency of fluorescent light on the optical fiber 710. As the chromatic aberration correction element 740, for example, it is preferable to use a cemented lens with optical properties, which function as a substantially parallel flat plate for laser light having a wavelength (785 mm) corresponding to near infrared light, but function as a concave lens for light having a wavelength band corresponding to fluorescent light (e.g., visible light band).

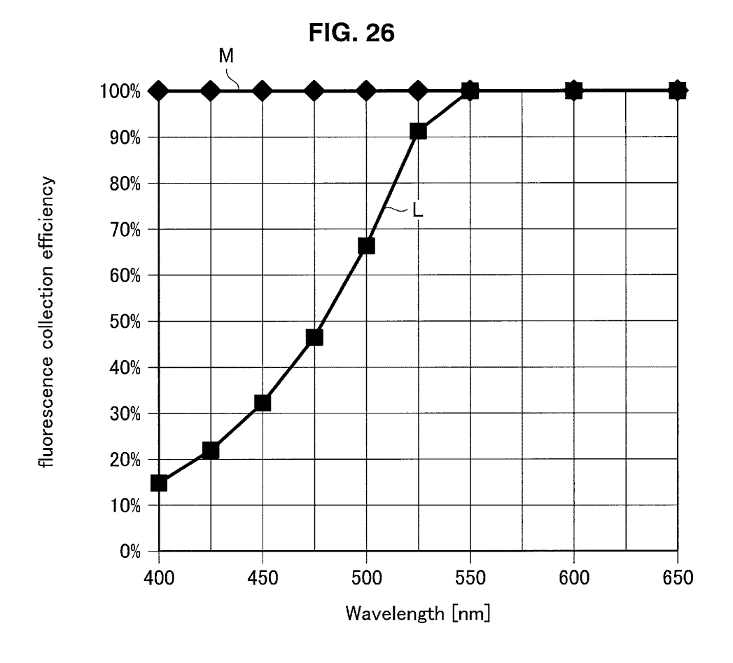

FIG. 26 illustrates the light collection efficiency of fluorescent light on the optical fiber 710 in both cases where the chromatic aberration correction element 740 is employed and not employed. FIG. 26 is a graph illustrating the light collection efficiency of fluorescent light on the optical fiber 710 in both cases where the chromatic aberration correction element 740 employed and not employed. In FIG. 26, the horizontal axis represents wavelength of fluorescent light and the vertical axis represents light collection efficiency of fluorescent light on the optical fiber 710, and the relationship between them is plotted.

In FIG. 26, the curve L represents light collection efficiency of fluorescent light in a case where the chromatic aberration correction element 740 is not employed. The curve M represents light collection efficiency of fluorescent light in a case where the chromatic aberration correction element 740 is employed. Referring to FIG. 26, as shown by the curve L, when the chromatic aberration correction element 740 is not employed, it can be found that the light collection efficiency for fluorescent light with a short wavelength is significantly reduced. This is considered that, as the wavelength of laser light is short, the difference between wavelengths of laser light and fluorescent light is large and the degree of chromatic aberration is large, and thus fluorescent light is difficult to be collected on the end of the optical fiber 710. On the other hand, as shown by the curve M, when the chromatic aberration correction element 740 is employed, high light collection efficiency is achieved regardless of the wavelength of fluorescent light. In this way, in an exemplary embodiment, the arrangement of chromatic aberration correction element 740 makes it possible to improve the light collection efficiency of fluorescent light on the optical fiber 710, thereby performing an observation more efficiently.

The chromatic aberration correction element 740 according to an exemplary embodiment has been described. The detailed configuration including the shape and material of the chromatic aberration correction element 740 may be preferably designed to obtain a suitable light collection efficiency of fluorescent light on the optical fiber 710 by considering optical properties of the objective lens 735, wavelength of laser light used for observation, wavelength of fluorescent light to be observed, or the like.

(6-2-4. Other Exemplary Configuration of Laser Scanning Probe)

Other exemplary configuration of the laser scanning probe according to an exemplary embodiment will be described. As described above, in an exemplary embodiment, a large laser scanning probe may be manufactured, and the window unit is allowed to be in contact with the body surface of a human or animal to be observed with the probe held by the user's hand. Thus, the laser scanning may be performed on biological tissue in a predetermined depth from the body surface.

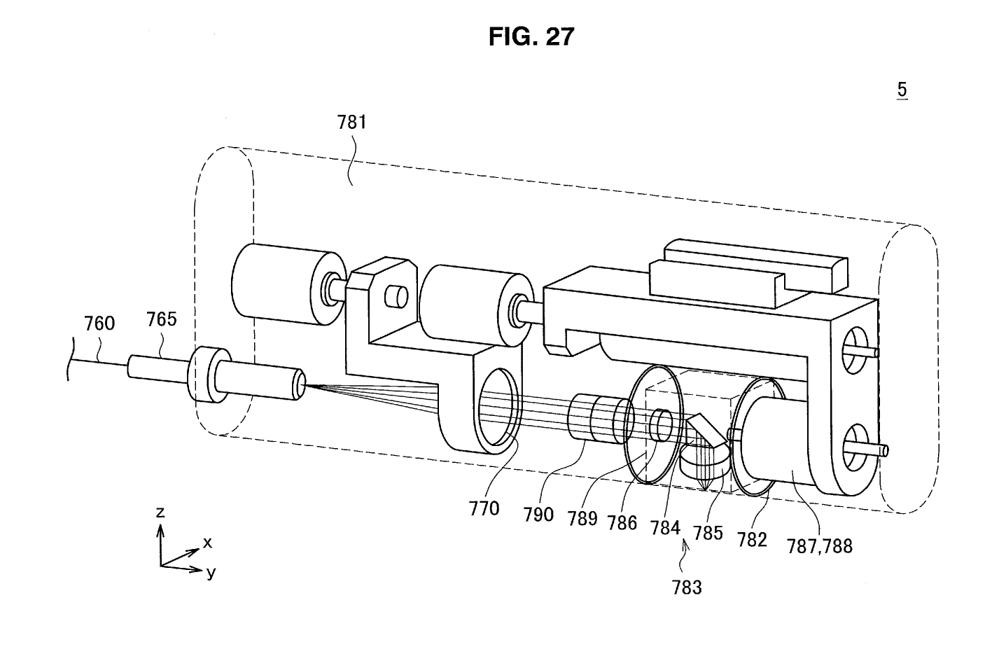

The configuration of a hand-held laser scanning probe as another exemplary configuration of the laser scanning probe according to an exemplary embodiment will be described with reference to FIG. 27. FIG. 27 is a perspective view illustrating the configuration of a hand-held laser scanning probe as another exemplary configuration of the laser scanning probe according to an exemplary embodiment. In FIG. 27, a casing is illustrated as being transparent to show constituent components arranged within the casing.

Referring to FIG. 27, the laser scanning probe 5 according to an exemplary embodiment is configured to include a collimator lens 770, a chromatic aberration correction element 790, and a scanning unit 783, which are accommodated within a substantially rectangular parallelepiped casing 781. In this way, in an exemplary embodiment, the shape of the casing 781 in the laser scanning probe 5 may not be cylindrical. The shape of the casing 781 may be selected as a shape for easy grip by a user, for example, by considering usability of the user. The laser scanning probe 5 shown in FIG. 27 has a substantially similar optical configuration to that of the laser scanning probe 4 shown in FIG. 18, except that the shape of the casing 781 is different from it. Thus, in the description below with reference to FIG. 27, the detailed description that is the same as the above-mentioned laser scanning probe 4 will be omitted.

The casing 781 is connected to an optical fiber 760 at one end thereof via a fiber connector 765. The laser light emitted from a laser light source (not shown) is guided into the casing 781 through the optical fiber 760, passes through the collimator lens 770 and the chromatic aberration correction element 790, and then is incident on the scanning unit 783.

The scanning unit 783 is configured to include an astigmatism correction element 786, an optical path changing element 784, and an objective lens 785, which are accommodated within a housing 789. The scanning unit 783 is configured to be rotatable integrally about the y-axis direction serving as the direction of rotation axis by a rotation mechanism 787 provided in the other end of the casing 781. The light incident on the scanning unit 733 passes through the astigmatism correction element 786. Then, the direction of travel of the light is changed in a direction substantially perpendicular thereto (e.g., surface direction of the casing 731 having curvature, that is, z-axis direction in the figure) by the optical path changing element 784 and the light passes through the objective lens 785, and then is guided to the outside of the housing 789.

The casing 781 includes a cylindrical glass tube 782 that is arranged to surround the scanning unit 783. At least one surface of the casing 781 is formed to have a curvature corresponding to the glass tube 782. An opening is formed in a portion of the area of the surface of the casing 781 having the curvature. The casing 781 and the glass tube 782 are configured so that a portion of the glass tube 782 is exposed through the opening (i.e. the surface of the casing 781 having the curvature is formed by a portion of the glass tube 782). The laser light, which is collected by the objective lens 785 and emitted from the scanning unit 783, passes through an exposed portion of the glass tube 782 (hereinafter, also refer to as “window unit” 782) and then is applied to the outside of the casing 781. When the exposed portion of the glass tube 782 is in contact with an observation target, the observation target is irradiated with the laser light. In this way, the exposed portion of the glass tube 782 corresponds to the window unit 732 of the laser scanning probe 4 shown in FIG. 18.

The rotation of the scanning unit 783 in the y-axis direction as a rotation axis by the rotation mechanism 787 allows an observation target to be scanned with laser light in the x-axis direction. The translational movement of the scanning unit 783 in the y-axis direction by the translational movement mechanism 788 allows an observation target to be scanned with laser light in the y-axis direction. Although not shown in FIG. 27, the laser scanning endoscopic device 5 is configured to include components corresponding to the laser light source 110, the beam splitter 120, the optical fiber light-guiding lens 130, the optical detector 170, the control unit 180, the output unit 190, and the input unit 195, which are shown in FIG. 2. The laser scanning endoscopic device 5 can acquire an image of the observation target based on the returning light occurring by the laser scanning. In the example shown in FIG. 27, the rotation mechanism 787 and the translational movement mechanism 788 are illustrated as an integral member, but they may be arranged within the casing 781 as separate members. The optical properties of optical elements including the collimator lens 770, the optical path changing element 784, the objective lens 785, the astigmatism correction element 786, and the chromatic aberration correction element 790 or the detailed configuration of a driving mechanism for driving the rotation mechanism 787 and the translational movement mechanism 788 as shown in FIG. 27, may have similar function to those shown in FIG. 18. Thus, detailed description thereof will be omitted.

The laser scanning probe 5 may be further provided with a movement mechanism (not shown) for moving the collimator lens 770 in the y-axis direction, which is similar to the laser scanning probe 4 shown in FIG. 18. The movement of the collimator lens 770 in the y-axis direction by the movement mechanism allows the depth of observation to be changed. This makes it possible to perform laser scanning in the z-axis direction, which is combined with the laser scanning in the x-axis and y-axis directions described above, thereby obtaining three-dimensional image data.

The laser scanning probe 5 shown in FIG. 27 is preferably used for the observation of a part that is able to be in contact with the outside, such as human skin or oral cavity. For example, the laser scanning probe 5 is provided with a camera device (not shown) for imaging the outside through the window unit 782 that performs the laser scanning. The user can move the laser scanning probe 5 while the user refers to the image captured by the camera device in a state where the window unit 782 of the laser scanning probe 5 is in contact with an observation target, and can search a part desired to observe precisely. When the user finds out a part desired to observe, the laser scanning on the part is started. In this way, the laser scanning probe 5 can be moved by the user with the hand as desired to some extent, and thus it is possible to perform an observation with high usability.

As another usage of the laser scanning probe 5, it is conceivable to use a method of allowing the laser scanning probe 5 to be attached to a part of the body of an animal for testing (e.g., head and trunk) and of observing the state of the brain or organs with the elapse of time. For such usage, to prevent an excessive burden from being imposed on an animal, the laser scanning probe 5 is preferably configured to be relatively small and lightweight.

The other exemplary configuration of the laser scanning probe according to an exemplary embodiment has been described. As described above, the laser scanning observation device according to an exemplary embodiment may be the hand-held laser scanning probe 5 that is intended to be used by the user with the hand. In this way, in an exemplary embodiment, the laser scanning observation device can be used in both cases where biological tissue in the body cavity is observed using an endoscope or the like and where biological tissue in a predetermined depth from the body surface is observed.

(6-3. Laser Scanning Microscopic Device)

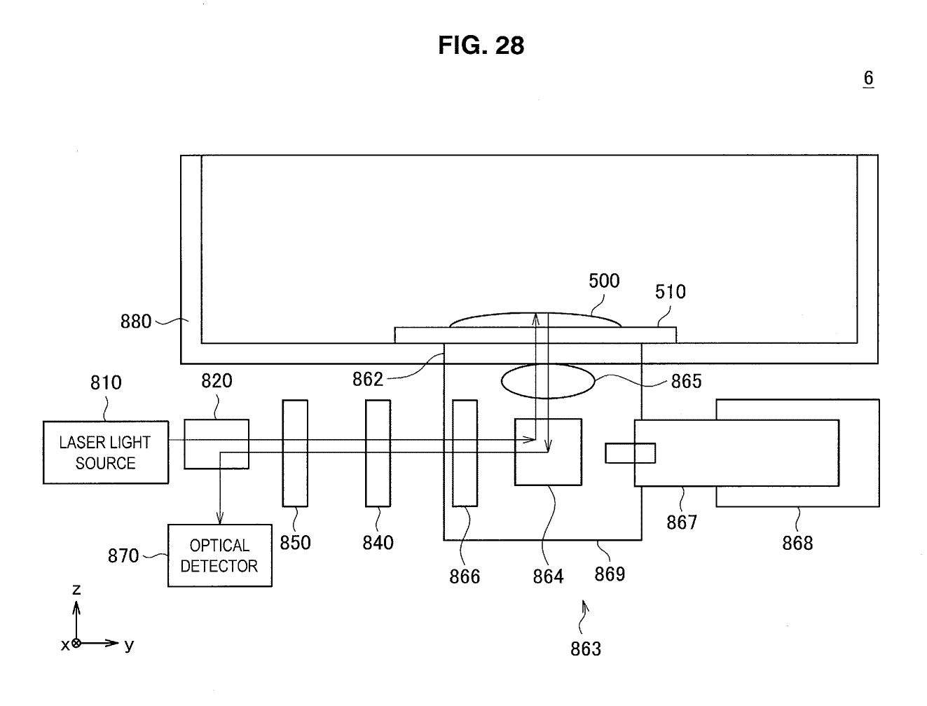

An exemplary configuration of the laser scanning microscopic device according to an embodiment will be described with reference to FIG. 28. FIG. 28 is a schematic diagram illustrating an exemplary configuration of the laser scanning microscopic device according to an embodiment. In FIG. 28, illustration of a casing is omitted to show constituent components arranged within the casing.

Referring to FIG. 28, a laser scanning microscopic device 6 according to an exemplary embodiment is configured to include a laser light source 810, a beam splitter 820, an optical detector 870, a collimator lens 850, a chromatic aberration correction element 840, a rotation mechanism 867, and a translational movement mechanism 868, which are arranged within a casing (not shown). In this way, an optical system including components from the laser light source to the scanning unit may be designed to be accommodated within a single casing, and thus the laser scanning microscopic device 6 may not be provided with a light guiding member such as an optical fiber. The laser scanning microscopic device 6 shown in FIG. 28 may be substantially similar to the laser scanning probe 4 shown in FIG. 18, especially in optical configuration, except that the laser light source 810, the beam splitter 820, and the optical detector 870 are provided within a casing and an optical fiber is not used. Thus, in the description below with reference to FIG. 28, the detailed description that is the same as the above-mentioned laser scanning probe 4 will be omitted.

The laser light emitted from the laser light source 810 passes through the collimator lens 850 and the chromatic aberration correction element 840, and then is incident on the scanning unit 863. The scanning unit 863 is configured to include an astigmatism correction element 866, an optical path changing element 864, and an objective lens 865, which are accommodated within a housing 869. The scanning unit 863 is connected to the rotation mechanism 867 and the translational movement mechanism 868 that are configured to include, for example, a motor or linear actuator. The scanning unit 863 is configured to be rotatable integrally about the y-axis direction serving as the direction of rotation axis and to be integrally moved translationally in the y-axis direction. The light incident on the scanning unit 863 passes through the astigmatism correction element 866. Then, the direction of travel of the light is changed in a direction substantially perpendicular thereto (e.g., z-axis direction in the figure) and the light passes through the objective lens 785, and then is guided to the outside of the housing 869.

The laser scanning microscopic device 6 is provided with a stage 880 on which the observation target 550 is placed. The scanning unit 863 is arranged at a position where the objective lens 865 faces the back surface of the stage 880 that is opposite the surface on which the observation target 500 is placed. A window unit 862 is formed in an area of the stage 880 that faces at least the scanning unit 863. The window unit 862 is composed by material that transmits light with a wavelength band corresponding to at least laser light. The laser light, which is collected by the objective lens 865 and is emitted from the scanning unit 863, is applied to the observation target 500 placed on the stage 880 through the window unit 862. As shown in FIG. 28, a prepared specimen in which the observation target 500 is placed on a member for placing a sample such as a slide glass 510 is fabricated in advance and the prepared specimen may be placed on the stage 880. In this case, the laser light passes through the slide glass 510 and is applied to the observation target 500, and thus a member formed by a material having optical properties to avoid interfering with the laser scanning can be preferably used as the slide glass 510.

The rotation of the scanning unit 863 in the y-axis direction as a rotation axis by the rotation mechanism 867 allows the observation target 500 to be scanned with laser light in the x-axis direction. The translational movement of the scanning unit 863 in the y-axis direction by the translational movement mechanism 868 allows the observation target 500 to be scanned with laser light in the y-axis direction. The returning light is guided to the reverse path through which the laser light passes. Specifically, the returning light passes through the objective lens 865, the optical path changing element 864, the astigmatism correction element 866, and the chromatic aberration correction element 840, and the collimator lens 850, and then is guided to the optical detector 870 by the beam splitter 820. Information relating to the observation target 500 is obtained, for example, in the form of image data depending on the returning light detected by the optical detector 870.

The laser scanning microscopic device 6 may be further provided with a movement mechanism (not shown) for moving the collimator lens 850 in the y-axis direction, which is similar to the laser scanning probe 4 shown in FIG. 18. The movement of the collimator lens 850 in the y-axis direction by the movement mechanism allows the depth of observation to be changed. This makes it possible to perform laser scanning in the depth direction (z-axis direction) with respect to the observation target 500, which is combined with the laser scanning in the x-axis and y-axis directions described above, thereby obtaining three-dimensional image data.

The configuration of the laser light source 810, the beam splitter 820, the optical detector 870, the collimator lens 850, the optical path changing element 864, the objective lens 865, the astigmatism correction element 866, the chromatic aberration correction element 840, the rotation mechanism 867, and the translational movement mechanism 868 shown in FIG. 28 may have similar functions to the constituent members shown in FIGS. 2 and 18, and thus detailed description thereof will be omitted. Although not shown in FIG. 28, the laser scanning microscopic device 6 may be further provided with components corresponding to the control unit 180, the output unit 190, and the input unit 195 shown in FIG. 2. These components allow an image of the observation target 500 to be obtained based on the returning light occurring by the laser scanning.

The exemplary configuration of the laser scanning microscopic device according to an exemplary embodiment has been described. As described above, the laser scanning observation device according to an exemplary embodiment may be the laser scanning microscopic device 6. The laser scanning endoscopic device 3 shown in FIG. 16 or the laser scanning probe 5 shown in FIG. 27 is intended to observe an observation target in the body cavity of a subject or to use the laser scanning probe 5 by holding it with the user's hand, and thus an optical system such as the scanning unit or a driving system such as rotation mechanism and translational movement mechanism is necessary to be relatively small. On the other hand, in the laser scanning microscopic device 6, an observation target is placed on a stage provided in the device and the observation target on the stage is subjected to the laser scanning, and thus the requirement for a small configuration of the scanning unit, the rotation mechanism, and the translational movement mechanism is relatively reduced. Thus, the optical system or driving system can be designed with a higher degree of freedom.

As an example of the driving system, the above-mentioned rotation mechanism 867 is taken into consideration. As described in the above item 2 (First embodiment), for example, when image data of one frame is assumed to be (x x y)=(500×500 pixels), to achieve the scanning speed of 1 fps, it is necessary to scan 500 lines per one second with laser light. Thus, the rotation speed necessary for the scanning unit 863 to achieve the scanning speed of 1 fps is 500×60×1=30000 [rpm]. This may be possible even at a lower speed depending on use applications, but a motor provided in the rotation mechanism 867 may be necessary to have a rotation speed of approximately 5000 to 30000 [rpm].

The motor of the rotation mechanism 867 is necessary to reduce axial run-out or inclination of axis (axis tilt) of the rotation axis during the rotation to a smaller range. This is because, if the position of the rotation axis of the motor fluctuates during rotation, the accuracy of scanning position on the z-axis direction of laser light (i.e. accuracy of depth of observation) is likely to be reduced.

To satisfy the rotation speed and the positional accuracy of the rotation axis as described above, the rotation mechanism 867 is necessary to have predetermined rigidity. Specifically, the rotation axis of the motor of the rotation mechanism 867 is necessary to be designed to withstand the centrifugal force (mrw²) acting on the scanning unit 863 during rotation (m is the mass of the scanning unit 863, r is the distance from the rotation axis to the center of the scanning unit 863 serving as a rotary body, and w is rotational angular velocity). To keep the positional accuracy of the rotation axis, a bearing provided in the motor is necessary to high rigidity. For example, if the scanning unit 863 serving as a rotary body is excessively larger than the performance of the motor of the rotation mechanism 867 can handle, excessive centrifugal force is applied to the rotation axis of the motor, and thus the request for the rigidity of the motor becomes stricter. Thus, a design in which the dynamic balance between the motor and the scanning unit 863 serving as a rotary body is taken into consideration is necessary, and the scanning unit 863 is necessary to be smaller and lighter.

Furthermore, in an exemplary embodiment, the laser scanning in the y-axis direction and/or z-axis direction may be performed in synchronization with the laser scanning in the x-axis direction by the rotation of the scanning unit 863. Thus, to improve the accuracy of the laser scanning, a high-resolution angle sensor (e.g., a rotary encoder) used to detect the accuracy of the motor rotation angle with high precision is preferable to be mounted together with the motor.

For example, in the laser scanning endoscopic device 3 shown in FIG. 16, it is considered how performance described above is satisfied. In the laser scanning endoscopic device 3, for example, it is necessary to be equipped with the scanning unit 663 and the rotation mechanism 667 in the tube 661 having a diameter of approximately 10 mm. Thus, if other components are considered to be provided in the tube 661, a motor for the rotation mechanism 667 is preferable to have the size in the radial direction is 60% or less of the diameter of the tube 661 (6 mm or less in the above example) and the length along the tube is 20 mm or less. For example, if the objective lens is assumed to support an NA of 0.45, as the positional accuracy of the rotation axis of the motor, it is preferable that the amount of axial run-out is 0.01 mm or less and the amount of axis tilt is 0.1 [deg] or less.

In this way, in the laser scanning endoscopic device 3, for a relatively small motor, it is necessary to achieve rigidity while maintaining the position of the rotation axis with high accuracy. The angle sensor is necessary to be high resolution and small in size. Thus, when components are necessary to be provided within a relatively small casing, as is the case with the laser scanning endoscopic device 3, conditions when constituent members including the rotation mechanism 667 and the scanning unit 663 are designed is likely to be relatively strict. On the other hand, the laser scanning microscopic device 6 is necessary to reduce its size, as is the case with the laser scanning endoscopic device 3. Accordingly, a lager motor can be used for the rotation mechanism 867, and thus constituent members including the rotation mechanism 867 and the scanning unit 863 may be designed easily.

As described in the above item 1. (Examination of laser scanning endoscopic devices with different configurations), in a laser scanning microscopic device as the existing technique commonly used, it is possible to relatively increase its size, and the degree of freedom in designing an optical system is high. Thus, an appropriate designing of an optical system may obtain a configuration for implementing the above items 3 “High NA” and 4 “Wide field of view”, simultaneously. However, in the existing technique, the optical system has a complicated configuration, and thus a reduction in size and cost is difficult to be achieved. On the other hand, according to an exemplary embodiment, the rotation of the scanning unit 863 performs the laser light scanning with a simple configuration, and thus a wide field of view is achieved even when the objective lens 865 having a relatively large NA is used. The astigmatism correction element 866 makes it possible to perform high precision observation with less influence of astigmatism even when the depth of observation is changed.

### 7. HARDWARE CONFIGURATION

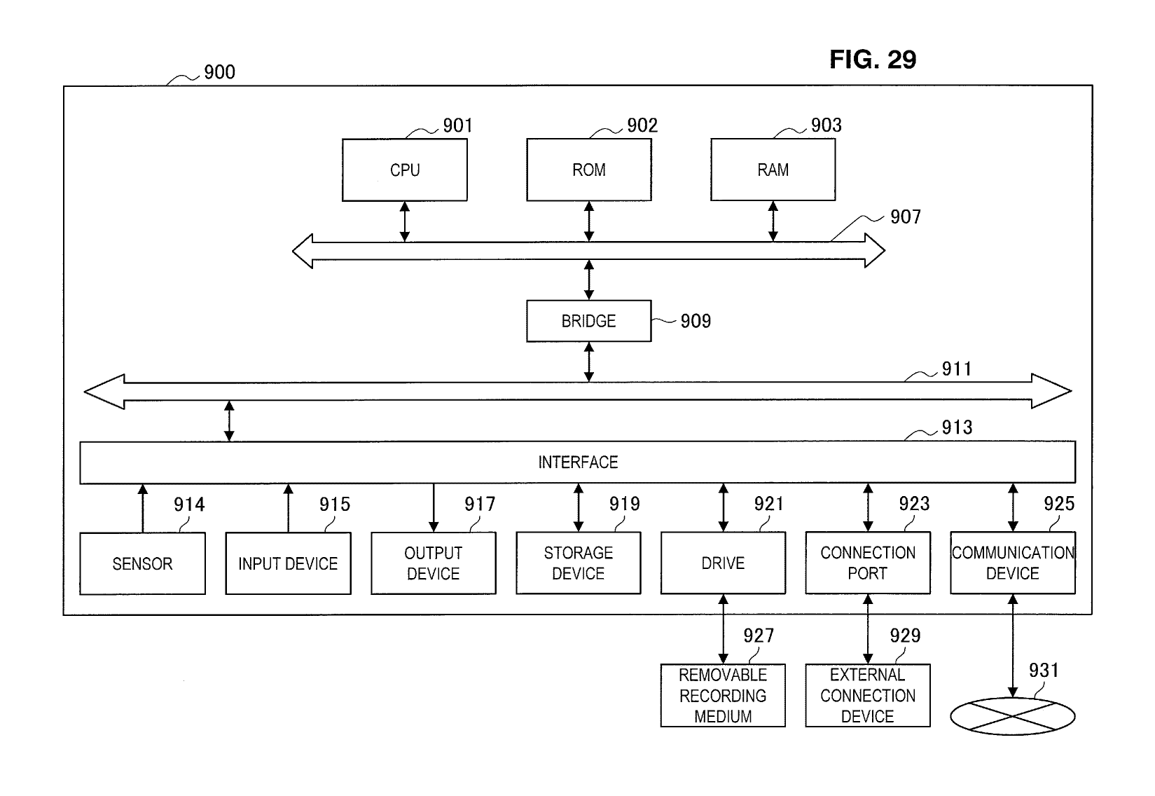

A hardware configuration of the laser scanning observation device according to an exemplary embodiment will be described in detail with reference to FIG. 29. FIG. 29 is a block diagram illustrated to describe the hardware configuration of the laser scanning observation device according to an embodiment. The laser scanning observation device shown in FIG. 29 may implement the laser scanning endoscopic device 1, 2, or 3, the laser scanning probe 4 or 5, or the laser scanning microscopic device 6.

With reference to FIG. 29, the laser scanning observation device 900 mainly include a CPU 901, a ROM 903, and a RAM 905. The laser scanning observation device 900 further include a host bus 907, a bridge 909, an external bus 911, an interface 913, a sensor 914, an input device 915, an output device 917, a storage device 919, a drive 921, a connection port 923, and a communication device 925.

The CPU 901 functions as an arithmetic processing device and a control device and controls some or all of the operations in the laser scanning observation device 900 according to various programs recorded in the ROM 903, the RAM 905, the storage device 919, or the removable recording medium 927. The ROM 903 stores programs, arithmetic parameters, or the like used by the CPU 901. The RAM 905 first store programs used by the CPU 901 or parameters or the like appropriately changed in execution of the programs. The CPU, the ROM, and the RAM are connected by the host bus 907 including an internal bus such as a CPU bus. The CPU 901, the ROM 903, and the RAM 905 correspond to, for example, the control units 180 and 280 illustrated in FIGS. 2 and 4A in the present embodiment.

The host bus 907 is connected to the external bus 911 such as a Peripheral Component Interconnect/Interface (PCI) bus via the bridge 909.

The sensor 914 is a detection unit that detects biological information unique to a user or various kinds of information used to acquire the biological information. In the present embodiment, the sensor 914 corresponds to, for example, the optical detector 170 illustrated in FIGS. 2 and 4A. Also, the sensor 914 corresponds to, for example, each constituent member related to a series of systems that includes the endoscope 160 and the optical detector 170 illustrated in FIGS. 2 and 4A, and scans the biological tissue 500 with laser light and detects returning light. For example, the sensor 914 may include various image sensors, for example, a optical detector such as a photodiode or PMT, a charge coupled device (CCD) or a complementary metal oxide semiconductor (CMOS). Also, the sensor 914 may further include a light source or an optical system such as a lens used to image a biological part. Also, the sensor 914 may be a microphone or the like configured to acquire an audio or the like. Also, the sensor 914 may include various measurement devices such as a thermometer, an illuminometer, a hydrometer, a speedometer, and an accelerometer in addition to the above-described devices.

The input device 915 is, for example, an operation unit operated by a user, such as a mouse, a keyboard, a touch panel, a button, a switch, and a lever. Also, the input device 915 may be, for example, a remote control unit (so-called remote controller) using infrared light or other radio waves or may be an external connection device 929 such as a mobile phone or a PDA corresponding to an operation of the laser scanning observation device 900. Also, the input device 915 includes, for example, an input control circuit that generates an input signal based on information input by a user using the foregoing operation unit and outputs the generated signal to the CPU 901. In the present embodiment, the input device 915 corresponds to, for example, the input unit 195 illustrated in FIGS. 2 and 4A. For example, the user of the laser scanning observation device 900 can input various kinds of data regarding driving of a rotation mechanism, a translational movement mechanism, and/or a depth-of-observation adjusting mechanism, or the like or instruct the laser scanning observation device 900 to perform a processing operation by operating the input device 915.

The output device 917 includes a device capable of visually or audibly notifying a user of the acquired information. Examples of this output device include display devices such as a CRT display device, a liquid crystal display device, a plasma display device, an EL display device, and a lamp, audio output devices such as a speaker and a headphone, and printer devices. The output device 917 outputs, for example, results obtained through various processes performed by the laser scanning observation device 900. Specifically, a display device visually displays results obtained through various processes performed by the laser scanning observation device 900 in various forms such as text, images, tables, and graphs. On the other hand, an audio output device converts an audio signal produced from reproduced audio data, acoustic data, or the like into an analog signal and outputs the converted analog signal. In the present embodiment, the output device 917 corresponds to, for example, the output unit 190 illustrated in FIGS. 2 and 4. For example, image data regarding a biological tissue acquired as the result of the laser scanning is displayed on a display screen of the output device 917.

Although not illustrated in FIGS. 2 and 4A, the laser scanning observation device 900 may further include the following constituent members.

The storage device 919 is a data storage device configured as one example of the storage unit of the laser scanning observation device 900. The storage device 919 includes, for example, a magnetic storage device such as a Hard Disk Drive (HDD), a semiconductor storage device, an optical storage device, or a magneto-optical storage device. The storage device 919 stores various kinds of data processed in the laser scanning observation device 900, e.g., programs or various kinds of data executed by the CPU 901, various kinds of data acquired from the outside, and various kinds of data acquired as the result of the laser scanning in the laser scanning observation device 900. In the present embodiment, for example, the storage device 919 stores programs, various conditions, or the like for controlling the laser scanning in the laser scanning observation device 900. For example, the storage device 919 stores image data regarding a biological tissue acquired as the result of the laser scanning.

The drive 921 is a recording medium reader and writer and is included internally or attached outside the laser scanning observation device 900. The drive 921 reads information recorded in the mounted removable recording medium 927 such as a magnetic disk, an optical disc, a magneto-optical disc, or a semiconductor memory and outputs the read information to the RAM 905. Also, the drive 921 can also write a record on the mounted removable recording medium 927 such as a magnetic disk, an optical disc, a magneto-optical disc, or a semiconductor memory. Examples of the mounted removable recording medium 927 include DVD media, HD-DVD media, and Blu-ray (a registered trademark) media. Also, the mounted removable recording medium 927 may be a CompactFlash (CF) (registered trademark), a flash memory, a Secure Digital (SD) memory card, or the like. Also, the mounted removable recording medium 927 may be an electronic device or an Integrated Circuit (IC) card on which a contactless type IC chip is mounted. The drive 921 writes and reads various kinds of data processed in the laser scanning observation device 900 to and from various types of the mounted removable recording medium 927.

The connection port 923 is a port configured to directly connect various kinds of external devices to the laser scanning observation device 900. Examples of the connection port 923 include a Universal Serial Bus (USB) port, an IEEE 1394 port, and a Small Computer System Interface (SCSI) port. Other examples of the connection port 923 include an RS-232C port, an optical audio terminal, and a High-Definition Multimedia Interface (HDMI)(a registered trademark) port. When the external connection device 929 is connected to the connection port 923, the laser scanning observation device 900 directly acquire various kinds of data from the external connection device 929 or supply various kinds of data to the external connection device 929. Thus, the connection port 923 connects various external devices to the laser scanning observation device 900 such that various kinds of data can be communicated. The laser scanning observation device 900 can transmit various kinds of data processed in the laser scanning observation device 900, e.g., image data regarding a biological tissue acquired as the result of the laser scanning, to various kinds of external devices via the connection port 923.

The communication device 925 is, for example, a communication interface including a communication device configured to connect to a communication network (network) 931. The communication device 925 is, for example, a communication card for a wired or wireless Local Area Network (LAN), Bluetooth (registered trademark), or a Wireless USB (WUSB). Also, the communication device 925 may also be a router for optical communication, a router for an Asymmetric Digital Subscriber Line (ADSL), or a modem for various kinds of communication. For example, the communication device 925 can transmit and receive a signal or the like to and from the Internet or another communication device in conformity with, for example, a predetermined protocol such as TCP/IP. Also, the communication network 931 connected to the communication device 925 includes networks connected in a wired or wireless manner and may be, for example, the Internet, a home LAN, infrared communication, radio-wave communication, or satellite communication. The communication device 925 can transmit and receive various kinds of data processed in the laser scanning observation device 900 between the laser scanning observation device 900 and various external devices. For example, the communication device 925 can transmit various kinds of data processed in the laser scanning observation device 900 to various external devices via the communication network 931. For example, image data regarding a biological tissue acquired as the result of the laser scanning may be transmitted to various external devices such as database servers by the communication device 925.

One example of a hardware configuration capable of realizing the functions of the laser scanning observation device 900 according to the embodiments of the present disclosure has been described above. Each of the foregoing constituent elements may be configured using a general member or may be configured by hardware specialized for the function of each constituent element. Accordingly, the hardware configuration to be used may be modified appropriately according to a technical level when the present embodiment is realized.

A computer program for realizing each function regarding the laser scanning and the acquisition of the image data in the laser scanning observation device 900 according to the above-described embodiments can be produced and mounted on a personal computer or the like. Also, a computer-readable recording medium storing the computer program can also be provided. Examples of the recording medium include a magnetic disk, an optical disc, a magneto-optical disc, and a flash memory. Also, the foregoing computer program may be delivered via, for example, a network without using a recording medium.

### 8. CONCLUSION

As described above, the following advantages can be obtained according to the preferred embodiments of the present disclosure.

In the laser scanning endoscopic device 1 according to the first embodiment, the biological tissue 500 is scanned with the laser light via the window unit 162 in the x axis direction by rotating the objective lens 165 about the y axis as the rotation axis inside the tube 161. Thus, since scanning with the laser light is performed by rotating the objective lens 165, the field of view (FOV) in the laser scanning endoscopic device 1 is not restricted due to off-axis characteristics of the objective lens 165. Accordingly, in the laser scanning endoscopic device 1, a range (that is, a range in which scanning with the laser light is performed in the x axis direction) facing the window unit 162 during the rotation of the objective lens 165 is ensured as the FOV. Therefore, the wide field of view is realized even when the NA of the objective lens 165 is relatively high. Since the window unit 162 provided in the endoscope 160 of the laser scanning endoscopic device 1 according to the first embodiment is formed to have a predetermined thickness, safety is guaranteed at the time of the contact of the window unit 162 with a biological tissue. In the laser scanning endoscopic device 1 according to the first embodiment, the aberration correction element 166 that corrects aberration occurring at the time of the collection of the laser light on a biological tissue is provided at the front stage of the window unit 162. Here, the aberration correction performance of the aberration correction element 166 may be set appropriately according to the characteristics or the shapes of the objective lens 165 and the window unit 162 so that the aberration occurring due to the objective lens 165 and/or the window unit 162 is corrected. Accordingly, in the laser scanning endoscopic device 1, it is possible to achieve compatibility between the guarantee of safety obtained by allowing the window unit to have a predetermined thickness and acquisition of a high-quality image obtained by suppressing an influence of aberration, while using an objective lens with a relatively high NA.

Also, in the laser scanning endoscopic device 1, a high resolution and a wide field of view can be ensured by rotating the objective lens 165. Accordingly, a biological tissue can be efficiently observed since the biological tissue can be viewed in a wide range by controlling a sampling rate of the laser scanning or a desired portion can be observed with a higher resolution by expanding the desired portion, as necessary.

In the laser scanning endoscopic device 2 according to the second embodiment, it is possible to obtain the following advantages in addition to the advantages obtained in the laser scanning endoscopic device according to the above-described first embodiment. That is, in the laser scanning endoscopic device 2, the pencil of the laser light is incident on the optical path changing element 164 and the objective lens 165 collects the pencil of the laser light on the plurality of different spots of the biological tissue 500. Here, the laser light constituting the pencil may be differently modulated laser light. The laser scanning endoscopic device 2 has a function of demodulating the laser light, and thus can selectively separate and acquire an image signal corresponding to the returning light from each spot. Accordingly, in the laser scanning endoscopic device 2, the plurality of lines of the laser light applied to the plurality of spots can be scanned while the scanning unit 163 is rotated once. Thus, even when the number of rotations of the scanning unit 163 is relatively small, a high scanning speed can be obtained.

Also, in the laser scanning endoscopic devices 1 and 2 according to the first and second embodiments, the scanning unit may be configured to include a plurality of objective lenses. When the scanning unit includes the plurality of objective lenses, the laser scanning of the plurality of lines by the plurality of objective lenses can be performed while the scanning unit is rotated once. Accordingly, scanning with the laser light can be performed more efficiently since the number of lines scanned through one rotation of the scanning unit can be increased.

Also, in the laser scanning endoscopic devices 1 and 2 according to the first and second embodiments, the scanning unit may have a configuration in which the scanning unit has another rotation axis direction. For example, the window unit 162 is provided at the distal portion in the longitudinal direction of the tube 161 and has the surface substantially perpendicular to the longitudinal direction of the tube 161. In addition, the laser scanning is performed on a portion brought into contact with the distal portion of the tube 161. Accordingly, even when an examination target part is present in a recessed concave portion inside a body cavity that is difficult to bring in contact with the outside side wall of the tube 161, an examination can be carried out through the laser scanning.

Moreover, the case where the laser scanning observation device is configured to include the depth-of-observation adjusting mechanism has been described in the above item 6 (Configuration including depth-of-observation adjusting mechanism). As the exemplary configuration other than the endoscopic device of the laser scanning observation device according to an exemplary embodiment, the configuration of the laser scanning probe and the laser scanning microscopic device has been described. These configurations make it possible to obtain advantageous effects described below in addition to the effect obtained from the above-mentioned first embodiment and/or second embodiment.

In the laser scanning observation device described in the above item 6 (Configuration including depth-of-observation adjusting mechanism), the provision of the depth-of-observation adjusting mechanism makes it possible to perform a laser scanning of an observation target in the direction of depth. Thus, it is possible to observe the observation target three-dimensionally, thereby obtaining more information about the observation target. The laser scanning observation device may be provided with the astigmatism correction element that corrects the astigmatism by the amount of correction corresponding to variation in astigmatism caused by a change in the depth of observation. The provision of the astigmatism correction element having such properties allows high precision observation with less influence of astigmatism to be performed even when the depth of observation is changed.

When the fluorescent light as the returning light is detected, for example, as is the case with the observation using two-photon excitation, the double clad optical fiber may be used as an optical fiber, and the chromatic aberration correction element may be provided. The use of the double clad optical fiber allows the fluorescent light to be guided in the internal clad. Thus, the fluorescent light can be collected over a wider area, thereby improving the light collection efficiency. The chromatic aberration correction element is designed to correct the astigmatism caused by the difference between wavelengths of the laser light and fluorescent light. Thus, the provision of astigmatism correction element having such properties makes it possible to further improve the light collection efficiency of fluorescent light on the optical fiber.

The preferred embodiments of the present disclosure have been described above in detail with reference to the appended drawings, but the technical scope of embodiments of the present disclosure is not limited to these examples. It should be apparent to those skilled in the art in the technical fields of the present disclosure that various modification examples or correction examples can be made within the scope of the technical scope described in the claims and the modification examples and the correction examples are, of course, construed to pertain to the technical scope of the present disclosure.

For example, the use application of the technique according to each embodiment described above is not limited to the observation using an endoscope, and other use applications may be used, for example, various kinds of optogenetical manipulations including the control of the ion channel of nerve cells that can control the activation and inactivation by photoexcitation is applicable.

For example, a configuration described below may be further provided in each configuration described above.

For example, the laser light source 110 may further have a configuration in which a laser-light emission timing is dynamically controlled. Also, the laser light source 110 may emit laser light only at a timing at which the laser light is applied to the biological tissue 500 in synchronization with rotation of the scanning unit by the rotation mechanism 167. Power consumption can be reduced more than a configuration in which the laser light source 110 emits the laser light only at a necessary time.

For example, the laser light source 110 may further have a configuration in which the intensity (power) of the emitted laser light is dynamically controlled. In general, when expanded image data is acquired, a light reception accumulation time per pixel is shorter as expansion (zoom) is performed, and thus the brightness of the acquired image data deteriorates. Accordingly, the laser light source 110 may control the intensity of the emitted laser light according to the size of the acquired image data. For example, when expanded image data is acquired, the laser light source 110 may increase the intensity of the emitted laser light. The emission timing and the intensity of the laser light of the laser light source 110 may be controlled by the control unit 180.

The rotation mechanism 167 may further include a rotary servomechanism to stably control rotation driving of the scanning unit. The rotary servomechanism can stabilize the rotation of the scanning unit, for example, by detecting an amount of eccentricity or the like during the rotation of the scanning unit and controlling a rotation speed or the like. Aberration including astigmatism may vary depending on a measure of eccentricity. Thus, information about the measure of eccentricity for the scanning unit is fed back to the aberration correction element and the amount of correction may be dynamically controlled by the aberration correction element depending on variation of aberration including astigmatism calculated from the measure of eccentricity.

Also, as described in the foregoing (2. First embodiment), the endoscope 160 may further include an imaging unit that images the inside of a body cavity of a patient. For example, the imaging unit may include a wide-angle bright-field imaging camera. When the imaging unit includes a wide-angle bright-field imaging camera, the laser scanning may be performed by searching for an observation target part desired to be observed in detail with reference to a wide-angle image photographed by the imaging unit and bringing the window unit 162 into contact with the searched observation target part.

Additionally, the present technology may also be configured as below.
(1)

An endoscope including:

a window unit configured to be provided in a partial area of a tubular casing and come into contact with or be close to a biological tissue inside a body cavity of a subject that is an observation target;

an objective lens configured to be provided inside the casing and collect laser light on the biological tissue via the window unit;

an optical path changing element configured to guide the laser light guided inside the casing in a major axis direction of the casing to a lens surface of the objective lens;

an aberration correction element configured to be provided at a front stage of the window unit and correct aberration occurring when the laser light is collected on the biological tissue; and

a rotation mechanism configured to rotate at least the objective lens inside the casing about a rotational axis which is perpendicular to an optical axis of the objective lens and does not pass through the objective lens so that the biological tissue is scanned with the laser light.
(2)

The endoscope according to (1), wherein the aberration correction element corrects at least astigmatism occurring due to the window unit.
(3)

The endoscope according to (2), wherein the aberration correction element includes at least one cylindrical lens.
(4)

The endoscope according to any one of (1) to (3), wherein the rotation mechanism integrally rotates the optical path changing element, the aberration correction element, and the objective lens.
(5)

The endoscope according to any one of (1) to (4), further including:

a translational movement mechanism configured to move at least the objective lens translationally in a direction of the rotational axis inside the casing.
(6)

The endoscope according to any one of (1) to (5),

wherein a pencil of the laser light is incident on the optical path changing element, and

wherein the objective lens collects the pencil of the laser light on a plurality of different spots of the biological tissue.
(7)

The endoscope according to (6), wherein the pencil of the laser light includes the laser light modulated in a plurality of different states.
(8)

The endoscope according to any one of (1) to (7), wherein the window unit is provided in a partial area of a side wall substantially parallel to the major axis direction of the casing.
(9)

The endo scope according to (8),

wherein a plurality of the objective lenses are provided, and

wherein the plurality of objective lenses face inner walls of the casing at substantially identical positions in the major axis direction of the casing and are arranged at a predetermined interval in an outer circumferential direction of the casing.
(10)

The endoscope according to (9), further including:

a polarization modulation element configured to be provided at a front stage of the optical path changing element and change a polarization direction of the laser light incident on the optical path changing element,

wherein the optical path changing element is a polarization beam splitter changing an optical path of the laser light having a predetermined polarization direction, and

wherein the polarization beam splitter guides the laser light of which the polarization direction is changed by the polarization modulation element to the objective lens facing the window unit among the plurality of objective lenses according to the polarization direction of the laser light.
(11)

The endoscope according to (9),

wherein the optical path changing element is an MEMS minor capable of dynamically controlling a reflection direction of the incident laser light, and

wherein the MEMS mirror guides the incident laser light to the objective lens facing the window unit among the plurality of objective lenses.
(12)

The endoscope according to (9), further including:

an optical path branching element configured to be provided at a front stage of the optical path changing element and branch the laser light incident on the optical path changing element into a plurality of optical paths,

wherein the aberration correction element and the optical path changing element are provided in each of front stages of the plurality of objective lenses, and

wherein the laser light branched by the optical path branching element sequentially passes through the optical path changing element and the aberration correction element to be guided to each of the plurality of objective lenses.
(13)

The endoscope according to (9),

wherein the aberration correction element and the optical path changing element are provided at each of front stages of the plurality of objective lenses,

wherein the endoscope further includes
an incident window unit configured to be provided at each of the front stages of a plurality of the optical path changing elements and allow the laser light to be incident only on the corresponding optical path changing element,

wherein the laser light is guided inside the casing in a state in which an optical axis of the laser light is maintained at a predetermined position with respect to the casing, and

wherein the laser light incident from the incident window unit corresponding to an irradiation position of the laser light is sequentially guided to the aberration correction element, the optical path changing element, and the objective lens that are corresponding to the incident window unit.
(14)

The endoscope according to any one of (1) to (7), wherein the window unit has a surface substantially perpendicular to the major axis direction of the casing at a distal portion in the major axis direction of the casing.
(15)

The endoscope according to any one of (1) to (14), wherein a space between the objective lens and the window unit is immersed in a liquid having substantially the same refractive index as the objective lens and the window unit.
(16)

The endoscope according to any one of (1) to (15), further including:

an optical axis direction movement mechanism configured to move at least the objective lens translationally in the optical axis direction of the objective lens.
(17)

A laser scanning endoscopic device including:

an endoscope configured to include
a window unit configured to be provided in a partial area of a tubular casing and come into contact with or be close to a biological tissue inside a body cavity of a subject that is an observation target,
an objective lens configured to be provided inside the casing and collect laser light on the biological tissue via the window unit,
an optical path changing element configured to guide the laser light guided inside the casing in a major axis direction of the casing to a lens surface of the objective lens,
an aberration correction element configured to be provided at a front stage of the window unit and correct aberration occurring when the laser light is collected on the biological tissue, and
a rotation mechanism configured to rotate at least the objective lens inside the casing about a rotational axis which is perpendicular to an optical axis of the objective lens and does not pass through the objective lens so that the biological tissue is scanned with the laser light;

an optical detector configured to detect returning light occurring when the laser light is collected on the biological tissue; and

a control unit configured to generate image data regarding the biological tissue based on the detected returning light.
(18)

A laser scanning method including:

guiding laser light inside a tubular casing in an endoscope and allowing the laser light to be incident on an optical path changing element provided inside the casing;

changing an optical path of the laser light guided in a major axis direction of the casing by the optical path changing element and guiding the laser light to a lens surface of an objective lens provided inside the casing;

collecting the laser light on a biological tissue inside a body cavity of a subject that is an observation target by the objective lens via a window unit configured to be provided in a partial area of the casing and come into contact with or be close to the biological tissue; and

rotating at least the objective lens inside the casing about a rotational axis which is perpendicular to an optical axis of the objective lens and does not pass through the objective lens so that the biological tissue is scanned with the laser light,

wherein an aberration correction element configured to correct aberration occurring when the laser light is collected on the biological tissue is provided at a front stage of the window unit.

Additionally, the present technology may also be configured as below.
(1)

A laser scanning observation device including:

a window unit provided in a partial area of a casing and configured to be in contact with or close to an observation target;

an objective lens configured to collect laser light on the observation target through the window unit;

an optical path changing element configured to change a direction of travel of the laser light guided within the casing toward the window unit;

an astigmatism correction element provided in a front stage of the window unit and configured to correct astigmatism occurring upon the collection of the laser light on the observation target; and

a rotation mechanism configured to allow at least the optical path changing element to rotate about a rotation axis perpendicular to a direction of incidence of the laser light on the window unit to scan the observation target with the laser light,

wherein the astigmatism correction element corrects astigmatism by an amount of correction corresponding to variation in the astigmatism caused by a change in depth of observation, the depth of observation being a measure of depth at a position where the laser light is collected on the observation target.
(2)

The laser scanning observation device according to (1),

wherein the astigmatism correction element includes a lens having an at least two-sided cylindrical surface or toroidal surface through which the laser light passes, the astigmatism correction element being configured to rotate together with the optical path changing element by the rotation mechanism.
(3)

The laser scanning observation device according to (2),

wherein the astigmatism correction element is a meniscus lens having a cylindrical surface formed on both surfaces.
(4)

The laser scanning observation device according to (1),

wherein the astigmatism correction element is an optical member including a driving element configured to dynamically change the amount of correction for astigmatism depending on the change in the depth of observation.
(5)

The laser scanning observation device according to any one of (1) to (4), further including:

a translational movement mechanism configured to allow at least the optical path changing element to move translationally in a direction of the rotation axis to scan the observation target with the laser light in the rotation axis direction.
(6)

The laser scanning observation device according to any one of (1) to (5), further including:

a depth-of-observation adjusting mechanism configured to change the depth of observation to scan the observation target with the laser light in a depth direction.
(7)

The laser scanning observation device according to (6),

wherein the depth-of-observation adjusting mechanism includes a collimator lens and a movement mechanism, the collimator lens being configured to collimate the laser light into a substantially parallel beam of light and to guide the collimated light to the optical path changing element and the astigmatism correction element, the movement mechanism being configured to move the collimator lens in a direction of an optical axis.
(8)

The laser scanning observation device according to any one of (1) to (7),

wherein the laser scanning observation device detects fluorescent light occurring by irradiating the observation target with the laser light as returning light to acquire information relating to the observation target, and

wherein the laser scanning observation device further includes a chromatic aberration correction element configured to correct chromatic aberration caused by a difference in wavelengths between the laser light and the fluorescent light.
(9)

The laser scanning observation device according to (8),

wherein the chromatic aberration correction element is a cemented lens configured to function as a parallel flat plate for light having a wavelength band corresponding to the laser light and to function as a concave lens for light having a wavelength band corresponding to the fluorescent light.
(10)

The laser scanning observation device according to any one of (1) to (9),

wherein the optical path changing element is configured to allow a pencil of the laser light to be incident on the optical path changing element, and

wherein the objective lens collects the pencil of the laser light at a plurality of different spots of the observation target.
(11)

The laser scanning observation device according to (10),

wherein the pencil of the laser light is configured to include the laser light modulated to a plurality of different states.
(12)

The laser scanning observation device according to (10) or (11),

wherein the pencil of the laser light is guided into the casing through a plurality of optical fibers.
(13)

The laser scanning observation device according to (10) or (11),

wherein the pencil of the laser light is guided into the casing through a multi-core optical fiber including a plurality of cores.
(14)

The laser scanning observation device according to any one of (1) to (13), further including:

a polarization modulation element provided in a front stage of the optical path changing element and configured to change a polarization direction of the laser light incident on the optical path changing element,

wherein the optical path changing element is a polarization beam splitter configured to change an optical path of the laser light having a predetermined polarization direction, and

wherein the polarization beam splitter changes a direction of travel of the laser light of which a polarization direction is changed by the polarization modulation element toward the window unit depending on the polarization direction of the laser light.
(15)

The laser scanning observation device according to any one of (1) to (13), further including:

an optical path branching element provided in a front stage of the optical path changing element and configured to allow the laser light incident on the optical path changing element to be branched into a plurality of optical paths,

wherein the astigmatism correction element, the optical path changing element, and the objective lens are provided for each of the plurality of optical paths, and

wherein the optical path changing element changes each direction of travel of the laser light branched by the optical path branching element to a plurality of directions perpendicular to a direction of the rotation axis.
(16)

The laser scanning observation device according to any one of (1) to (13),

wherein the laser scanning observation device is provided with a housing configured to accommodate at least a plurality of the optical path changing elements and to rotate together with the plurality of optical path changing elements,

wherein the housing includes an incident window unit formed on a wall of the housing on which the laser light is incident and configured to allow the laser light to be incident on each of the plurality of optical path changing elements,

wherein the astigmatism correction element and the objective lens are provided for each of a plurality of the incident window units,

wherein the laser light is guided within the casing in a state where an optical axis of the laser light is maintained at a predetermined position with respect to the casing and the laser light is sequentially applied to the plurality of incident window units with a rotation of the housing, and

wherein the laser light incident through the incident window unit corresponding to a position to be irradiated with the laser light is guided to the window unit by the optical path changing element.
(17)

The laser scanning observation device according to any one of (1) to (16),

wherein the casing has a cylindrical shape, and

wherein the window unit is provided on a side wall substantially parallel to a longitudinal direction of the casing and has a cylindrical curved surface conforming to a shape of the side wall of the casing.
(18)

The laser scanning observation device according to any one of (1) to (16),

wherein the casing has a cylindrical shape, and

wherein the window unit is provided at a distal portion of the casing in a longitudinal direction and has a surface substantially perpendicular to the longitudinal direction of the casing.
(19)

The laser scanning observation device according to any one of (1) to (18),

wherein the objective lens is provided between the optical path changing element and the window unit, and

wherein a space between the objective lens and the window unit is immersed in liquid having substantially a same refractive index as a refractive index of the window unit.
(20)

The laser scanning observation device according to any one of (1) to (19),

wherein the casing is a tube of an endoscope, and

wherein the window unit provided in a partial area of the tube is brought in contact with or close to a biological tissue in a body cavity of a human or animal to be observed and allows the biological tissue to be scanned with the laser light.
(21)

The laser scanning observation device according to any one of (1) to (19),

wherein the window unit is brought in contact with or close to a body surface of a human or animal to be observed and allows a biological tissue at a predetermined depth from the body surface to be scanned with the laser light.
(22)

The laser scanning observation device according to any one of (1) to (19), further including:

a stage configured to allow the observation target to be placed on the stage,

wherein the observation target is scanned with the laser light through the window unit provided on at least a partial area of the stage.
(23)

A laser scanning method including:

causing laser light to be incident on an optical path changing element provided within a casing;

changing a direction of travel of the laser light guided within the casing by the optical path changing element, and irradiating, through a window unit provided in a partial area of the casing and configured to be in contact with or close to an observation target, the observation target with the laser light which is collected by an objective lens and in which astigmatism is corrected by an astigmatism correction element; and

causing at least the optical path changing element to rotate about a rotation axis perpendicular to an observation direction to scan the biological tissue with the laser light, the observation direction being a direction of incidence of the laser light on the observation target,

wherein the astigmatism correction element corrects astigmatism by an amount of correction corresponding to variation in the astigmatism caused by a change in depth of observation, the depth of observation being a measure of depth at a position where the laser light is collected on the observation target.

### REFERENCE SIGNS LIST

1, 2, 3 laser scanning endoscopic device
4,5 laser scanning probe
6 laser scanning microscopic device
110, 810 laser light source 110
120, 820 beam splitter
130, 150 optical fiber light-guiding lens
140, 241, 242, 243, 340, 641, 710, 740, 760 optical fiber
160, 360, 400, 450, 470 endoscope
161 tube
162, 662 ,732, 782, 862 window unit
163, 363, 370, 380, 390, 420, 460, 480, 663, 733, 783, 863 scanning unit
164, 364, 421, 422, 664, 734, 784, 864 optical path changing element
165, 365, 366, 422, 665, 735, 785, 865 objective lens
166, 367, 368, 423, 461 aberration correction element
167, 667, 737, 787, 867 rotation mechanism
168, 668, 738, 788, 868 translational movement mechanism
169, 369, 424, 469, 669, 739, 789, 869 housing
170, 870 light detector
180, 280 control unit
181 image signal acquisition unit
182 image signal processing unit
183 driving control unit
184 display control unit
190 output unit
195 input unit
240 optical fiber bundle
281 image signal acquisition unit (light demodulation unit)
372 polarization beam splitter
381 MEMS mirror
391 optical path branching element
463 first optical path changing element
464 second optical path changing element
465 first objective lens
466 second objective lens
620 cylindrical concave-convex lens pair
621 concave cylindrical lens
622 convex cylindrical lens
630 cylindrical meniscus lens
640 cylindrical plane-convex lens
650, 720, 770, 850 collimator lens
661, 731, 781 casing
666, 736, 786, 866 astigmatism correction element
670, 740, 790, 840 chromatic aberration correction element

1. A laser scanning observation device comprising:
a window unit provided in a partial area of a casing and configured to be in contact with or close to an observation target;
an objective lens configured to collect laser light on the observation target through the window unit;
an optical path changing element configured to change a direction of travel of the laser light guided within the casing toward the window unit;
an astigmatism correction element provided in a front stage of the window unit and configured to correct astigmatism occurring upon the collection of the laser light on the observation target; and
a rotation mechanism configured to allow at least the optical path changing element to rotate about a rotation axis perpendicular to a direction of incidence of the laser light on the window unit to scan the observation target with the laser light,
wherein the astigmatism correction element corrects astigmatism by an amount of correction corresponding to variation in the astigmatism caused by a change in depth of observation, the depth of observation being a measure of depth at a position where the laser light is collected on the observation target.

2. The laser scanning observation device according to claim 1,
wherein the astigmatism correction element includes a lens having an at least two-sided cylindrical surface or toroidal surface through which the laser light passes, the astigmatism correction element being configured to rotate together with the optical path changing element by the rotation mechanism.

3. The laser scanning observation device according to claim 2,
wherein the astigmatism correction element is a meniscus lens having a cylindrical surface formed on both surfaces.

4. The laser scanning observation device according to claim 1,
wherein the astigmatism correction element is an optical member including a driving element configured to dynamically change the amount of correction for astigmatism depending on the change in the depth of observation.

5. The laser scanning observation device according to claim 1, further comprising:
a translational movement mechanism configured to allow at least the optical path changing element to move translationally in a direction of the rotation axis to scan the observation target with the laser light in the rotation axis direction.

6. The laser scanning observation device according to claim 1, further comprising:
a depth-of-observation adjusting mechanism configured to change the depth of observation to scan the observation target with the laser light in a depth direction.

7. The laser scanning observation device according to claim 6,
wherein the depth-of-observation adjusting mechanism includes a collimator lens and a movement mechanism, the collimator lens being configured to collimate the laser light into a substantially parallel beam of light and to guide the collimated light to the optical path changing element and the astigmatism correction element, the movement mechanism being configured to move the collimator lens in a direction of an optical axis.

8. The laser scanning observation device according to claim 1,
wherein the laser scanning observation device detects fluorescent light occurring by irradiating the observation target with the laser light as returning light to acquire information relating to the observation target, and
wherein the laser scanning observation device further includes a chromatic aberration correction element configured to correct chromatic aberration caused by a difference in wavelengths between the laser light and the fluorescent light.

9. The laser scanning observation device according to claim 8,
wherein the chromatic aberration correction element is a cemented lens configured to function as a parallel flat plate for light having a wavelength band corresponding to the laser light and to function as a concave lens for light having a wavelength band corresponding to the fluorescent light.

10. The laser scanning observation device according to claim 1,
wherein the optical path changing element is configured to allow a pencil of the laser light to be incident on the optical path changing element, and
wherein the objective lens collects the pencil of the laser light at a plurality of different spots of the observation target.

11. The laser scanning observation device according to claim 10,
wherein the pencil of the laser light is configured to include the laser light modulated to a plurality of different states.

12. The laser scanning observation device according to claim 10,
wherein the pencil of the laser light is guided into the casing through a plurality of optical fibers.

13. The laser scanning observation device according to claim 10,
wherein the pencil of the laser light is guided into the casing through a multi-core optical fiber including a plurality of cores.

14. The laser scanning observation device according to claim 1, further comprising:
a polarization modulation element provided in a front stage of the optical path changing element and configured to change a polarization direction of the laser light incident on the optical path changing element,
wherein the optical path changing element is a polarization beam splitter configured to change an optical path of the laser light having a predetermined polarization direction, and
wherein the polarization beam splitter changes a direction of travel of the laser light of which a polarization direction is changed by the polarization modulation element toward the window unit depending on the polarization direction of the laser light.

15. The laser scanning observation device according to claim 1, further comprising:
an optical path branching element provided in a front stage of the optical path changing element and configured to allow the laser light incident on the optical path changing element to be branched into a plurality of optical paths,
wherein the astigmatism correction element, the optical path changing element, and the objective lens are provided for each of the plurality of optical paths, and
wherein the optical path changing element changes each direction of travel of the laser light branched by the optical path branching element to a plurality of directions perpendicular to a direction of the rotation axis.

16. The laser scanning observation device according to claim 1,
wherein the laser scanning observation device is provided with a housing configured to accommodate at least a plurality of the optical path changing elements and to rotate together with the plurality of optical path changing elements,
wherein the housing includes an incident window unit formed on a wall of the housing on which the laser light is incident and configured to allow the laser light to be incident on each of the plurality of optical path changing elements,
wherein the astigmatism correction element and the objective lens are provided for each of a plurality of the incident window units,
wherein the laser light is guided within the casing in a state where an optical axis of the laser light is maintained at a predetermined position with respect to the casing and the laser light is sequentially applied to the plurality of incident window units with a rotation of the housing, and
wherein the laser light incident through the incident window unit corresponding to a position to be irradiated with the laser light is guided to the window unit by the optical path changing element.

17. The laser scanning observation device according to claim 1,
wherein the casing has a cylindrical shape, and
wherein the window unit is provided on a side wall substantially parallel to a longitudinal direction of the casing and has a cylindrical curved surface conforming to a shape of the side wall of the casing.

18. The laser scanning observation device according to claim 1,
wherein the casing has a cylindrical shape, and
wherein the window unit is provided at a distal portion of the casing in a longitudinal direction and has a surface substantially perpendicular to the longitudinal direction of the casing.

19. The laser scanning observation device according to claim 1,
wherein the objective lens is provided between the optical path changing element and the window unit, and
wherein a space between the objective lens and the window unit is immersed in liquid having substantially a same refractive index as a refractive index of the window unit.

20. The laser scanning observation device according to claim 1,
wherein the casing is a tube of an endoscope, and
wherein the window unit provided in a partial area of the tube is brought in contact with or close to a biological tissue in a body cavity of a human or animal to be observed and allows the biological tissue to be scanned with the laser light.

21. The laser scanning observation device according to claim 1,
wherein the window unit is brought in contact with or close to a body surface of a human or animal to be observed and allows a biological tissue at a predetermined depth from the body surface to be scanned with the laser light.

22. The laser scanning observation device according to claim 1, further comprising:
a stage configured to allow the observation target to be placed on the stage,
wherein the observation target is scanned with the laser light through the window unit provided on at least a partial area of the stage.

23. A laser scanning method comprising:
causing laser light to be incident on an optical path changing element provided within a casing;
changing a direction of travel of the laser light guided within the casing by the optical path changing element, and irradiating, through a window unit provided in a partial area of the casing and configured to be in contact with or close to an observation target, the observation target with the laser light which is collected by an objective lens and in which astigmatism is corrected by an astigmatism correction element; and
causing at least the optical path changing element to rotate about a rotation axis perpendicular to an observation direction to scan the observation target with the laser light, the observation direction being a direction of incidence of the laser light on the observation target,
wherein the astigmatism correction element corrects astigmatism by an amount of correction corresponding to variation in the astigmatism caused by a change in depth of observation, the depth of observation being a measure of depth at a position where the laser light is collected on the observation target.
